(19) United States
(12) Patent Application Publication
(10) Pub. No.: US 2024/0419404 A1
(43) Pub. Date: Dec. 19, 2024

(54) DEVICE AND METHOD FOR FREE SPACE QUANTUM KEY DISTRIBUTION

(71) Applicant: ELMOS Semiconductor SE, Dortmund (DE)

(72) Inventors: Bernd Burchard, Essen (DE); Thomas REUL, Drensteinfurt (DE)

(73) Assignee: ELMOS Semiconductor SE, Dortmund (DE)

(21) Appl. No.: 18/702,849

(22) PCT Filed: Sep. 28, 2022
(86) PCT No.: PCT/DE2022/100724

§ 371 Date: Apr. 19, 2024

(30) Foreign Application Priority Data
Oct. 27, 2021 (DE) 10 2021 127 994.1
Oct. 27, 2021 (DE) 10 2021 127 996.8
Oct. 27, 2021 (DE) 10 2021 127 997.6
Oct. 27, 2021 (DE) 10 2021 127 998.4
Nov. 25, 2021 (DE) 10 2021 131 003.2
Nov. 25, 2021 (DE) 10 2021 131 004.0
Nov. 25, 2021 (DE) 10 2021 131 005.9
Nov. 25, 2021 (DE) 10 2021 131 006.7

(51) Int. Cl. G06F 7/58

(52) U.S. Cl. CPC G06F 7/588

(57) ABSTRACT

The invention relates to a single-photon transmission device for enabling secure authentication, said device comprising a plurality of single-photon sources, a control device which is configured to actuate each of the single-photon sources separately, and an optical subdevice which is configured to combine single-photon streams of photons emitted by the at least one single-photon source into a QKD coupling beam consisting of a common stream of single photons. The invention also relates to a single-photon receiving device for receiving a QKD coupling beam transmitted from a single-photon transmission device. The invention also relates to a method for generating a common quantum key for a single-photon transmission device and a single-photon receiving device. The invention also relates to an integrated QKD circuit. The invention also relates to a car key comprising a single-photon transmission device and/or a single-photon receiving device. The invention also relates to a car comprising a single-photon transmission device and/or a single-photon receiving device. The invention also relates to the use of a single-photon transmission device and/or a single-photon receiving device for data exchange. The invention also relates to a SPAD diode for a sensor element of a single-photon detector for a single-photon transmission device and/or for a single-photon receiving device.

The invention relates to a single-photon transmission device for enabling secure authentication, comprising a plurality of single-photon sources, a control device which is configured to actuate each one of the single-photon sources separately, and an optical subdevice which is configured to combine single-photon streams of photons emitted by the at least one single-photon source to form a QKD coupling beam consisting of a common stream of single photons.

The invention also relates to a single-photon receiving device for receiving a QKD coupling beam transmitted from a single-photon transmission device.

The invention also relates to a method for generating a common quantum key for a single-photon transmission device and a single-photon receiving device.

The invention also relates to an integrated QKD circuit.

The invention also relates to a car key comprising a single-photon transmission device and/or a single-photon receiving device.

The invention further relates to a car comprising a single-photon transmission device and/or a single-photon receiving device.

The invention also relates to the use of a single-photon transmission device and/or a single-photon receiving device for data exchange.

The invention also relates to a SPAD diode for a sensor element of a single-photon detector for a single-photon transmission device and/or for a single-photon receiving device.

The general principles of quantum cryptography were first described by Bennett and Brassard in their article “Quantum Cryptography: Public key distribution and coin tossing” published in “Proceedings of the International Conference on Computers, Systems and Signal Processing”, Bangalore, India, 1984, pp. 175-179 (IEEE, New York, 1984).

The general method for performing the quantum key distribution is described in the book by Bouwmeester et al. “The Physics of Quantum Information”, Springer-Verlag 2001, described in Section 2.3, pages 27-33.

The encryption units enable secure transmission of user data by performing a type of symmetric encryption using the keys exchanged by quantum key distribution. Specific quantum key distribution systems are described, for example, in U.S. Pat. No. 5,307,410 and in the article by C. H. Bennett entitled “Quantum Cryptography Using Any Two Non-Orthogonal States”, Phys. Rev. Lett. 68 3121 (1992).

Quantum cryptography has developed on an interdisciplinary basis between the scientific fields of quantum physics, quantum optics, information theory, cryptography and computer science. An overview of the fundamentals and methods as well as the historical development of quantum cryptography can be found in the articles by N. Gisin, G. Ribordy, W. Tittel and H. Zbinden, “Quantum Cryptography”, Reviews of Modern Physics. 74, 145 (2002).

Quantum cryptography or quantum key distribution (hereinafter also referred to as QKD) is a method that enables the distribution of a secret key between two remote parties, a transmitter called “Alice” and a recipient called “Bob”, with verifiably absolute security. The distribution of quantum keys is based on the principles of quantum physics and the encryption of information in quantum states or qubits, which stands in contrast to classical communication, in which bits are used. Photons are normally used for these quantum states. The quantum key distribution makes use of certain properties of these quantum states to ensure their security.

QKD is a protocol that enables the exchange of secret keys in an active scenario. In a QKD protocol, the communication channel between the two users is referred to as the quantum channel. A quantum channel is a communication channel that transmits quantum particles, typically photons, in a way that their quantum properties are preserved. There exist two parameter groups which are used for quantum encoding. One parameter is the polarization of the photons, and the other parameter is the phase, which requires the use of interferometers. Both have their advantages and disadvantages, depending on the physical layer of the quantum channel and the type of QKD protocol.

In contrast to classical cryptography, whose security depends on computational complexity, the security of quantum cryptography is based on numerous quantum mechanical principles, including the quantum mechanical principle that every measurement of a quantum system in an unknown state changes the state of this quantum system.

The security of this method results in particular from the fact that measuring the quantum state of an unknown quantum system changes the system itself. In other words: A spy known as “Eve” listening in on a quantum communication channel cannot obtain information about the key without introducing errors into the key exchanged between the transmitter and the receiver. If “Eve” the spy tries to intercept or otherwise measure the exchanged qubits, errors occur that reveal its presence. In this way, the user is informed of an eavesdropping attempt.

The basic idea of QKD is that the spy, also known as the eavesdropper, can intercept the signal and process it in any way compatible with quantum mechanics. Nevertheless, the legitimate users, known as Alice and Bob, can exchange a secure key.

A typical implementation of a cryptographic application based on QKD consists of a cryptographic application running between two remote sites. This implementation comprises at least one pair of quantum key distribution units and one pair of cryptographic application units that use the secret keys exchanged via QKD.

One unit of each pair is installed at a first site, whereas the other unit is located at the other, second site.

The QKD units are connected via a quantum communication channel and a first bidirectional classical communication channel, also known as a service channel. The quantum communication channel is implemented by a first optical fiber, and the service channel is implemented by a second optical fiber that is separate from the first optical fiber.

The cryptographic application units are connected via a second bidirectional classical communication channel, also known as the data channel.

Eavesdropping detection takes place on the quantum communication channel (quantum channel), and not on the service channel or on the data channel running parallel to the quantum communication channel.

Several implementation options are possible for the quantum and service channels in quantum key distribution systems.

The most common is the use of separate physical media to transmit these communication channels.

In general, the physical medium used for the transmission of optical communication channels consists of optical fibers. However, other media are also possible, e.g. propagation in free space.

In the case of communication channels transmitted over separate optical fibers, the optical fiber dedicated to the quantum channel is called dark fiber. The bidirectional service channel is also transmitted via two separate optical fibers. Each fiber transmits one direction of the communication channel. In this option, there are no interactions between the different channels as they are transmitted via a physically separate medium.

For a properly functioning communication channel, it is important that a signal-to-noise ratio of the received logical signal is large enough.

One of the effects of optical fibers on both quantum and classical optical logical signals is attenuation of these signals during their propagation. In other words, the signal level decreases as the signal propagates in an optical fiber. On the other hand, the noise in both quantum and classical channels is mainly due to the noise of the detection system. The noise level is therefore independent of the propagation distance in the optical fiber. Therefore, the signal-to-noise ratio of both communication channel types decreases as the propagation distance of the signal increases. This effect results in a maximum propagation distance (or maximum loss value) over which a channel can operate.

With classic communication channels, the parameter used to determine whether the channel has a sufficiently good signal-to-noise ratio is the optical intensity of the signal that reaches the receiver. If the value of this parameter is within a range specified by the manufacturer, the channel is functioning correctly.

In the case of quantum communication channels, the parameter used to determine whether the channel has a sufficiently good signal-to-noise ratio is called the quantum bit error rate (QBER). This parameter is, so to speak, the reciprocal of the signal-to-noise ratio. The QBER value is measured by QKD systems. If the QBER value is above a predefined threshold, then the QKD system cannot generate secret keys from the qubit exchange. The higher the QBER value, the greater the error rate in relation to the signal rate. An increase in the error rate can be due either to a decrease in the quantum signal or to a change in some QKD system parameters or to an eavesdropping attempt. A change in QKD system parameters can be caused, for example, by a temperature fluctuation that changes the alignment of the optical system or a change in the inherent noise of the single-photon detectors in the QKD receiver.

The best-known protocol for QKD is the BB84 protocol, which is based on four different quantum states and is explained in Bennett & Brassard, 1984.

Other known protocols include, e.g.:
E91, based on entanglement;
B92 based on only two quantum states, but requiring interferometric detection; and
COW, which uses a variant of the phase parameter and uses the detection time for encoding.

Typically, a phase parameter or a related time parameter for the COW protocol is used in implementations of QKD for quantum encoding. The reason for this is that polarization is not maintained in an optical fiber and polarization processes require complicated and expensive components.

On the other hand, interferometric detection is easier to implement in single-mode optical fibers, which is why single-mode optical fibers are a preferred medium.

To increase the range, one solution is to rely on free-space optical communication (FSO) QKD, where the quantum channel runs in free space, which does not have the same loss limitations as optical fibers.

Another possibility is free-space optical communication (FSO) QKD, in which the quantum channel runs in free space.

Examples of QKD implementations in free space can be found in R. Bedington et al. “Progress in satellite quantum key distribution”, https://arxiv.org/abs/1707.03613v2, or in J-P Bourgoin et al. “A comprehensive design and performance analysis of LEO satellite quantum communication”, https://arxiv.org/abs/1211.2733.

Free-space optical communication (FSO) is an optical communication technology that uses light propagating in free space for wireless data transmission for telecommunications or computer networks.

The term “free space” refers to air, vacuum, or something similar, i.e., a medium in which light can propagate in a straight line.

This is in contrast to a guided optical means, such as in optical fibers, or more generally optical waveguides, whereby the light is guided and directed through the waveguide.

Like any other type of communication, free-space optical communication requires security to prevent eavesdropping. The most common solutions for realizing an exchange of secret information via FSO between a transmitter and a receiver are based on an exchange of secret keys via FSO channels. After the exchange of secret keys, these keys are used to exchange messages in a secure way, for example by encrypting the messages.

However, an FSO QKD poses a challenge because due to atmospheric distortions, the wavefront of a wave is distorted during propagation, resulting in poor interference at the receiver. This can be improved upon by using mirrors with adaptive optics, but has the disadvantage that the complexity and cost of such a system is considerable. In free space, the polarization of light is preserved, which makes polarization-based systems more attractive.

However, one problem with the transmission of QKD photons in free space is background noise caused by scattered light.

If a receiver moves relative to the transmitter, or vice versa, the polarization of the photons changes during the movement of the moving transmitter/receiver, e.g. a car key with a QKD system, which requires polarization-compensating components.

Therefore, the object of the invention is to provide a device that enables secure encryption between a transmitter and a receiver, whereby the transmitter can move relative to the receiver, or the receiver can move relative to the transmitter.

A device and a method according to the independent claim are proposed in order to achieve this object.

Further advantageous embodiments of the invention can be gathered from the dependent claims, the description, and the drawings.

The proposed solution provides a single-photon transmission device and a single-photon receiving device, which can exchange a key for secure communication by means of a QKD coupling beam transmitted by the single-photon transmission device and received by the single-photon receiving device.

The single-photon transmission device according to the invention for enabling secure authentication comprises a plurality of single-photon sources, a control device which is configured to actuate each one of the single-photon sources separately, and an optical subdevice which is configured to combine single-photon streams of photons emitted by the at least one single-photon source to form a QKD coupling beam consisting of a common stream of single photons.

In particular, the single-photon transmission device comprises an actuating device for the single-photon sources, which single-photon sources each comprise an light source and a power source, whereby the light source emits polarized single photons or single photons of different polarization, which are polarized by means of polarization filters or polarizing optical functional means in a subsequent beam path.

In particular, the single-photon transmission device comprises at least one databus. In particular, the single-photon transmission device comprises at least one microcontroller core which is configured to control the actuating device via the internal databus.

In particular, the single-photon transmission device comprises at least one control line connecting the actuating device to an adjustable voltage regulator.

In particular, the single-photon transmission device comprises at least one power supply for the single-photon sources, whereby the power supply is configured to regulate an operating voltage of the single-photon sources, in particular to regulate it by means of a linear regulator.

In particular, the actuating device is configured to adjust a voltage between a supply voltage line of the single-photon sources and a reference potential by means of the control line.

In particular, the power source of each single-photon source is configured to adjust a single-photon rate of the respective associated light source depending on signaling of a control line associated with the respective power source, in particular depending on control data for the single-photon sources transmitted by the actuating device, and thus a photon density of a light emission of the single-photon sources.

In particular, the actuating device is configured to control an electric current through the respective power source of the respective single-photon sources.

In particular, the single-photon sources are configured to feed the respective single-photon streams into the QKD coupling beam depending on the control by the actuating device.

In one embodiment, the single-photon transmission device comprises a plurality of the databuses and a plurality of the microcontroller cores.

In particular, the plurality of microcontroller cores can independently access various subdevices of the single-photon transmission device simultaneously.

In a further embodiment, the single-photon transmission device for measuring and calibrating a photon rate comprises a beam splitter or mirror and a photodetector.

In particular, the beam splitter or mirror is configured to direct at least one portion of the QKD coupling beam onto the photodetector.

In a further embodiment, the microcontroller core is configured to determine a single-photon density in the QKD coupling beam by means of the photodetector.

In a further embodiment, the microcontroller core is configured to insert the beam splitter or mirror into the QKD coupling beam, in particular by means of an actuator, whereby the microcontroller core controls the actuator via the internal databus.

In a further embodiment, the microcontroller core is configured to operate one of the single-photon sources separately and to detect a single-photon density associated with this single-photon source.

In a further embodiment, the microcontroller core is configured to calibrate the single-photon densities of the various single-photon sources by the microcontroller core adjusting the power sources of the respective single-photon sources such that the single-photon density of the respective single-photon source detected by the photodetector is within a provided single-photon density range value interval, and/or the single-photon density of the respective single-photon source detected by the photodetector differs from the single-photon density of another of the single-photon sources by no more than 10%, better 5%, better 2%, better 1%, better 0.5%, better 0.2%, better 0.1%, better 0.05%, better 0.02%, better 0.01%.

In a further embodiment, the microcontroller core is configured to remove the beam splitter or mirror from the QKD coupling beam, in particular by means of an actuator, whereby the microcontroller core controls the actuator via the internal databus, after the calibration of the single-photon densities of the various single-photon sources has been completed.

In a further embodiment, the subdevice comprises a conical mirror, and a spatial filter, in particular comprising a first pinhole aperture and a second pinhole aperture.

In particular, the conical mirror is configured to direct single photons emitted by the single-photon sources in a common beam direction and thus to combine them into a common stream of single photons, the QKD coupling beam.

In a further embodiment, the subdevice comprises at least one λ/4 plate configured to rotate photons emitted by the plurality of single-photon sources by 45°, at least one beam splitter, and a control device.

In particular, the at least one beam splitter is configured to combine photons emitted by the at least one single-photon source into a common stream of single photons, the QKD coupling beam.

In a further embodiment, the single-photon transmission device comprises at least one read/write memory, at least one non-writable volatile memory, and at least one read-only memory.

In particular, the microcontroller core is configured to process program code and/or program data contained on the at least one read/write memory and/or on the at least one read-only memory. In particular, the single-photon transmission device comprises an access logic for this purpose.

In particular, the microcontroller core is configured to access the at least one read/write memory by means of the internal databus.

In particular, the microcontroller core is configured to access the at least one non-writable volatile memory by means of the internal databus.

In a further embodiment, the single-photon transmission device comprises at least one non-volatile manufacturer memory, which is designed to be writable and/or non-writable.

In particular, the non-volatile manufacturer memory comprises boot software for the microcontroller core.

In a further embodiment, the single-photon transmission device comprises at least one cryptography accelerator.

In particular, the at least one cryptography accelerator is connected to the microcontroller core via the internal databus.

In a further embodiment, the single-photon transmission device comprises at least one manufacturer memory firewall, which is configured to prevent unauthorized access to the manufacturer's memory and only allow access after appropriate authentication. In particular, the at least one manufacturer memory firewall is provided between the manufacturer memory and the internal databus.

In a further embodiment, the single-photon transmission device comprises at least one CRC module (Cyclic Redundancy Check), which is configured to calculate a CRC check data word for a specified amount of data.

In a further embodiment, the single-photon transmission device comprises at least one clock driver module which is configured to provide system clocks for operating individual device components of the single-photon transmission device.

In a further embodiment, the single-photon transmission device comprises at least one timer module which is configured to control temporal sequences within the single-photon transmission device.

In a further embodiment, the single-photon transmission device comprises at least one security monitoring and security control circuit which is configured to monitor the integrity of the single-photon transmission device and optionally initiate countermeasures in the event of an attack.

In particular, the at least one security monitoring and security control circuit is configured to detect an attack and optionally block the single-photon transmission device from accessing the storage contents of the memories for a preferably predetermined period of time and/or to delete the contents of the memories in whole or in part, and/or to set the contents of the memories to predefined values, and/or to overwrite them with nonsensical data, and/or to otherwise manipulate them.

In a further embodiment, the single-photon transmission device comprises at least one quantum random number generator which is configured to generate true random numbers.

In a further embodiment, the transmission device comprises at least one data interface.

In a further embodiment, the single-photon transmission device comprises at least one base clock driver which is configured to provide a base clock to the at least one clock driver module.

In a further embodiment, the single-photon transmission device comprises at least one reset circuit which is configured to set the single-photon transmission device and/or subdevices of the single-photon transmission device to a predefined state when predetermined or determinable reset conditions and/or combinations and/or temporal sequences of such reset conditions are present.

In a further embodiment, the single-photon transmission device comprises at least one power supply or VCC circuit comprising voltage regulators, which power supply or VCC circuit is configured to provide an operating voltage.

In a further embodiment, the single-photon transmission device comprises at least one ground circuit which is configured to protect the single-photon transmission device against polarity reversal and attacks via a ground line.

In a further embodiment, the single-photon transmission device comprises at least one input/output circuit configured to enable the single-photon transmission device to actuate or read out or otherwise communicate with further devices.

In a further embodiment, the single-photon transmission device comprises at least one processing module configured to communicate with the microcontroller core via the internal databus, in particular the at least one processing module comprises the at least one CRC module, and/or the at least one cryptography accelerator, and/or the at least one clock driver module, and/or the at least one timer module, and/or the at least one security monitoring and security control circuit, and/or the at least one quantum random number generator, and/or the at least one microcontroller core, and/or the at least one data interface.

In a further embodiment, the single-photon transmission device comprises at least one watchdog timer which is configured to monitor a processing of various program components by the at least one microcontroller core, in particular the at least one watchdog timer is integrated in the at least one security monitoring and security control circuit.

In a further embodiment, the single-photon transmission device is configured to store, in addition to an authentication code, further data, for example, one or a plurality of lifetime and usage data, and/or logistical data, and/or commercial data, and/or website and email addresses, and/or image data and/or a set of instructions for control units of a car with which the microcontroller core of the single-photon transmission device communicates via the at least one data interface of the single-photon transmission device, and/or further application data.

In a further embodiment, one or a plurality of the at least one ground circuit and/or one or a plurality of the at least one power supply or VCC circuit are configured to cooperate such that a modulation of a power consumption and/or a internal resistance and/or a voltage drop between supply voltage terminals of the single-photon transmission device does not allow conclusions to be drawn about an operating sequence and/or a state of the single-photon transmission device, at least temporarily.

In a further embodiment, the single-photon transmission device comprises an analog-to-digital converter which is configured to enable the microcontroller core to monitor internal analog values, such as an operating voltage, and external analog values.

In a further embodiment, the at least one quantum random number generator is configured to generate one or a plurality of random numbers, in particular on request of the at least one microcontroller core.

In a further embodiment, the at least one microcontroller core is configured to generate one or a plurality of keys by means of a respective program from one or a plurality of its memory elements and by means of one or plurality of the generated random numbers.

In a further embodiment, the at least one microcontroller core is configured to encrypt and/or decrypt data with the aid of a respective program of the related microcontroller core and with the aid of a respective key of the generated keys, which data is typically exchanged by the at least one microcontroller core via the at least one data interface of the single-photon transmission device with devices outside the single-photon transmission device.

In a further embodiment, the single-photon transmission device comprises at least one wireless data interface for communication with another computer system, in particular via a respective antenna of the at least one wireless data interface.

In particular, the respective antenna is configured to emit an electromagnetic signal which the single-photon transmission device exchanges with a single-photon receiving device in a wired or wireless manner.

In a further embodiment, the single-photon transmission device is a mobile unit, in particular a cell phone, or a smartphone, or a laptop, or a tablet PC, or a key, or a vehicle key, or a security key for a weapon or other military device, or a key for activating and/or controlling an aircraft, a watercraft, or a projectile, or an access key to a secured area or to a safe or a safe deposit box, or an activation key for a secured mechanism, or an activation key for a protected procedure to, e.g., execute a secured device, or an activation key for a protected device to, e.g., execute a secured procedure.

In a further embodiment, the single-photon transmission device comprises at least one biometric sensor.

In a further embodiment, the single-photon transmission device comprises at least one means for identifying a person using the single-photon transmission device.

In a further embodiment, the single-photon transmission device comprises alignment means, in particular a laser pointer diode, for aligning the single-photon transmission device with respect to a single-photon receiving device.

The single-photon receiving device according to the invention for receiving a QKD coupling beam transmitted by a single-photon transmission device according to the invention as described hereinabove comprises a single-photon detector system which is configured to receive a polarization-modulated single-photon signal.

In particular, the single-photon detector system comprises at least one single-photon detector, whereby

In particular, the at least one single-photon detector is configured to detect the QKD coupling beam of the single-photon transmission device, and

In particular, the single-photon receiving device comprises at least one microcontroller core.

In particular, the single-photon receiving device comprises at least one internal databus.

In one embodiment, the microcontroller core of the single-photon receiving device is configured to handle internal data communication via the internal databus of the single-photon receiving device.

In a further embodiment, the single-photon receiving device comprises at least one read/write memory RAM for the storage system and for the provision and use of data and program instructions by the microcontroller core.

In a further embodiment, the single-photon receiving device comprises at least one writable non-volatile memory.

In a further embodiment, the single-photon receiving device comprises at least one non-volatile, read-only memory.

In a further embodiment, the microcontroller core of the single-photon receiving device is configured to process program code and program data which is stored on the writable non-volatile memory and/or on the non-volatile, read-only memory of the single-photon receiving device.

In a further embodiment, the single-photon receiving device comprises at least one non-volatile, writable and/or non-writable manufacturer memory.

In a further embodiment, the single-photon receiving device comprises at least one cryptography accelerator.

In a further embodiment, the single-photon receiving device comprises at least one manufacturer memory firewall which is configured to prevent unauthorized access to a manufacturer memory and to allow such access only after appropriate authentication, for example by means of a password.

In a further embodiment, the single-photon receiving device comprises at least one cyclic redundancy check (CRC) module.

In a further embodiment, the single-photon receiving device comprises at least one clock driver module.

In a further embodiment, the single-photon receiving device comprises at least one timer module which is configured to control temporal sequences within the single-photon receiving device.

In a further embodiment, the single-photon receiving device comprises at least one security monitoring and security control circuit which is configured to monitor the integrity of the single-photon receiving device and optionally initiate countermeasures in the event of an attack.

In a further embodiment, the single-photon receiving device comprises at least one quantum random number generator.

In a further embodiment, the single-photon receiving device comprises at least one data interface which is configured to perform data communication with other computer systems.

In a further embodiment, the single-photon receiving device comprises at least one base clock driver.

In a further embodiment, the single-photon receiving device comprises at least one reset circuit.

In a further embodiment, the single-photon receiving device comprises at least one power supply or Vcc switch comprising a voltage regulator.

In particular, the power supply or Vcc switch of the single-photon receiving device is configured to provide an operating voltage for a microcontroller system of the single-photon receiving device and other subdevices of the single-photon receiving device.

In a further embodiment, the power supply or Vcc circuit of the single-photon receiving device comprises a charging circuit and a first charging coil for inductive coupling to a second charging coil.

In a further embodiment, the single-photon receiving device comprises at least one ground circuit which is configured to protect the device against polarity reversal and attacks via the ground line.

In a further embodiment, the single-photon receiving device comprises at least one input/output circuit which is configured to enable the single-photon receiving device to actuate or read out or otherwise communicate with further devices.

In a further embodiment, the reset circuit of the single-photon receiving device comprises a watchdog timer.

In a further embodiment, one or a plurality of the at least one ground circuit and/or one or a plurality of the at least one power supply or Vcc circuit of the single-photon receiving device are configured to cooperate such that a modulation of the power consumption and/or the internal resistance and/or the voltage drop between supply voltage terminals of the single-photon receiving device does not allow conclusions to be drawn about operating sequences and/or states of the single-photon receiving device, at least temporarily.

In a further embodiment, one or a plurality of the at least one microcontroller core of the single-photon receiving device is configured to generate one or a plurality of keys by means of a respective program from one or a plurality of its memory elements and with the aid of one or a plurality of generated random numbers.

In particular, the at least one microcontroller core of the single-photon receiving device is configured to encrypt and/or decrypt data which is exchanged with devices outside the single-photon receiving device via one or a plurality of data interfaces of the single-photon receiving device with the aid of a respective program of the related microcontroller core and with the aid of a respective key of the generated keys.

In a further embodiment, the single-photon receiving device comprises at least one wireless and/or at least one wired data interface.

In particular, the wired data interface of the single-photon receiving device is configured to exchange data between the single-photon receiving device and the single-photon transmission device via a wired data channel by means of an electromagnetic data signal.

In particular, the wireless data interface of the single-photon receiving device comprises at least one antenna in each case.

In a further embodiment, the single-photon receiving device comprises an evaluation circuit.

In a further embodiment, the single-photon detector system of the single-photon receiving device comprises at least one receiving channel for single photons. Optionally, the single-photon detector system of the single-photon receiving device comprises at least one receiving optical means which is configured to focus incoming single photons of the QKD coupling beam of the single-photon transmission device onto the single-photon detectors of the single-photon detector system of the single-photon receiving device.

In particular, the single-photon detector system comprises at least one polarizing beam splitter.

In particular, the single-photon detector system of the single-photon receiving device comprises at least one λ/4 plate and/or a polarization rotation device.

In a further embodiment, the single-photon receiving device comprises an alignment receiver for aligning the single-photon transmission device with respect to the single-photon receiving device.

In particular, the alignment receiver of the single-photon receiving device is configured to detect a laser pointer beam of the single-photon transmission device.

In a further embodiment, the alignment receiver of the single-photon receiving device comprises a receiver.

In particular, the receiver is configured to detect the laser pointer beam.

In particular, the alignment receiver comprises an optical means.

In particular, the alignment receiver comprises an interface which is configured to receive measurement data from the receiver, in particular the interface is configured to signal to the microcontroller core of the single-photon receiving device via the internal databus of the single-photon receiving device whether the receiver receives sufficient light from the laser pointer beam of the single-photon transmission device via the optical means to align the single-photon transmission device.

In a further embodiment, the microcontroller core of the single-photon receiving device is configured to start a generation of a common quantum key for the single-photon transmission device and the single-photon receiving device according to a signaling of the interface of the single-photon receiving device.

According to the method according to the invention for generating a common quantum key for a single-photon transmission device, as described hereinabove, and a single-photon receiving device as described hereinabove, a microcontroller core of the single-photon receiving device starts the generation of the common quantum key for the single-photon transmission device and the single-photon receiving device in accordance with signaling by an interface of the single-photon receiving device by the microcontroller core of the single-photon receiving device signaling a microcontroller core of the single-photon transmission device that an agreement of a quantum key can start.

In particular, the microcontroller core of the single-photon transmission device causes the single-photon transmission device to generate a polarization-modulated stream of single photons as a QKD coupling beam, in particular using a random number of its quantum random number generator of the single-photon transmission device.

In particular, the single-photon receiving device receives the polarization-modulated single-photon data stream of the QKD coupling beam generated by the single-photon transmission device.

An integrated QKD circuit according to the invention comprises a single-photon transmission device as described hereinabove and/or a single-photon receiving device as described hereinabove.

A car key according to the invention comprises a single-photon transmission device as described hereinabove and/or a single-photon receiving device as described hereinabove.

A car according to the invention comprises a single-photon transmission device as described hereinabove and/or a single-photon receiving device as described hereinabove.

The single-photon transmission device according to the invention described hereinabove and/or the single-photon receiving device according to the invention described hereinabove is used in particular for exchanging data exchange.
between a car key according to the invention and a car according to the invention,
between a first car according to the invention and a second car according to the invention,
between a car according to the invention and an infrastructure device, such as a charging station, and
within a car according to the invention for encrypted communication within the car according to the invention.

A SPAD diode according to the invention for a sensor element of a single-photon detector for a single-photon transmission device according to the invention and/or for a single-photon receiving device according to the invention comprises
at least one shallow trench isolation means,
at least one anode contact,
at least one cathode contact,
at least one cover oxide,
at least an optically transparent insulating layer,
at least one highly doped first connector area of a first line type,
at least one first doped tray of a second line type,
at least one second doped tray of a second line type,
an epitaxial layer of a second line type,
a base material of a semiconducting monocrystalline wafer,
a second doped tray of a second line type below the anode contact,
at least one highly doped second connector area of the second connector type, and
at least one isolation means.

In particular, the SPAD diode according to the invention comprises at least one metal-optical filter, and at least one optically transparent slit in the metal-optical filter.

In particular, in a SPAD diode array comprising a plurality of the SPAD diodes according to the invention, the plurality of SPAD diodes are arranged such that the respective metal-optical filters of the respective adjacent SPAD diodes are arranged at a 45° angle to each other.

The invention further relates to a vehicle system comprising a vehicle (802), and device components (401, 601), whereby at least a first device component (401, 601) is part of the vehicle (802), and whereby the vehicle system comprises a QKD system (401, 601, 452, 428), and

whereby at least the first device component (401, 601) exchanges with a further second device component (401, 601) of the vehicle system a key for encrypting data by means of the QKD system (401, 601, 452, 428) and whereby the first device component (401, 601) exchanges encrypted data with the second device component (401, 601) at least temporarily by means of this key.

In one embodiment, the second device component is a car key.

In a further embodiment, the second device component is also part of the vehicle (802).

In a further embodiment, the second device component is an infrastructure device.

In a further embodiment, the second device component is another vehicle (802).

In a further embodiment, the vehicle is a car, a truck, a special machine, a ship, a watercraft, a floating body, or another mobile apparatus.

In a further embodiment, the vehicle system comprises at least temporarily a polarization-modulated single-photon stream, in particular a QKD coupling stream (452), between the second device component (401, 601) and the first device component (401, 601), which the second device component (401, 601) exchanges with the first device component (401, 601).

In a further embodiment, the first device component comprises a single-photon receiving device (601) for the polarization-modulated single-photon stream. The second device component further comprises a single-photon transmission device (401) for the polarization-modulated single-photon stream.

In a further embodiment, the first device component comprises a single-photon transmission device (401) for the polarization-modulated single-photon stream. The second device component further comprises a single-photon receiving device (601) for the polarization-modulated single-photon stream.

In a further embodiment, the single-photon stream is a QKD coupling stream (452).

In a further embodiment, the first device component (401, 601) and the second device component (401, 601) each have means (1411, 1603) for exchanging a single-photon stream, in particular a QKD coupling beam, (452).

In a further embodiment, the first device component and the second device component comprise means (455, 699) for directing a single-photon stream, in particular a QKD coupling beam (452).

The single-photon transmission device according to the invention and the single-photon receiving device according to the invention have the advantage that they can perform secure data exchange by means of the method according to the invention, whereby the single-photon transmission device according to the invention and/or the single-photon receiving device according to the invention can be a mobile unit or are integrated into a mobile unit, e.g. the car key according to the invention and the car according to the invention.

An application for data exchange between a mobile unit, such as a key or smartphone, etc., and an infrastructure, such as a building, is also possible.

An application for data exchange between a mobile units, e.g. a smartphone or the like, and a controllable unit, e.g. a smart home application, is also possible in a secure manner using the single-photon transmission device and the single-photon receiving device according to the invention.

In this context, the single-photon transmission device according to the invention and the single-photon receiving device according to the invention have a very compact design. In particular in the form of the integrated QKD circuit according to the invention. In particular, the CPK is improved by monolithic integration of the single-photon transmission device according to the invention and/or the single-photon receiving device according to the invention. This results in a narrow distribution and a small scattering width, so that scattering among the components of the single-photon transmission device and/or single-photon receiving device is reduced.

Further advantageous embodiments, features, and functions of the invention are explained in connection with the examples shown in the drawings.

Shown are:

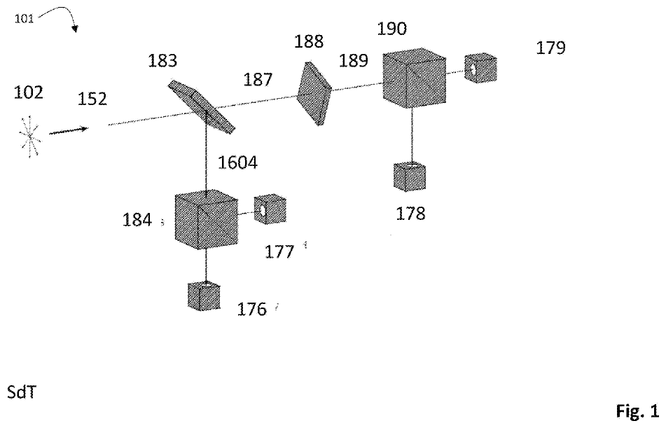

FIG. 1 a schematic illustration of an optical means of a QKD receiver according to the prior art;

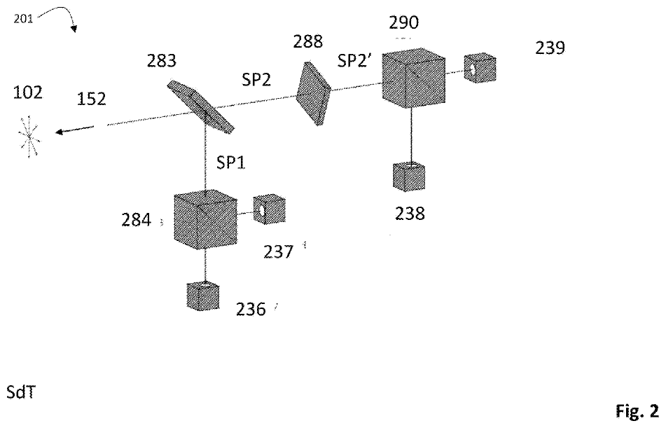

FIG. 2 a schematic illustration of an optical means of a QKD single-photon transmission device according to the state of the art;

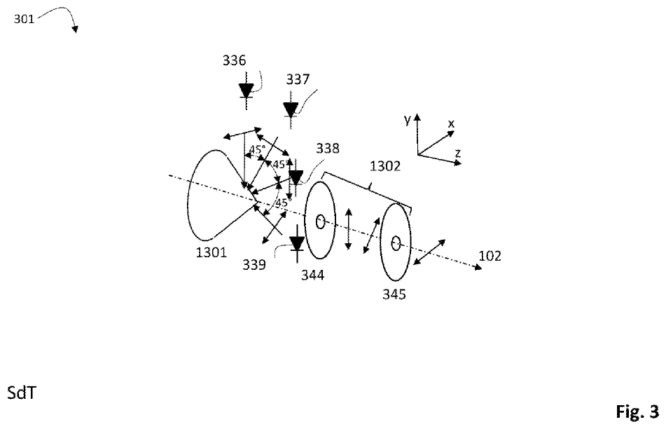

FIG. 3 a schematic illustration of another optical means of a QKD single-photon transmission device according to the prior art;

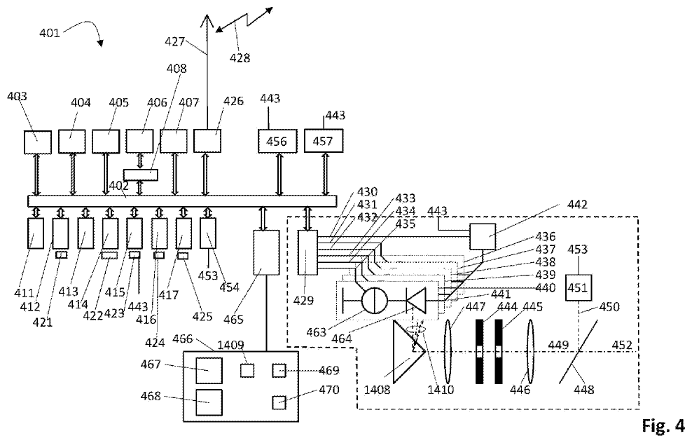

FIG. 4 a schematic illustration of a single-photon transmission device according to the invention in a first embodiment;

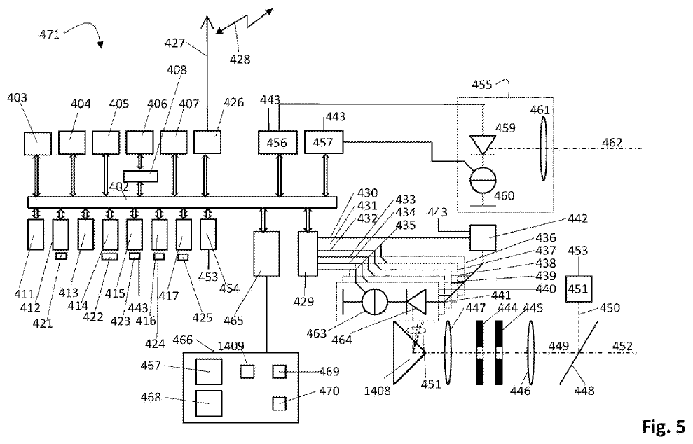

FIG. 5 a schematic illustration of a single-photon transmission device according to the invention in a further embodiment;

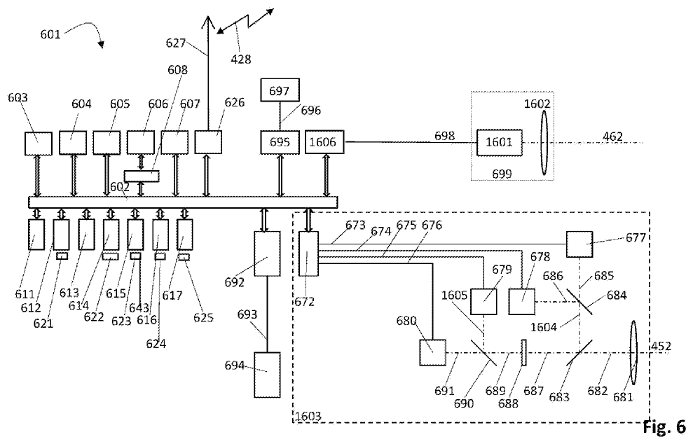

FIG. 6 a schematic illustration of a single-photon receiving device according to the invention;

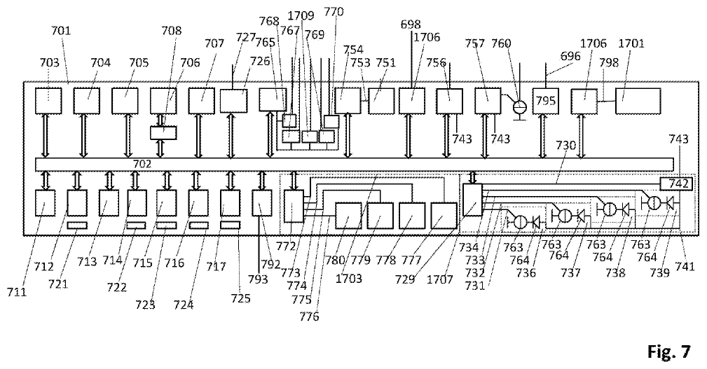

FIG. 7 a schematic block diagram of an exemplary integrated circuit for use as an integrated QKD circuit in automotive QKD systems;

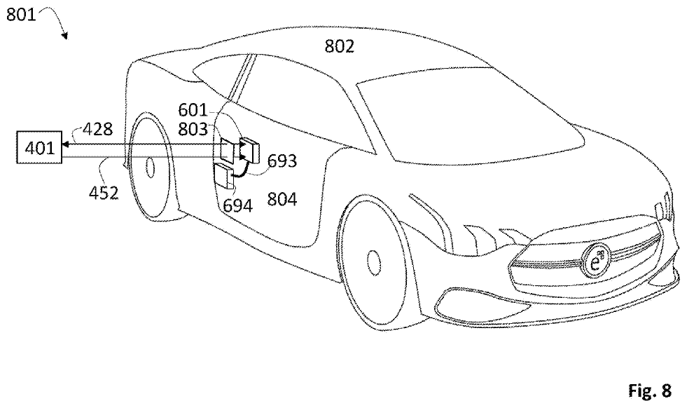

FIG. 8 a schematic illustration of a coupling of a single-photon transmission device according to the invention with a single-photon receiving device according to the invention by means of a QKD coupling beam;

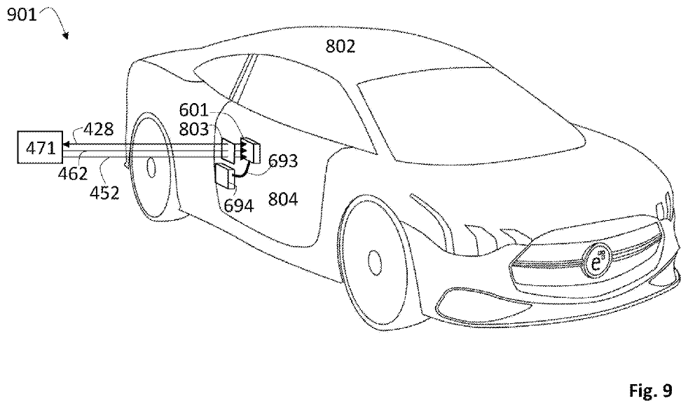

FIG. 9 a schematic illustration of a use of a laser pointer beam to align the single-photon transmission device according to the invention with the single-photon receiving device according to the invention;

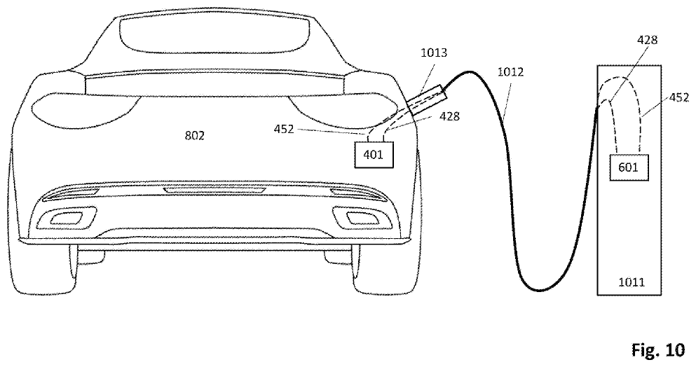

FIG. 10 a schematic illustration of the agreement of a QKD key between a car comprising a single-photon transmission device according to the invention and an infrastructure device comprising a single-photon receiving device according to the invention in the form of a charging station;

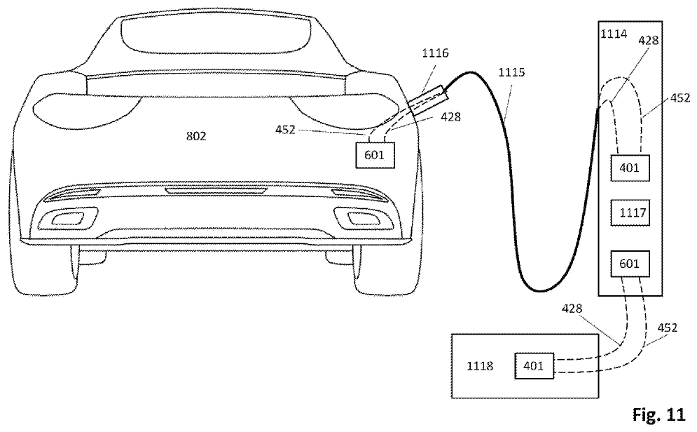

FIG. 11 a schematic illustration of an exemplary interaction between a software update unit comprising the single-photon transmission device according to the invention and a car comprising the single-photon receiving device according to the invention;

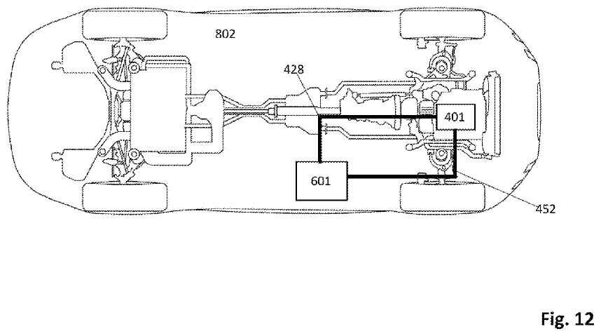

FIG. 12 a car comprising a single-photon transmission device according to the invention and a single-photon receiving device according to the invention, whereby subdevices of the car generate a QKD key via an associated QKD system and use it for encrypted communication in the car;

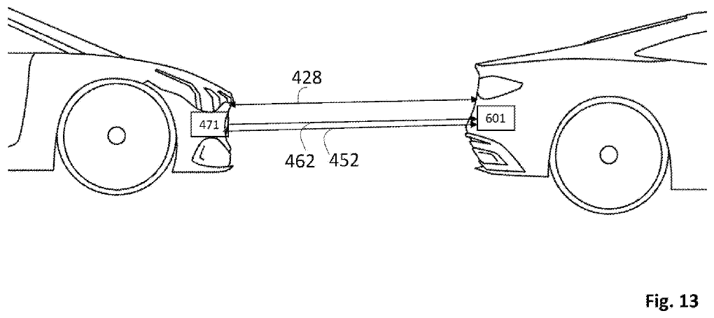

FIG. 13 a schematic illustration of an exemplary interaction between two cars comprising a single-photon transmission device according to the invention and a single-photon receiving device according to the invention;

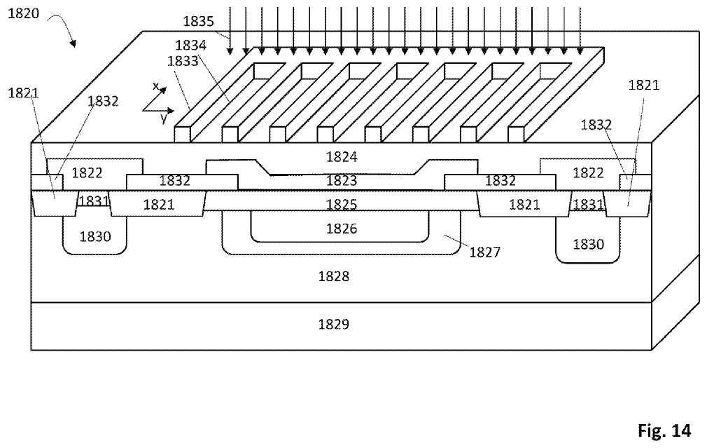

FIG. 14 a schematic illustration of an exemplary SPAD diode for use as a sensor element of a single-photon detector of a single-photon transmission device and/or a single-photon receiving device according to the invention; and

FIG. 15 a schematic illustration of a metal-optical filter with metal-optical subfilters for a SPAD diode array of SPAD diodes according to FIG. 14.

FIG. 1 shows a schematic and simplified illustration of an optical means of a QKD receiver 101 according to the prior art, in which case the QKD receiver is a single-photon receiving device 101.

The latter is a single-photon receiving device for a polarization-modulated single-photon beam. A polarization direction modulated stream of single photons 102 enters a QKD receiving system of the single-photon receiving device 101 for a polarization-modulated single-photon beam via a receive path 152. A non-polarizing first beam splitter 183 splits the polarization direction modulated stream of single photons 102 in the receive path 152 into a first signal path 1604 and a second signal path 187. In this case, at a probability of 50%, a single photon of the polarization direction modulated stream of the single photons 102 in the receive path 152 enters the first signal path 1604, and at a probability of 50%, a single photon of the polarization direction modulated stream of the single photons 102 in the receive path 152 enters the second signal path 187. A second polarizing beam splitter 184 splits the one first single-photon stream 1604 into a third horizontally polarized single-photon stream and a fourth vertically polarized photon stream. The second polarizing beam splitter 184 directs the photons of light in the first signal path 1604, which have a horizontal polarization, to a first single-photon detector 176 for horizontally polarized single photons and the photons of light in the first signal path 1604, which have a vertical polarization, to a second single-photon detector 177 for vertically polarized single photons. A λ/4 plate 188 rotates the photons in the second signal path 187 by 45° and feeds these rotated photons into a rotated second signal path 189. A third polarizing beam splitter 190 directs the −45° polarized single photons of light in the rotated second signal path 189 to a fourth single-photon detector 179, and the +45° polarized single photons of light in the rotated second signal path 189 to a third single-photon detector 178.

In this way, the proposed single-photon receiving device 101 for a polarization direction modulated stream 102 of the single photons can detect the polarization modulation of the polarization direction modulated stream 102 of the single photons in the receive path 152 and provide it to a computer, such as a microcontroller core.

FIG. 2 shows a schematic and simplified illustration of an optical means of a QKD single-photon transmission device 201 according to the prior art.

It is a single-photon transmission device 201 for transmitting a stream of polarization-modulated single photons 102. The polarization direction modulated stream of single photons 102 exits the QKD single-photon transmission device 201 via the receive path 152 as a polarization-modulated single-photon beam 102.

The polarization modulatable single-photon source 201 comprises a first single-photon source 236 for horizontally polarized single photons and a second single-photon source 237 for vertically polarized single photons and a third single-photon source 238 for horizontally polarized single photons and a fourth single-photon source 239 for vertically polarized single photons. The single photons from the third single-photon source 238 for horizontally polarized single photons and the fourth single-photon source 239 for vertically polarized single photons must pass through a A/4 plate 288 before leaving the polarization-modulated single-photon source 201. This λ/4 plate 288 rotates the polarization of the single photons of the third single-photon source 238 for horizontally polarized single photons and the single photons of the fourth single-photon source 239 for vertically polarized single photons by 45°. Therefore, the third single-photon source 238 for horizontally polarized single photons is actually a third single-photon source 238 for +45° polarized single photons with respect to the receive path 152. Similarly, for this reason, the fourth single-photon source 239 for vertically polarized single photons is actually a fourth single-photon source 239 for −45° polarized single photons with respect to the receive path 152.

A first beam splitter 283 and a second beam splitter 284 and a third beam splitter 290 combine the single photons from the first single-photon sources 236 and the second single-photon source 237 and the third single-photon source 238 and the fourth single-photon source 239 into a common stream 102 of single photons in the receive path 152.

A control device, typically a microcontroller core, now controls only one single-photon source of the four single-photon sources at a time for a very short time, so that overall polarization modulation of the stream 102 of the single photons is possible in 45° steps.

FIG. 3 shows another way of mixing together single photons from differently polarized single-photon sources 336 to 339 to form a common beam 102 of single photons according to the prior art.

In the example in FIG. 3, exemplary n=4 single-photon sources are arranged around the system axis. The system axis is preferably substantially equal to the optical axis of the stream 102 of single photons. The respective optical beam axes of the respective single-photon sources 336 to 339 are arranged perpendicular to the system axis of the stream 102 of single photons. Preferably, the respective optical beam axes of the respective single-photon sources 336 to 339 are substantially in a plane arranged perpendicular to the system axis of the beam 102 of single photons. The respective optical beam axes of the respective single-photon sources 336 to 339 preferably intersect substantially at a crossing point. An exemplary conical mirror 1301 comprises a reflective surface in the shape of a cone and a rotational axis of symmetry. The rotational axis of symmetry of the conical mirror 1301 is preferably arranged substantially parallel to and substantially congruent with the system axis. The intersection of the respective optical beam axes of the respective single-photon sources 336 to 339 is preferably substantially on the system axis and substantially on the rotational symmetry axis of the conical mirror 1301, and typically within the conical mirror 1301. The n=4 respective optical beam axes of the respective single-photon sources 336 to 339 differ from each other by an angle of (k−1)/(2*n)*360° where k is the number of the respective single-photon source 336 to 339. In the example in FIG. 3, n=4 is selected. Therefore, the angles of the respective optical beam axes of the respective single-photon sources 336 to 339 differ by 45° with respect to the respective optical beam axes of the respective directly adjacent single-photon sources of the single-photon sources 336 to 339. Other numbers of single-photon sources are possible. For example, 8 or 16 single-photon sources are conceivable. Preferred is n≥2. Better is n≥4. A spatial filter 1302 eliminates slight variations in photon density per unit time depending on the single-photon transmission device 336 to 339 emitting a single photon. In the example in FIG. 3, the spatial filter 1302 comprises a first pinhole 344 and a second, spaced-apart pinhole 345. By arranging the n single-photon sources in an arrangement plane perpendicular to the beam axis of the stream 102 of single photons and by rotating the optical beam axes of the single-photon sources by (k−1)/(2*n)*360° relative to each other, the device presented can perform a quantized modulation of the polarization of the single photons in steps of (k−1)/(2*n)*360°. The conical mirror 1301 deflects the single photons of the respective single-photon sources 336 to 339, whose respective beam axes are aligned differently in the arrangement plane, into the common beam direction of the beam axis of the single photons 102. The spatial filter 1302 optionally eliminates any smaller single-photon sources specific deviations that may occur.

FIG. 4 shows a simplified schematic of an exemplary single-photon transmission device 401 according to the invention using the example of a car key system 401 without alignment aids for a car.

The core of the car key system 401 is a microcontroller core 416. Essential parts of the single-photon transmission device, in particular of the car key system, 401 are preferably microintegrated on a semiconductor substrate. These parts are preferably manufactured using CMOS, BiCMOS or bipolar technology.

The single-photon transmission device 401 preferably comprises one or a plurality of internal databuses 402, over which the microcontroller core 416 of the single-photon transmission device 401 preferably handles the internal data communication. Furthermore, the single-photon transmission device preferably comprises one or a plurality of read/write memories RAM 403 for storing and providing use of data and program instructions by the microcontroller core 416. Furthermore, the single-photon transmission device 401 preferably comprises one or a plurality of writable non-volatile memories 404. These non-volatile memories can comprise, for example, EEPROM memory 404 or flash memory 404 or OTP memory 404. Furthermore, the single-photon transmission device 401 preferably comprises one or a plurality of non-volatile, read-only memories 405, such as a ROM 405. These read-only memories preferably comprise program code and program data for the microcontroller core 416, which typically processes this program code. Program code and program data can also be stored in the one or a plurality of writable non-volatile memories 404.

The exemplary single-photon transmission device 401 preferably comprises one or a plurality of non-volatile, writable and/or non-writable manufacturer memories 406. In the case of a non-writable manufacturer memory 406, the manufacturer memory 406 can, e.g., be a manufacturer ROM. Furthermore, the exemplary single-photon transmission device 401 preferably comprises one or a plurality of cryptography accelerators 407, for example a DES accelerator and/or an AES accelerator 407, to accelerate the processing of the cryptography algorithms by the microcontroller core 416 of the exemplary single-photon transmission device 401. Also, the exemplary single-photon transmission device 401 preferably comprises one or a plurality of manufacturer memory firewalls 408 that prevent unauthorized access to the manufacturer memory 406 and only allow access after appropriate authentication, such as by means of a password. Preferably, the manufacturer memory firewalls irrevocably block access if more than a permitted number of unsuccessful access attempts to the manufacturer memory 406 have been made. Another device for increasing efficiency can be one or a plurality of cyclic redundancy check (CRC) modules 411 of the exemplary single-photon transmission device 401. Said modules calculate a CRC check data word for a specified amount of data in the way used by, e.g., many data communication protocols. Furthermore, the exemplary single-photon transmission device 401 typically comprises one or a plurality of clock driver module (CLK) 412 that provide the system clocks to operate the device components of the exemplary single-photon transmission device 401. Preferably, the exemplary single-photon transmission device 401 comprises one or a plurality of timer modules 413 that control temporal sequences within the exemplary single-photon transmission device 401. Preferably, the exemplary single-photon transmission device 401 comprises one or a plurality of security monitoring and security control circuits 414 that monitor the integrity of the exemplary single-photon transmission device 401 and optionally initiate countermeasures in the event of an attack. The exemplary single-photon transmission device 401 preferably comprises at least one preferably quantum random number generator (QRNG) 415. This has the advantage that the entropy of its random number is particularly suitable for encryption. Typically, the exemplary single-photon transmission device 401 comprises one or a plurality of 8/16/32/64-bit microcontroller cores 416 that execute the programs in the memory of the exemplary single-photon transmission device 401. The exemplary single-photon transmission device 401 preferably comprises one or a plurality of optional data interfaces 417, in particular one or plurality of Universal Asynchronous Receiver Transmitters (UART) to support high-speed serial data, for data communication with other computer systems.

One or a plurality of base clock drivers 421 (CLK) are preferably part of the exemplary single-photon transmission device 401. Preferably, the exemplary single-photon transmission device 401 comprises one or a plurality of reset circuits 422. The one or a plurality of power supply or Vcc circuits 423 comprise voltage regulators which provide operating voltages for the microcontroller system of the exemplary single-photon transmission device 401 and the other subdevices of the exemplary single-photon transmission device 401. Preferably, the one or a plurality of power supply or Vcc circuits 423 also comprise at least one power reserve, such as a battery or accumulator. Particularly preferably, the one or a plurality of power supply or Vcc circuits 423 also comprise a charging circuit and a first charging coil, which is typically not a device component of the exemplary single-photon transmission device 401, for inductive coupling to a second charging coil, which is preferably part of a device external to the exemplary single-photon transmission device 401 and/or separate from the exemplary single-photon transmission device 401. The external charging device transmits energy, by means of an inductive coupling, from an energy system, for example a battery or an alternator or the like, or from an energy system of the external charging device, for example an energy storage or a generator or a solar cell or a power grid or the like, by means of the charging circuit of the one or a plurality of power supply or Vcc circuits 423 of the example single-photon transmission device 401 to the energy reserve of the one or a plurality of power supply or Vcc circuits 423 of the example single-photon transmission device 401. The exemplary single-photon transmission device 401 typically comprises one or a plurality of ground circuits 424 that protect the device against polarity reversal and ground line attacks. The exemplary single-photon transmission device 401 further typically comprises one or a plurality of input/output circuits 425 that enable the exemplary single-photon transmission device 401 to actuate or read or otherwise communicate with other devices.

FIG. 4 shows an exemplary and schematic block diagram of an exemplary system for using the exemplary single-photon transmission device 401 in, for example, automotive car keys. FIG. 4 shows a diagram of an example of an exemplary single-photon transmission device 401. The exemplary single-photon transmission device 401 comprises, for example, memory elements connected to an internal databus 402 of the exemplary single-photon transmission device 401. The memory elements of the exemplary single-photon transmission device 401 can comprise, for example, one or a plurality of read/write memory RAM 403, one or a plurality of writable non-volatile memory such as EEPROM memory 404 or flash memory 404 or OTP memory 404. Furthermore, the exemplary single-photon transmission device 401 preferably comprises one or a plurality of non-volatile, read-only memories 405, such as a ROM. The exemplary single-photon transmission device 401 further preferably comprises one or a plurality of non-volatile, writable and/or non-writable manufacturer memories 406. In the case of a non-writable manufacturer memory, the manufacturer memory 406 can be a manufacturer ROM. Preferably, the manufacturer ROM 406 comprises boot software for the microcontroller core 416 of the exemplary single-photon transmission device 401. The exemplary single-photon transmission device 401 comprises, e.g., one or a plurality of cryptography accelerator 407, such as a DES accelerator and/or an AES accelerator 407, preferably connected to the microcontroller core 416 of the exemplary single-photon transmission device 401 via the internal databus 402 of the exemplary single-photon transmission device 401. For example, one or a plurality of manufacturer memory firewalls 408 can be provided between the manufacturer memory 406 of the exemplary single-photon transmission device 401 and the internal databus 402 of the exemplary single-photon transmission device 401. The exemplary single-photon transmission device 401 preferably comprises, e.g., processing modules of the exemplary single-photon transmission device 401 that communicate with the microcontroller core 416 of the exemplary single-photon transmission device 401 via the internal databus 402 of the exemplary single-photon transmission device 401. The processing modules of the exemplary single-photon transmission device 401 preferably comprise at least one of the following modules: a cyclic redundancy check (CRC) module 411 of the exemplary single-photon transmission device 401, a clock driver module 412 of the exemplary single-photon transmission device 401, one or a plurality of timer modules 413 of the exemplary single-photon transmission device 401, a security monitoring and security control circuit 414 of the exemplary single-photon transmission device 401, one or a plurality of preferably quantum random number generator(s) 415 (abbreviated as QRNG) of the exemplary single-photon transmission device 401, one or a plurality of 8/16/32/15-bit microcontroller cores 416 of the exemplary single-photon transmission device 401, and one or a plurality of data interfaces 417 of the exemplary single-photon transmission device 401, in particular one or a plurality of Universal Asynchronous Receiver Transmitters (UART) for supporting high-speed serial data. Other circuit components of the exemplary single-photon transmission device 401 comprise, e.g., one or a plurality of base clock drivers 421 (CLK), and/or one or a plurality of clock driver modules 412, a reset circuit 422, a power supply or Vcc circuit 423 comprising voltage regulators which provide the operating voltage, a ground circuit 424, and an input/output circuit 425.

Preferably, the exemplary single-photon transmission device 401 is configured to provide secure authentication. The exemplary single-photon transmission device 401 preferably stores, for example, in addition to the authentication code, further data, e. g., one or a plurality of lifetime and usage data and/or e.g., logistic data and/or e.g., commercial data and/or website and email addresses and/or image data, a set of instructions for control units of a car 802, using which the microcontroller core 416 of the exemplary single-photon transmission device 401 communicates via a data interface of the exemplary single-photon transmission device 401. In addition, the exemplary single-photon transmission device 401 can store other application data. Preferably, the exemplary single-photon transmission device 401 comprises, for example, a microcontroller core 416 which is configured to facilitate secure authentication of a product.

The internal databus 402 of the exemplary single-photon transmission device 401 can comprise a plurality of databuses 402 for multiple microcontroller cores 416 of the exemplary single-photon transmission device 401, such that these a plurality of microcontroller cores 416 can independently access different subdevices of the exemplary single-photon transmission device 401 simultaneously. Generally, however, the exemplary single-photon transmission device 401 comprises only one internal databus 402 and only one microcontroller core 416. Preferably, the microcontroller core 416 of the exemplary single-photon transmission device 401 is an ARM processor or the like. The latter is preferably an 8-bit, 16-bit, 32-bit, or 64-bit microcontroller core 416.

Preferably, the exemplary single-photon transmission device 401 comprises one or a plurality of read/write memories RAM 403. These can be SRAMs and/or MRAMs and/or FRAMS or similar. The one or a plurality of read-only memories RAM 403 of the exemplary single-photon transmission device 401 can also be, in whole or in part, dynamic read/write memories such as DRAMs, which the microcontroller core 416 or a refresh device of the exemplary single-photon transmission device 401 reads and rewrites at regular time intervals in a refresh cycle. In order for the microcontroller core 416 to access a memory of the exemplary single-photon transmission device 401, the exemplary single-photon transmission device 401 can comprise access logic that periodically performs this refresh and controls this access. However, a DRAM typically opens up opportunities for an attack and is typically a potential vulnerability. Preferably, this read/write memory RAM 403 of the exemplary single-photon transmission device 401 can be accessed by the microcontroller core 416 of the exemplary single-photon transmission device 401 by means of the internal databus 402 of the exemplary single-photon transmission device 401.

Preferably, the exemplary single-photon transmission device 401 comprises one or a plurality of writable and non-volatile memories 404. Preferably, these writable and non-volatile memories 404 of the exemplary single-photon transmission device 401 can be accessed by the microcontroller core 416 of the exemplary single-photon transmission device 401 by means of the internal databus 402 of the exemplary single-photon transmission device 401. These non-volatile memories 404 of the exemplary single-photon transmission device 401 can comprise, for example, EEPROM memory 404 or flash memory 404 or OTP memory 404. OTP is the abbreviation for “One Time Programmable”, which means programmable only once.

One attack option may be to erase the non-volatile memories 404 by means of radiation, for example X-rays and/or ionizing radiation and/or heating of storage cells. To this end, the exemplary single-photon transmission device 401 preferably comprises one or a plurality of security monitoring and security control circuits 414 of the exemplary single-photon transmission device 401 that monitor the data integrity of the storage cells of the erasable memories 404 of the exemplary single-photon transmission device 401. Preferably, the storage cells of the erasable memories 404 of the exemplary single-photon transmission device 401 have a redundancy such that at least two check bits are provided for a data word, which is preferably a data word of 8 bits in length, i.e. a byte, and that always at least a first check bit must have the content 1 and another far check bit assigned to this first check bit must have the content 0. For example, the first check bit can be a parity bit of the byte and the second check bit can be the inverse bit of the parity bit to the first check bit. If an ionizing radiation attack or similar occurs, the attack resets both check bits to the same value. This is an illegal condition that the exemplary single-photon transmission device 401 can detect. The one or a plurality of security monitoring and security control circuits 414 of the exemplary single-photon transmission device 401 detect such a deviation and optionally disable the exemplary single-photon transmission device 401 from further access for at least a preferably predetermined period of time.

Preferably, each bit of the memory of the exemplary single-photon transmission device 401 is dual, so that preferably each logical data bit is realized as a pair of a first physical data bit having a first internal logical value and a second physical data bit having a second internal logical value. Typically, the second internal logical value is the logical inverse of the first internal logical value. That this is always the case is again preferably monitored by the one or a plurality of security monitoring and security control circuits 414 of the exemplary single-photon transmission device 401. The one or a plurality of security monitoring and security control circuits 414 of the exemplary single-photon transmission device 401 again detect deviations and (by way of example and optionally) preferably disable further execution of programs or certain program components and/or access to data for, e.g., the microcontroller core 416 in the event of deviations. Preferably, the exemplary single-photon transmission device 401 comprises one or a plurality of reset circuits 422 of the exemplary single-photon transmission device 401. The reset circuits 422 of the exemplary single-photon transmission device 401 respectively set the exemplary single-photon transmission device 401 and/or subdevices of the exemplary single-photon transmission device 401 to predefined states if predetermined or determinable reset conditions and/or combinations and/or temporal sequences of such reset conditions are present. For example, these conditions may be, for example, signaling of the one or a plurality of security monitoring and security control circuits 414 of the exemplary single-photon transmission device 401 to one or a plurality of reset circuits 422 of the exemplary single-photon transmission device 401. Also, these conditions may be changes and/or values of electrical node potentials relative to the potential of a reference node or reference potential line, such as one or a plurality of operating voltages of the exemplary single-photon transmission device 401. A watchdog timer can be part of a reset circuit 422 of the exemplary single-photon transmission device 401. Furthermore, such conditions can relate to the integrity of the housing of the exemplary single-photon transmission device 401. Preferably, the housing of the exemplary single-photon transmission device 401 comprises a detector for opening or damaging the housing of the exemplary single-photon transmission device 401. For example, this can be a single conduit, such as a textile network, surrounding or covering the exemplary single-photon transmission device 401 or covering at least portions of the exemplary single-photon transmission device 401. It can also be a network of lines covering the exemplary single-photon transmission device 401 for the sole purpose of detecting an attack. For example, the exemplary single-photon transmission device 401 can inject an electrical current into one or a plurality of such lines by means of a first input/output line, respectively, and withdraw it again at one or a plurality of second input/output lines. If the stream flow is interrupted, this is an indication of an attack in which one or a plurality of the one or a plurality of security monitoring and security control circuits 414 of the exemplary single-photon transmission device 401 may detect, and which then signal this attack to, e.g., the microcontroller core 416 of the exemplary single-photon transmission device 401. For example, in such a case of suspected violation of the integrity of the housing of the exemplary single-photon transmission device 401, one or a plurality of the one or a plurality of security monitoring and security control circuits 414 of the exemplary single-photon transmission device 401 can prevent read and/or write access to memory contents of the memory of the exemplary single-photon transmission device 401. of the memories of the exemplary single-photon transmission device 401 and/or erase such contents of the memories of the exemplary single-photon transmission device in whole or in part or set such contents of the memories of the exemplary single-photon transmission device 401 to predefined values or overwrite them with nonsensical data or otherwise manipulate them. The memories of the exemplary single-photon transmission device 401 preferably comprise one or a plurality of non-volatile, read-only memories 405, such as a ROM. Preferably, the ROM of the exemplary single-photon transmission device 401 contains data and/or program instructions defined by the design. Preferably, the exemplary single-photon transmission device 401 comprises one or a plurality of non-volatile, writable and/or non-writable manufacturer memories 406 in which the semiconductor manufacturer or another supplier can store its production and security data, such as serial numbers, etc. Preferably, the semiconductor manufacturer locks access to this writable and/or non-writable non-volatile manufacturer memory 406 of the exemplary single-photon transmission device 401 after execution of the last production test. Preferably, the writable and/or non-writable manufacturer memory 406 of the exemplary single-photon transmission device 401 can be accessed by means of one or a plurality of manufacturer passwords. In some cases, a double key method is advantageous. In that case, a customer following the semiconductor manufacturer stores a customer password in a customer lock register of the exemplary single-photon transmission device 401 that is also lockable for access with a password. Preferably, the semiconductor manufacturer can only access all memory areas of the exemplary single-photon transmission device 401 using the customer password and the semiconductor password. Preferably, the semiconductor manufacturer provides an analysis password by means of which it can cause one or a plurality of the one or a plurality of security monitoring and security control circuits 414 of the exemplary single-photon transmission device 401 to erase, typically with the aid of the reset circuit 422 of the exemplary single-photon transmission device 401, the customer contents in the memories of the exemplary single-photon transmission device 401 and then make all memory areas of the exemplary single-photon transmission device 401 accessible for the analysis of errors. In the case of a non-writable manufacturer memory of the exemplary single-photon transmission device 401, the manufacturer memory 406 of the exemplary single-photon transmission device 401 can, e.g., be a manufacturer ROM whose contents are determined, for example, during manufacturing of the semiconductor circuit of the exemplary single-photon transmission device 401. The exemplary single-photon transmission device 401 is typically intended to receive and/or send data and/or program code portions and/or instructions in encrypted form by means of cryptographic procedures stored in the memories of the exemplary single-photon transmission device 401 and executed by one or a plurality of the microcontroller cores 416 of the exemplary single-photon transmission device 401. Preferably, the encryption is QKD encryption in each case. These methods sometimes require considerable computing power. It has therefore proven to be the case that not only the microcontroller core 416 of the exemplary single-photon transmission device 401 executes certain program components of these cryptography methods in the form of sub-steps of these cryptography methods, but that one or a plurality of special hardware accelerators of the exemplary single-photon transmission device 401 preferably in the form of one or a plurality of cryptography accelerators 407 of the exemplary single-photon transmission device 401 execute these program components. For this purpose, the exemplary single-photon transmission device 401 preferably comprises, for example, a DES accelerator 407 for the DES algorithm and/or an AES accelerator 407 for executing the AES algorithm. The microcontroller core 416 of the exemplary single-photon transmission device 401 typically addresses these hardware accelerators of the exemplary single-photon transmission device 401 via the internal databus 402 of the exemplary single-photon transmission device 401. Preferably, the microcontroller core 416 of the exemplary single-photon transmission device 401 comprises a redundant clock system of the exemplary single-photon transmission device 401 to detect accesses to the clock system of the exemplary single-photon transmission device 401. One or a plurality of of the one or a plurality of security monitoring and security control circuits 414 of the exemplary single-photon transmission device 401 monitor the consistency of the logical contents of this preferred plurality of redundant clock systems of the exemplary single-photon transmission device 401, and thus can detect attacks and errors. Preferably, access by the microcontroller core 416 of the exemplary single-photon transmission device 401 and the test logic of the exemplary single-photon transmission device 401 to the manufacturer memories of the exemplary single-photon transmission device 401 is prevented by one or a plurality of manufacturer memory firewalls 408 of the exemplary single-photon transmission device 401. These manufacturer firewalls 408 of the exemplary single-photon transmission device 401 can preferably be unlocked by a manufacturer password, as described. Preferably, the number of incorrect entries is very limited to minimize the likelihood of a successful attack. Preferably, the exemplary single-photon transmission device 401 comprises over one or a plurality of cyclic redundancy check (CRC) modules 411 of the exemplary single-photon transmission device 401 so that the exemplary single-photon transmission device 401 for a serial data communication can efficiently generate the CRC data used in most data protocols to detect erroneous data transmissions, initially in the case of a transmission and subsequently in the case of a reception to quickly verify the correct reception of the data message. Preferably, the exemplary single-photon transmission device 401 comprises one or a plurality of clock driver modules (CLK) 412 that generate one or a plurality of clock signals to operate the circuits of the exemplary single-photon transmission device 401. Preferably, the one or a plurality of clock driver modules (CLK) 412 of the exemplary single-photon transmission device 401 generate redundant clock signals to detect an attack on the clock system of the exemplary single-photon transmission device 401. Typically, the exemplary single-photon transmission device 401 comprises one or a plurality of timer modules 413, such as those required by the microcontroller core 416 to detect time-outs. Preferably, the exemplary single-photon transmission device 401 comprises one or a plurality of watchdog timers that monitor the processing of the various program components by the one or a plurality of microcontroller cores 416 of the exemplary single-photon transmission device 401. These watchdog timers can be part of the one or a plurality of the one or a plurality of security monitoring and security control circuits 414 of the exemplary single-photon transmission device 401. Suggestively, the exemplary single-photon transmission device 401 comprises at least one preferably quantum random number generator (QRNG) 415. Quantum random number generators have the advantage that they are based on true random numbers. In the 1970s, the physicist Bell proved that the theory of “hidden parameters” was wrong. In other words, there are no hidden causes for the randomness of quantum mechanical events, e.g. the emission of photons. The microcontroller core 416 of the exemplary single-photon transmission device 401 mentioned multiple times hereinabove can, e.g., be an 8-bit microcontroller core, or a 16-bit microcontroller core, or a 32-bit microcontroller core, or a 64-bit microcontroller core, or a 128-bit microcontroller core, or the like. The exemplary single-photon transmission device 401 can comprise one or a plurality of 8/16/32/15-bit microcontroller cores 416, which can preferably access the other subdevices of the exemplary single-photon transmission device 401 via one or a plurality of internal databuses 402 of the exemplary single-photon transmission device 401. Preferably, the exemplary single-photon transmission device 401 comprises one or a plurality of data interfaces 417 of the exemplary single-photon transmission device 401. Such data interfaces 417 can, e.g., be one or a plurality of Universal Asynchronous Receiver Transmitters (UART) to support high speed serial data. Preferably, the exemplary single-photon transmission device 401 comprises one or a plurality of base clock drivers 421 (CLK), each of which preferably provides a base clock to one or a plurality of clock driver modules (CLK) 412 of the exemplary single-photon transmission device 401. Preferably, the base clock drivers 421 (CLK) of the exemplary single-photon transmission device 401 are oscillators. Preferably, the exemplary single-photon transmission device 401 also comprises one or a plurality of power supply or Vcc circuits 423 comprising voltage regulators which provide the operating voltages for the exemplary single-photon transmission device 401. Preferably, the exemplary single-photon transmission device 401 also comprises one or a plurality of ground circuits 424 comprising, for example, polarity reversal protection and protection circuits against tampering with the electrical potential of the semiconductor substrate of the semiconductor crystal of the microintegrated tele of the exemplary single-photon transmission device 401. For example, it is advantageous for one or a plurality of the one or a plurality of ground circuits 424 of the exemplary single-photon transmission device 401 to comprise polarity reversal protection. For example, it is advantageous if one or a plurality of the one or a plurality of ground circuits 424 of the exemplary single-photon transmission device 401 and/or one or a plurality of the one or a plurality of power supply or Vcc circuits 423 of the exemplary single-photon transmission device 401 interact such that modulation of the power consumption and/or internal resistance and/or voltage drop between the supply voltage terminals of the exemplary single-photon transmission device 401 does not allow conclusions to be drawn about the operations and/or states of the exemplary single-photon transmission device 401, at least at times.

For controlling other devices and/or for communicating with other devices and/or for monitoring other devices, it is generally advantageous if the exemplary single-photon transmission device 401 comprises one or a plurality of input/output circuits 425, which are generally implemented as digital inputs and/or as digital outputs, which can preferably also assume a tri-state condition. The exemplary single-photon transmission device 401 can comprise an analog-to-digital converter that enables the microcontroller core 416 to monitor internal analog values, such as operating voltage, and external analog values. The analog-to-digital converter can be provided with an analog multiplexer to monitor a plurality of internal electrical nodes of the exemplary single-photon transmission device 401 for correctness of the values of the electrical potential with respect to a reference potential of the exemplary single-photon transmission device 401. Preferably, the microcontroller core 416 of the exemplary single-photon transmission device 401 controls this analog multiplexer. The exemplary single-photon transmission device 401 can optionally be provided with one or a plurality of driver stages 692 in order to, e.g., drive actuators 694. Such actuators 694 can, e.g., be motors and/or other resistive and/or inductive and/or capacitive loads and the like. Such a driver stage 692 of the exemplary single-photon transmission device 401 can, e.g., be a half-bridge and/or an H-bridge or the like. It is also conceivable that they are power sources of the exemplary single-photon transmission device 401 for, e.g., light sources such as LEDs.

Therefore, the present application proposes an exemplary single-photon transmission device 401, in particular for safely controlling devices in automobiles, comprising a semiconductor crystal. Preferably, the exemplary single-photon transmission device 401 is fabricated using CMOS circuit technology, bipolar circuit technology, or BiCMOS circuit technology. The exemplary single-photon transmission device 401 preferably comprises memory elements, one or a plurality of internal databuses 402, one or a plurality of 8/16/32/15-bit microcontroller cores 416, and one or a plurality of preferably quantum random number generators (QRNG) 415 for generating true random numbers or high quality random numbers. The internal databus 402 of the exemplary single-photon transmission device 401 can comprise a plurality of databuses. The memory elements of the exemplary single-photon transmission device 401 are typically connected to the internal databus 402 of the exemplary single-photon transmission device 401. The data interfaces of the exemplary single-photon transmission device 401 are typically connected to the internal databus 402 of the exemplary single-photon transmission device 401. The one or a plurality of quantum random number generators (QRNG) 415 of the exemplary single-photon transmission device 401 are also preferably connected to the internal databus 402 of the exemplary single-photon transmission device 401. The one or a plurality of microcontroller cores 416 of the exemplary single-photon transmission device 401 are also preferably connected to the internal databus 402 of the exemplary single-photon transmission device 401. Preferably and typically, the one or a plurality of random number generators (QRNG) 415 generate one or a plurality of random numbers in response to a request from the microcontroller core 416 of the exemplary single-photon transmission device 401. Preferably, one or a plurality of the one or a plurality of microcontroller cores 416 of the exemplary single-photon transmission device 401 generate one or a plurality of keys using a respective program from one or a plurality of its memory elements of the exemplary single-photon transmission device 401 and using one or a plurality of the generated random numbers. Typically, one or a plurality of microcontroller cores 416 of the exemplary single-photon transmission device 401 encrypt and/or decrypt data using a respective program of the related microcontroller core 416, each of which programs originates from one or a plurality of the device's memory elements and, using a respective key for the generated keys, these microcontroller cores 416 typically exchange data via one or a plurality of data interfaces of the exemplary single-photon transmission device 401 with devices outside the exemplary single-photon transmission device 401 via one or a plurality of data interfaces of the exemplary single-photon transmission device 401.

In a further embodiment of the exemplary single-photon transmission device 401, the memory elements of the exemplary single-photon transmission device 401 comprise one or a plurality of read/write memory RAM 403 and/or one or a plurality of writable non-volatile memory, in particular EEPROM memory 404 and/or flash memory 404 and/or OTP memory 404, and/or one or a plurality of read-only memory and/or one or a plurality of non-volatile manufacturer memory. The one semiconductor memory or the multiple manufacturer memories of the exemplary single-photon transmission device 401 can, e.g., comprise one or a plurality of manufacturer ROMs 406 and/or one or a plurality of manufacturer EEPROMs and/or one or a plurality of manufacturer flash memories.

In a second further embodiment, the manufacturer memory of the exemplary single-photon transmission device 401, and more particularly a manufacturer ROM 406 of the exemplary single-photon transmission device 401, comprises boot software for booting the microcontroller core 416 of the exemplary single-photon transmission device 401 to securely boot the exemplary single-photon transmission device 401.

In a third further embodiment, the exemplary single-photon transmission device 401 comprises a manufacturer memory firewall 408 of the exemplary single-photon transmission device 401 between the manufacturer memory 406 of the exemplary single-photon transmission device 401 and the internal databus 402 of the exemplary single-photon transmission device 401, which prevents access to the manufacturer memory 406 of the exemplary single-photon transmission device 401 without authentication.

In a fourth further embodiment, the exemplary single-photon transmission device 401 comprises one or a plurality of the following components: a base clock driver 421 (CLK), a clock driver circuit 412, a reset circuit 422, a power supply circuit, or a Vcc circuit 423 comprising voltage regulators which provide the operating voltages for at least the exemplary single-photon transmission device 401, a ground circuit 424, an input/output circuit 425, and one or a plurality of processing modules. The processing modules of the exemplary single-photon transmission device 401 communicate with the internal databus 402 of the exemplary single-photon transmission device 401, and thus typically with a microcontroller core 416 of the exemplary single-photon transmission device 401. Preferably, the processing modules of the exemplary single-photon transmission device 401 comprise one or a plurality of the following modules: A cyclic redundancy check (CRC) module 411 of the exemplary single-photon transmission device 401, a clock driver module 412 of the exemplary single-photon transmission device 401, a crypto accelerator 407 of the exemplary single-photon transmission device 401, in particular a DES accelerator and/or an AES accelerator 407, one or a plurality of timer modules 413 of the exemplary single-photon transmission device 401, one or a plurality of security monitoring and control circuits 414 (of the exemplary single-photon transmission device 401) of the exemplary single-photon transmission device 401, and, one or a plurality of data interfaces of the exemplary single-photon transmission device 401, in particular a Universal Asynchronous Receiver Transmitter (UART) 417.

In a further embodiment of the exemplary single-photon transmission device 401, at least one data interface of the one or a plurality of data interfaces of the exemplary single-photon transmission device 401 is a wired automotive databus interface. In this case, the wired automotive databus interface can, e.g., be a CAN databus interface, a CAN FD databus interface, a Flexray databus interface, a PSI5 databus interface, a DSI3 databus interface, a LIN databus interface, an Ethernet databus interface, a LIN databus interface, or a MELIBUS databus interface.

In another embodiment of the exemplary single-photon transmission device 401, at least one data interface of the one or a plurality of data interfaces of the exemplary single-photon transmission device 401 is a wireless databus interface. The wireless databus interface can, e.g., be a Wi-Fi interface or a Bluetooth interface.

In a further embodiment of the exemplary single-photon transmission device 401, at least one data interface of the one or a plurality of data interfaces of the exemplary single-photon transmission device 401 is a wired databus interface. The wireless databus interface of the exemplary single-photon transmission device 401 can, e.g., be a KNX databus interface, an EIB databus interface, a DALI databus interface, or a PROFIBUS databus interface.

Preferably, the exemplary single-photon transmission device 401 comprises one or a plurality of wireless data interfaces 426 for communicating with other computer systems. For example, the exemplary single-photon transmission device 401 can communicate via a respective antenna 427 of a respective wireless interface 426 of the exemplary single-photon transmission device 401. In this case, the antenna 427 emits an electromagnetic data signal 428 that the single-photon transmission device 401 exchanges with a single-photon receiving device 601 in a wired or wireless manner. In the case of a car key as a single-photon transmission device 401, the car key 401 exchanges data with the single-photon receiving device 601 preferably by means of a wireless data interface 426 and its antenna 427.

For generating a polarization-modulated single-photon beam 452, the single-photon transmission device 401 preferably comprises an actuating device 429 for the single-photon sources 436, 437, 438, 439, 440. The microcontroller core 416 controls the actuating device 429 via the internal databus 402. To this end, the microcontroller core 416 can transmit configuration data of the actuating device 429 to the actuating device 429 via the internal databus 402 and read status information of the actuating device 429 via the databus 402. Such status information can, e.g., be measurement data of the single-photon sources 436 to 440 or of device components related thereto. A control line 430 connects the actuating device 429 to an adjustable voltage regulator 442. The actuating device 429 adjusts the voltage between a supply voltage line 441 of the single-photon sources 436, 437, 438, 439, 440 and a reference potential by means of the control line 430. The reference potential is typically an internal ground potential of an internal ground line of the single-photon transmission device 401. The adjustable voltage regulator 442 generates from the potential of the supply voltage line 443 the potential of the supply voltage line 441 of the single-photon sources 436, 437, 438, 439, 440 adjusted by the actuating device 429 with respect to the internal reference potential of the single-photon transmission device 401.

The single-photon transmission device 401 comprises one or a plurality of power supplies 442 for the single-photon sources 436 to 440 or n single-photon sources. The energy source, e.g. a key battery, supplies the power supply 442 of the single-photon sources 436 to 440 with electrical energy via an light source supply voltage line 443. The power supply 442 regulates the operating voltage of the single-photon sources 436 to 440 preferably by means of a linear regulator in order to avoid causing interference as far as possible. Optionally, the actuating device for the single-photon sources 436, 437, 438, 439, 440 does not track the regulation of the voltage between the supply voltage line 441 of the single-photon sources and a reference potential (typically ground) during the generation of a QKD key in order to avoid control interference. Preferably, the power supply 442 comprises a small power reserve, e.g. a capacitor, for stabilization.

The supply voltage line 441 connects the respective consumers within the single-photon transmission device 401 to one or a plurality of power supply or Vcc circuits 423 comprising voltage regulators which provide the operating voltages for the microcontroller system of the single-photon transmission device 401 and the polarization-modulated single-photon transmission devices of the single-photon transmission device 401. The supply voltage line 441 can also comprise a plurality of lines each connecting, for example, a consumer of electrical power, i.e. a subdevice of the single-photon transmission device 401, to a respective voltage regulator or power source of the one or a plurality of power supply or Vcc circuits 423. The adjustable voltage regulator 442 reduces the voltage between the potential of the supply voltage line 443 to such an extent that the potential of the supply voltage line 441 of the single-photon sources 436, 437, 438, 439, 440 is sufficient with respect to the internal reference potential of the single-photon transmission device 401 so that the single-photon transmission device 401 can just about operate all the single-photon sources 436 to 440. The single-photon sources 436 to 440 each comprise light sources 464 and respective power sources 463 of the respective single-photon source of the single-photon sources 436 to 440. The power source 463 adjusts the single-photon rate of the respective associated light source 464 of its single-photon source of the single-photon sources 436 to 440 depending on signalizations of its associated control line of the control lines 431 to 435 for the associated power source 463 of the associated single-photon source of the single-photon sources 436 to 440. The respective power sources 463 of the respective single-photon sources 436 to 440 perform the actual adjustment of the photon density of the light emission of the single-photon sources 436 to 440. The respective power sources 463 of the respective single-photon sources 436 to 440 perform this adjustment depending on control data for the single-photon sources 436 to 440 transmitted by the actuating device 429 by means of the respective control line of the control lines 431 to 435.

The microcontroller core 416 preferably controls the actuating device 429 via the internal databus 402. The microcontroller core 416 preferably exchanges data with the actuating device 429 via the internal databus 402.

A first control line 431 connects the actuating device 429 to the first power source 463 of the first single-photon sources 436. Via the first control line 431 for the first power source 463 of the first single-photon source 436, the actuating device 429 controls the electric current through the first power source 463 of the first single-photon source 436. The actuating device 429 thus controls the electric current through the first light source 464 of the first single-photon sources 436 by means of the first control line 431. In this manner, the actuating device 429 controls the polarized first light source 464 of the first single-photon sources 436. The first light source 464 of the first single-photon source 436 emits either directly polarized single photons or emits single photons of different polarizations, which polarization filters or polarizing optical functional means then polarize in the subsequent beam path. Preferably, the first control line 431 optionally also reports status data and/or measured values and/or other status parameters in digital or analog form of the first single-photon source 436 and its subdevices back to the microcontroller core 416 via the actuating device 429 for the single-photon sources 436, 437, 438, 439, 440. The firth control line 431 can comprise one or a plurality of digital or analog signal lines.

A second control line 432 connects the actuating device 429 to the second power source 463 of the second single-photon sources 437. Via the second control line 432 for the second power source 463 of the second single-photon source 437, the actuating device 429 controls the electric current through the second power source 463 of the second single-photon source 437. The actuating device 429 thus controls the electric current through the second light source 464 of the second single-photon sources 437 by means of the second control line 432. In this manner, the actuating device 429 controls the polarized second light source 464 of the second single-photon sources 437. The second light source 464 of the second single-photon source 437 emits either directly polarized single photons or emits single photons of different polarizations, which polarization filters or polarizing optical functional means then polarize in the subsequent beam path. Preferably, the second control line 432 optionally also reports status data and/or measured values and/or other status parameters in digital or analog form of the second single-photon source 437 and its subdevices back to the microcontroller core 416 via the actuating device 429 for the single-photon sources 436, 437, 438, 439, 440. The second control line 432 can comprise one or a plurality of digital or analog signal lines.

A third control line 433 connects the actuating device 429 to the third power source 463 of the third single-photon sources 438. Via the third control line 433 for the third power source 463 of the third single-photon source 438, the actuating device 429 controls the electric current through the third power source 463 of the third single-photon source 438. The actuating device 429 thus controls the electric current through the third light source 464 of the third single-photon sources 438 by means of the third control line 433. In this manner, the actuating device 429 controls the polarized third light source 464 of the third single-photon sources 438. The third light source 464 of the third single-photon source 438 emits either directly polarized single photons or emits single photons of different polarizations, which polarization filters or polarizing optical functional means then polarize in the subsequent beam path. Preferably, the third control line 433 also optionally reports status data and/or measured values and/or other status parameters in digital or analog form of the third single-photon source 438 and its subdevices back to the microcontroller core 416 via the actuating device 429 for the single-photon sources 436, 437, 438, 439, 440. The third control line 433 can comprise one or a plurality of digital or analog signal lines.

A fourth control line 434 connects the actuating device 429 to the fourth power source 463 of the fourth single-photon sources 439. Via the fourth control line 434 for the fourth power source 463 of the fourth single-photon source 439, the actuating device 429 controls the electric current through the fourth power source 463 of the fourth single-photon source 439. The actuating device 429 thus controls the electric current through the fourth light source 464 of the fourth single-photon source 439 by means of the fourth control line 434. In this manner, the actuating device 429 controls the polarized fourth light source 464 of the fourth single-photon sources 439. The fourth light source 464 of the fourth single-photon source 439 emits either directly polarized single photons or emits single photons of different polarizations, which polarization filters or polarizing optical functional means then polarize in the subsequent beam path. Preferably, the fourth control line 434 also optionally reports status data and/or measured values and/or other status parameters in digital or analog form of the fourth single-photon source 439 and its subdevices back to the microcontroller core 416 via the actuating device 429 for the single-photon sources 436, 437, 438, 439, 440. The fourth control line 435 can comprise one or a plurality of digital or analog signal lines. In the example in FIG. 4, the single-photon transmission device 401 comprises five single-photon sources 436 to 440. In the preferred embodiments, the single-photon transmission device only comprises more than 4 single-photon sources 436 to 439.

The example in FIG. 4 is only intended to illustrate that the single-photon transmission device 401 can comprise more than four single-photon sources 436 to 440. Preferably, the single-photon transmission device 401 comprises n single-photon sources 436 to 440 that feed single photons into the QKD coupling beam 452 depending on control by the actuating device 429. Typically, each of these n single-photon sources feeds the single photons emitted by it at a different polarization direction into the QKD coupling beam 452. The single-photon sources of the single-photon transmission device 401 can be numbered from 1 to n, with a single-photon source number k. The polarization direction of the single photons of a single-photon source with the single-photon source number k is preferably rotated by 360°*(k−1)/(2*n) with respect to the polarization direction of the single photons of a single-photon source with the single-photon source number 1. Particularly preferably, the number n of the single-photon sources of the single-photon transmission device 401 is a power of 2. It is preferably true that n=2^{(m-1)}, where m∈ [symbol] . The corresponding single-photon receiving device 601 (see FIG. 6) should then have a corresponding number of single-photon detectors 677 to 680 (see, for example, FIG. 6 regarding exemplary n=4). In this respect, the examples in FIGS. 4 and 5, where n=5, are only exemplary.

In the examples in FIGS. 4 and 5, the single-photon transmission device 401 therefore further comprises a fifth control line 435. The fifth control line 435 connects the actuating device 429 to the fifth power source 463 of the fifth single-photon source 440. Via the fifth control line 435 for the fifth power source 463 of the fifth single-photon sources 440, the actuating device 429 controls the electric current through the fifth power source 463 of the fifth single-photon sources 440. The actuating device 429 thus controls the electric current through the fifth light source 464 of the fifth single-photon sources 440 by means of the fifth control line 435. In this manner, the actuating device 429 controls the polarized fifth light source 464 of the fifth single-photon sources 440. The fifth light source 464 of the fifth single-photon source 440 emits either directly polarized single photons or emits single photons of different polarizations, which polarization filters or polarizing optical functional means then polarize in the subsequent beam path. Preferably, the fifth control line 435 optionally also reports status data and/or measured values and/or other status parameters in digital or analog form of the fifth single-photon source 440 and its subdevices back to the microcontroller core 416 via the actuating device 429 for the single-photon sources 436, 437, 438, 439, 440. The fifth control line 435 can comprise one or a plurality of digital or analog signal lines.

The single-photon transmission device 401 can have n single-photon sources with n being an integer positive number greater than 1. This general case is not shown in FIGS. 4 and 5. However, a skilled person will be able to easily rework this case based on the examples presented herein. In such a case, the single-photon transmission device 401 therefore also comprises an n-th control line. The n-th control line connects the actuating device 429 to the n-th power source 463 of the n-th single-photon sources. Via the n-th control line for the n-th power source 463 of the n-th single-photon source, the actuating device 429 controls the electric current through the n-th power source 463 of the n-th single-photon source. The actuating device 429 thus controls the electric current through the n-th light source 464 of the n-th single-photon source by means of the n-th control line. In this manner, the actuating device 429 controls the polarized n-th light source 464 of the n-th single-photon source. The n-th light source 464 of the n-th single-photon source either emits polarized single photons directly or emits single photons of different polarizations, which polarization filters or polarizing optical functional means then polarize in the subsequent beam path. Preferably, the n-th control line 435 optionally also reports status data and/or measured values and/or other status parameters in digital or analog form of the n-th single-photon source and its subdevices back to the microcontroller core 416 via the actuating device 429 for the single-photon sources. The n-th control line can comprise one or a plurality of digital or analog signal lines.

Provided that the single-photon transmission device 401 comprises n single-photon sources, an n-th control line connects the actuating device 429 to the n-th power source 463 of the n-th single-photon source. Via the n-th control line for the n-th power source 463 of the n-th single-photon source, the actuating device 429 controls the electric current through the n-th power source 463 of the n-th single-photon source. The actuating device 429 thus controls the electric current through the n-th light source 464 of the n-th single-photon source by means of the n-th control line. In this manner, the actuating device 429 controls the polarized n-th light source 464 of the n-th single-photon source. The n-th light source 464 of the n-th single-photon source either emits polarized single photons directly or emits single photons of different polarizations, which polarization filters or polarizing optical functional means then polarize in the subsequent beam path. Preferably, the n-th control line optionally also reports status data and/or measured values and/or other status parameters in digital or analog form of the n-th single-photon source and its subdevices via the actuating device 429 for the single-photon sources with k=1 to n back to the microcontroller core 416. The n-th control line can comprise one or a plurality of digital or analog signal lines.

The first single-photon sources 436 typically comprises a polarized first light source 464 and a first power source 463. For a better overview, these device components are hidden in FIGS. 4 and 5. They correspond to the representation for the fifth single-photon sources 440. The first power source 463 energizes the first light source 464 of the first single-photon source 436 so briefly and with such low energy that the first light source 464 of the first single-photon source 436 emits essentially only individual photons that are spatially and temporally separated from one another. Preferably, this energization of the first light source 464 of the first single-photon source 436 by the first power source 463 of the first single-photon source 436 is shorter than 1 ns, better shorter than 500 ps, better shorter than 200 ps, better shorter than 100 ps, better shorter than 50 ps, better shorter than 20 ps, better shorter than 10 ps, better shorter than 5 ps, better shorter than 2 ps, better shorter than 1 ps. Particularly preferably, this energization of the first light source 464 of the first single-photon source 436 by the first power source 463 of the first single-photon source 436 is shorter than 10 ps.

The second single-photon sources 437 typically comprises a polarized second light source 464 and a second power source 463. For a better overview, these device components are hidden in FIGS. 4 and 5. They correspond to the representation for the fifth single-photon sources 440. The second power source 463 energizes the second light source 464 of the second single-photon source 437 so briefly and with such low energy that the second light source 464 of the second single-photon source 437 emits essentially only individual photons that are spatially and temporally separated from one another. Preferably, this energization of the second light source 464 of the second single-photon source 437 by the second power source 463 of the second single-photon source 437 is shorter than 1 ns, better shorter than 500 ps, better shorter than 200 ps, better shorter than 100 ps, better shorter than 50 ps, better shorter than 20 ps, better shorter than 10 ps, better shorter than 5 ps, better shorter than 2 ps, better shorter than 1 ps. Particularly preferably, this energization of the second light source 464 of the second single-photon source 437 by the second power source 463 of the second single-photon source 437 is shorter than 10 ps.

The third single-photon source 438 typically comprises a polarized third light source 464 and a third power source 463. For a better overview, these device components are hidden in FIGS. 4 and 5. They correspond to the representation for the fifth single-photon sources 440. The third power source 463 energizes the third light source 464 of the third single-photon source 438 so briefly and with such low energy that the third light source 464 of the third single-photon source 438 emits essentially only individual photons that are spatially and temporally separated from one another. Preferably, this energization of the third light source 464 of the third single-photon source 438 by the third power source 463 of the third single-photon source 438 is shorter than 1 ns, better shorter than 500 ps, better shorter than 200 ps, better shorter than 100 ps, better shorter than 50 ps, better shorter than 20 ps, better shorter than 10 ps, better shorter than 5 ps, better shorter than 2 ps, better shorter than 1 ps. Particularly preferably, this energization of the third light source 464 of the third single-photon source 438 by the third power source 463 of the third single-photon source 438 is shorter than 10 ps. The fourth single-photon source 439 typically comprises a polarized fourth light source 464 and a fourth power source 463. For a better overview, these device components are hidden in FIGS. 4 and 5. They correspond to the representation for the fifth single-photon sources 440. The fourth power source 463 energizes the fourth light source 464 of the fourth single-photon source 439 so briefly and with such low energy that the fourth light source 464 of the fourth single-photon source 439 emits essentially only individual photons that are spatially and temporally separated from one another. Preferably, this energization of the fourth light source 464 of the fourth single-photon source 439 by the fourth power source 463 of the fourth single-photon source 439 is shorter than 1 ns, better shorter than 500 ps, better shorter than 200 ps, better shorter than 100 ps, better shorter than 50 ps, better shorter than 20 ps, better shorter than 10 ps, better shorter than 5 ps, better shorter than 2 ps, better shorter than 1 ps. Particularly preferably, this energization of the fourth light source 464 of the fourth single-photon source 439 by the fourth power source 463 of the fourth single-photon source 439 is shorter than 10 ps.

The exemplary fifth single-photon source 440 additionally shown in the example of the drawing typically comprises a polarized fifth light source 464 and a fifth power source 463. The fifth power source 463 energizes the fifth light source 464 of the fifth single-photon source 440 so briefly and with such low energy that the fifth light source 464 of the fifth single-photon source 440 emits essentially only individual photons that are spatially and temporally separated from one another. Preferably, this energization of the fifth light source 464 of the fifth single-photon source 440 by the fifth power source 463 of the fifth single-photon source 440 is shorter than 1 ns, better shorter than 500 ps, better shorter than 200 ps, better shorter than 100 ps, better shorter than 50 ps, better shorter than 20 ps, better shorter than 10 ps, better shorter than 5 ps, better shorter than 2 ps, better shorter than 1 ps. Particularly preferably, this energization of the fifth light source 464 of the fifth single-photon source 440 by the fifth power source 463 of the fifth single-photon source 440 is shorter than 10 ps.

In the case of n single-photon sources as part of the single-photon transmission device 401 (not shown in the drawings), the n-th single-photon source typically comprises a polarized n-th light source 464 and an n-th power source 463. The n-th power source 463 preferably energizes the n-th light source 464 of the n-th single-photon source so briefly and with such low energy that the n-th light source 464 of the n-th single-photon source emits essentially only individual single photons that are spatially and temporally separated from one another. Preferably, this energization of the n-th light source 464 of the n-th single-photon source by the n-th power source 463 of the n-th single-photon source is shorter than 1 ns, better shorter than 500 ps, better shorter than 200 ps, better shorter than 100 ps, better shorter than 50 ps, better shorter than 20 ps, better shorter than 10 ps, better shorter than 5 ps, better shorter than 2 ps, better shorter than 1 ps. Particularly preferably, this energization of the n-th light source 464 of the n-th single-photon source by the n-th power source 463 of the n-th single-photon source is shorter than 10 ps.

In the example in FIGS. 4 and 5, an optical subdevice of the single-photon transmission device 401 combines the respective single-photon streams of the single-photon sources 336 to 440 to form a QKD coupling beam 452 of polarization-modulated single photons. In the example in FIGS. 4 and 5, this optical subdevice is a conical mirror 1408. In the example in FIGS. 4 and 5, the single-photon sources 436 to 440 emit polarized single photons with a respective polarization direction specific to the single-photon sources. The single-photon sources 436 to 440 emit the single photons with a direction vector of a respective beam axis, which lie substantially in a common beam plane. This common beam plane is preferably arranged substantially perpendicular to the system axis of the single-photon transmission device 401. Preferably, the polarization directions of the single-photon sources lie in the common beam plane.

The beam axes of the n single-photon sources lie in the plane of radiation and preferably intersect at a point in the common plane of radiation. Typically, the beam axis of a kth single-photon source is rotated by (k−1)/(2*n)*360° with respect to the first single-photon source 436. Typically, the system axis of the single-photon emitting device 401 is substantially equal to the optical axis of the QKD coupling beam 452. A first pinhole 444 and a second pinhole 445 form a spatial filter 1302, which prevents the imperfect positionings of the single-photon sources 436 to 440, typically due to manufacturing variations, from being detected externally and used for an attack. The conical axis of the conical mirror 1408 preferably pierces the common beam plane substantially at the intersection of the beam axes of the single-photon sources in the common beam plane. As a result, the conical mirror 1408 reflects the single photons from the different beam axes of the different single-photon sources toward a common system axis that substantially corresponds to the optical axis of the QKD coupling beam 452. An optional first lens 446 and an optional second lens 447 improve the optical alignment of the QKD coupling beam 452. The first lens 446 and the second lens 447 together form a telescope that first focuses the beam of single photons to the beam of the QKD coupling beam 452.

One problem is different single-photon densities of the single-photon sources 436 to 440 of the single-photon transmission device 401. To solve this problem, the single-photon transmission device 401 preferably comprises a first beam splitter 448 in the transmission path of the single-photon transmission device 401 and a photodetector 451. The first beam splitter 448 of the transmission path is used to divert some photons to measure the photon rate. Preferably, an actuator controlled by the microcontroller core 416 by means of an actuator controller via the internal databus 402 removes the beam splitter or mirror 448 from the beam path of the transmitter when the calibration of the photon rates of the single-photon sources 436 to 440 is complete. The microcontroller core 416 utilizes the photodetector 451 to determine the photon density in the beam path 449 of the single-photon transmission device 401. A potential problem is that the transmitted polarization of the single photons may not be linked to the temporal density of the single photons, i.e. the number of single photons per second. Therefore, the microcontroller core 416 inserts the mirror 448 into the beam path 446 of the single-photon transmission device 401 by means of, e.g., an actuator that it controls via the internal databus 402. The microcontroller core 416 then uses the photodetector 451 to detect the single-photon density in the beam path 449 of the single-photon transmission device 401. The microcontroller core 416 always operates a single-photon source of the single-photon sources 436 to 440 of the single-photon transmission device 401 and detects a single-photon density associated with this single-photon source. A receive signal 453 of the photodetector 451 connects the photodetector 451 to an evaluation circuit 454 of the photodetector 451. The evaluation circuit 454 is preferably coupled to the microcontroller core 416 via the internal databus 402. The evaluation circuit 454 of the photodetector 451 detects the values of the receive signal 453 of the photodetector 451, which depend on the single photons in the beam path of the single-photon receiving device 401 from the first beam splitter or mirror 448 to the photodetector 451, converts these preferably into digitized values, for example with the aid of an analog-to-digital converter ADC, and transmits the measured values thus acquired relating to the single photons in the beam path of the single-photon receiving device 401 from the first beam splitter or mirror 448 to the photodetector 451 to the microcontroller core 416 via the internal databus 402. The microcontroller core 416 then adjusts the power sources 463 of the respective single-photon sources 436 to 440 such that the single-photon density of a single-photon source of the single-photon sources 436 to 440 of the single-photon transmission device 401 detected by the photodetector 451 by means of the value of the receive signal 453 of the photodetector 451 is initially within a provided single-photon density range value interval and does not subsequently change by more than 10%, better 5%, better 2%, better 1%, better 0.5%, better 0.2%, better 0.1%, better 0.05%, better 0.02%, better 0.01% from the single photon densities of all other single-photon sources of the single-photon sources 436 to 440 of the single-photon transmission device 401. After the single-photon densities of the various single-photon sources of the single-photon transmission device 401 have been calibrated, the microcontroller core 416 preferably removes the mirror 446 from the beam path 449 of the single-photon transmission device 401 again, which then beams the single photons in the beam path 449 of the single-photon transmission device 401 as a QKD coupling beam 452 to a receiver, e.g. a single-photon receiving device 601.

In many applications, the single-photon transmission device 401 is a mobile unit. For example, the single-photon transmission device 401 can be a cell phone or a smartphone or a laptop or a tablet PC or a key or a vehicle key or a security key for a weapon or other military device or a key for activating and/or controlling an aircraft, a watercraft, or a projectile, or an access key to a secured area or to a safe or a safe or an activation key for a secured mechanical device or an activation key for a protected procedure that, for example, a secured device (e.g., 601), or an activation key for a protected device (e.g., 601) which is intended to perform a secured procedure, or the like.

In the case of a key, the single-photon device (401) preferably comprises a human-machine interface 465 (HMI interface with HMI=Human Machine Interface) to enable communication between the single-photon transmission device 401 on the one hand and the single-photon receiving device 601 of the QKD-coupled unit being controlled (e.g., a car 802) by a person operating the system. By way of example, the specification presented herein assumes a car key as a single-photon transmission device 401 and an exemplary car 802 as a unit being controlled using a single-photon receiving device 601. For the purposes of the specification provided herein, the human machine interface (HMI) 465 connects an input terminal 466 for interacting with a person using the system to the microcontroller core 416 via the internal databus 402 of the single-photon transmission device 401. For example, in the case of a car key, the input terminal 466 of the single-photon transmission device 401 can preferably comprise one or a plurality of buttons 467 or switches 467 or other mechanical input devices for manual input. Also, in the case of a car key, the input terminal 466 of the single-photon transmission device 401 can, e.g., preferably comprise one or a plurality of biometric sensors 468. The biometric sensors 468 can, e.g., comprise one or a plurality of fingerprint sensors, and/or one or a plurality of cameras, and/or one or a plurality of microphones, and/or one or a plurality of speech recognition devices, and/or one or a plurality of speaker recognition devices, and/or one or a plurality of face recognition devices, and/or one or a plurality of retina scanners or the like. Also, in the case of a car key, the input terminal 466 of the single-photon transmission device 401 can, e.g., preferably act one or a plurality of actuators 470 for feedback from the single-photon transmission device 401 to the person using it. In the context of the present application, an actuator 470 can, e.g., be a mechanical vibrator, a speaker, a beeper or other sound transducer, or a heater or the like. The actuator 470 typically serves to transmit a mechanical signal to the user. However, it can also serve the user's mechanical purposes. In addition to these mechanical/thermal feedbacks, the input terminal 466 of the single-photon transmission device 401 can preferably comprise (e.g., in the case of a car key), one or a plurality of optical signaling means 469, for example in the form of an optical output element for signaling to a user. The optical signaling means 469 can comprise one or a plurality of screens and/or one or a plurality of light sources and/or one or a plurality of means that change their absorption properties, such as LCD displays or e-Ink displays. Preferably, the single-photon transmission device 401 comprises one or a plurality of means 1409 for identifying a person using the single-photon transmission device 401. For example, one of the means 1409 for identifying a person using the single-photon transmission device 401 can be a SIM card (SIM=Subscriber Identification Module). The single-photon transmission device 401 can optionally be a cell phone or a smartphone. One of the wireless data interfaces of the single-photon transmission device 401 can thus be, for example, a cellular data interface into a cellular network or a Wi-Fi network or the like. It can therefore also be advantageous, among other things, if the single-photon transmission device 401 establishes an authentication data channel to the server of a service provider, for example an automobile manufacturer, via this interface.

FIG. 5 corresponds as far as possible to FIG. 4. Now, however, the single-photon transmission device 471 comprises alignment means (456, 457, 460, 455, 459, 461) for aligning the single-photon transmission device 471 with respect to the single-photon receiving device 601 (see FIG. 6). The single-photon transmission device 471 typically comprises a power supply 456 for a laser pointer laser diode 459. The laser pointer laser diode 459 typically emits a laser pointer beam 462 when powered. A user can preferably use the laser pointer beam 462 to align the single-photon transmission device 471 (e.g., a car key) with a single-photon receiving device 601. Preferably, the laser pointer beam 462 has a wavelength that is different from the wavelength of the single photons in the QKD coupling beam 452. Preferably, the single-photon detectors 436 to 440 of the single-photon receiving device 601 are not sensitive to the wavelength of the radiation of the laser pointer beam 462. Preferably, the single-photon detectors 436 to 440 of the single-photon receiving device 601 are protected by shutters, housings, and/or filters. Typically, the single-photon transmission device 471 comprises a control device 457 for the power source 460 of the laser pointer diode 459, which controls the value of the electrical current through the laser pointer diode. For example, the microcontroller core 416 of the single-photon transmission device 401 controls the control device 457 via the internal databus 402. The laser pointer diode 459 preferably emits visible light, which is typically detectable by a human user. As a result, the user is able to detect and correct misalignments. The power source 460 of the laser pointer diode 459 adjusts the operating current through the laser pointer diode 459 depending on signaling from the control device 457 for the power source 460 of the laser pointer diode 459. A projection optical means 461 of the laser pointer device improves the beam quality of the laser pointer beam 462 for aligning the car key.

FIG. 6 shows a simplified schematic of an exemplary single-photon receiving device 601 using the example of a car 802.

The core of the single-photon receiving device 601 is a microcontroller core 616. Essential parts of the single-photon receiving device 601 are preferably microintegrated on a semiconductor substrate. These parts are preferably manufactured using CMOS, BiCMOS, or bipolar technology.

The single-photon receiving device 601 preferably comprises one or a plurality of internal databuses 602, via which the microcontroller core 616 of the single-photon receiving device 601 preferably handles the internal data communication. The single-photon receiving device 601 preferably further comprises one or a plurality of read/write memories RAM 603 for storing and for providing and utilizing data and program instructions by the microcontroller core 616 of the single-photon receiving device 601. The single-photon receiving device 601 preferably further comprises one or a plurality of writable non-volatile memories 604. These non-volatile memories can, e.g., comprise EEPROM memory 604, flash memory 604, or OTP memory 604. The single-photon receiving device 601 preferably further comprises one or a plurality of non-volatile, read-only memories 605, e.g. a ROM 605. These preferably contain program code and program data for the microcontroller core 616, which typically processes this program code. Program code and program data can also be stored in the one or plurality of writable non-volatile memories 604.

The exemplary single-photon receiving device 601 preferably comprises one or a plurality of non-volatile, writable and/or non-writable manufacturer memories 606. In the case of a non-writable manufacturer memory 606, the manufacturer memory 606 can be, for example, a manufacturer ROM. Furthermore, the single-photon receiving device 601 preferably comprises one or a plurality of cryptography accelerators 607, for example a DES accelerator and/or an AES accelerator 607, to accelerate the processing of the cryptography algorithms by the microcontroller core 616 of the single-photon receiving device 601. The single-photon receiving device 601 preferably also comprises one or a plurality of manufacturer memory firewalls 608 that prevent unauthorized access to the manufacturer memory 406 and only allow access after appropriate authentication, for example by means of a password. Preferably, the manufacturer memory firewalls irrevocably block access if more than a permitted number of unsuccessful access attempts have been made to the manufacturer memory 606 of the single-photon receiving device 601. Another device for increasing efficiency can be one or a plurality of cyclic redundancy check (CRC) modules 611 of the single-photon receiving device 601. Said modules calculate a CRC check data word for a specified amount of data in the manner used by, e.g., many data communication protocols. Furthermore, the exemplary single-photon transmission device 601 typically comprises one or a plurality of clock driver modules (CLK) 612 that provide the system clocks to operate the device components of the single-photon receiving device 601. The exemplary single-photon receiving device 601 preferably comprises one or a plurality of timer modules 613 that temporal sequences within the single-photon receiving device 601. The single-photon receiving device 601 preferably comprises one or a plurality of security monitoring and security control circuits 614 that monitor the integrity of the single-photon receiving device 601 and optionally initiate countermeasures in the event of an attack. The single-photon receiving device 601 preferably comprises at least one preferably quantum random number generator (QRNG) 615. The advantage of such a generator is that the entropy of its random number is particularly suitable for encryption. Typically, the single-photon receiving device 601 comprises one or a plurality of 8/16/32/64-bit microcontroller cores 616 that execute the programs in the memory of the exemplary single-photon transmission device 601. The single-photon receiving device 601 preferably comprises one or a plurality of optional data interfaces 617, particularly one or a plurality of Universal Asynchronous Receiver Transmitters (UART) to support high-speed serial data, for data communication with other computing systems.

One or a plurality of base clock drivers 621 (CLK) are preferably part of the single-photon receiving device 601. The single-photon receiving device 601 preferably comprises one or a plurality of reset circuits 622. One or a plurality of power supply or Vcc circuits 623 comprising voltage regulators that provide the operating voltages for the microcontroller system of the single-photon receiving device 601 and other subdevices of the single-photon receiving device 601. Preferably, the one or a plurality of power supply or Vcc circuits 623 also comprise at least one power reserve, such as a battery or accumulator. In some applications, the one or a plurality of power supply or Vcc circuits 623 also comprise a charging circuit and a first charging coil, which is typically not a device component of the single-photon receiving device 601, for inductive coupling to a second charging coil, which is preferably part of a device external to the single-photon receiving device 601 and/or separate from the single-photon receiving device 601. The external charging device transfers energy by means of an inductive coupling from an energy system, for example a battery or an alternator or the like, or from an energy system of the external charging device, for example an energy storage device or a generator or a solar cell or a power grid or the like, by means of the charging circuit of the one or a plurality of power supply or Vcc circuits 623 of the single-photon receiving device 601 to the energy reserve of the one or a plurality of power supply or Vcc circuits 623 of the exemplary single-photon transmission device 401 and/or the single-photon receiving device 601. The single-photon receiving device 601 typically comprises one or a plurality of ground circuits 624 that protect the device against polarity reversal and attacks via the ground line. The single-photon receiving device 601 further typically comprises one or a plurality of input/output circuits 625 that enable the single-photon receiving device 601 to actuate or read or otherwise communicate with other devices.

FIG. 6 shows an exemplary and schematic block diagram of an exemplary system for using the single-photon receiving device 601, for example, in automotive locking systems in cars. FIG. 6 shows a diagram of an example of an exemplary single-photon receiving device 601. The exemplary single-photon receiving device 601 comprises, for example, memory elements connected to an internal databus 602 of the exemplary single-photon receiving device 601. The memory elements of the exemplary single-photon receiving device 601 can comprise, for example, one or a plurality of read/write memory RAM 603, one or a plurality of writable non-volatile memory, e.g., EEPROM memory 604, flash memory 604, or OTP memory 604. Furthermore, the exemplary single-photon receiving device 601 preferably comprises one or a plurality of non-volatile, read-only memories 605, such as a ROM. Furthermore, the exemplary single-photon receiving device 601 preferably comprises one or a plurality of non-volatile, writable and/or non-writable manufacturer memories 606. In the case of a non-writable manufacturer memory, the manufacturer memory 606 can be a manufacturer ROM. Preferably, the manufacturer ROM 606 comprises boot software for the microcontroller core 416 of the exemplary single-photon receiving device 601. For example, the exemplary single-photon receiving device 601 comprises one or a plurality of cryptography accelerators 607, such as a DES accelerator and/or an AES accelerator 607, preferably connected to the microcontroller core 616 of the exemplary single-photon receiving device 601 via the internal databus 602 of the exemplary single-photon receiving device 601. For example, one or a plurality of manufacturer memory firewalls 608 can be provided between the manufacturer memory 606 of the single-photon receiving device 601 and the internal databus 602 of the single-photon receiving device 601. For example, the exemplary single-photon receiving device 601 preferably comprises processing modules of the single-photon receiving device 601 that communicate with the microcontroller core 616 of the single-photon receiving device 601 via the internal databus 602 of the single-photon receiving device 601. The processing modules of the single-photon receiving device 601 preferably comprise at least one of the following modules: A cyclic redundancy check (CRC) module 611, a clock driver module 612, one or a plurality of timer modules 613, a security monitoring and control circuit 614, one or a plurality of preferably quantum random number generator (QRNG) 615, one or a plurality of 8/16/32/15-bit microcontroller cores 616, and one or a plurality of data interfaces 617, in particular one or a plurality of Universal Asynchronous Receiver Transmitters (UART) to support high speed serial data. Other circuit components of the exemplary single-photon receiving device 601 comprise, for example, one or a plurality of base clock drivers 620 (CLK) and/or one or a plurality of clock driver modules 612, a reset circuit 622, a power supply or Vcc circuit 623 comprising voltage regulators that provide the operating voltage, a ground circuit 624, and an input/output circuit 625.

Preferably, the exemplary single-photon receiving device 601 is configured to provide secure authentication. For example, the exemplary single-photon receiving device 601 preferably stores, for example, in addition to the authentication code, other data, e. g., one or a plurality of lifetime and usage data and/or e.g., logistical data and/or e.g., commercial data and/or website and email addresses and/or image data, a set of instructions for control units of a car 802, using which the microcontroller core 616 of the exemplary single-photon receiving device 601 communicates via a data interface of the exemplary single-photon receiving device 601. In addition, the exemplary single-photon receiving device 601 can store other application data.

Preferably, the exemplary single-photon receiving device 601 comprises, for example, a microcontroller core 616 which is configured to facilitate secure authentication of a product.

The internal databus 602 of the exemplary single-photon receiving device 601 can comprise multiple databuses 602 for multiple microcontroller cores 616 of the exemplary single-photon receiving device 601, such that these multiple microcontroller cores 616 can independently access different subdevices of the exemplary single-photon receiving device 601 simultaneously. Generally, however, the exemplary single-photon receiving device 601 comprises only one internal databus 602 and only one microcontroller core 616. Preferably, the microcontroller core 616 of the exemplary single-photon receiving device 601 is an ARM processor or the like. The latter is preferably an 8-bit, 16-bit, 32-bit, or 64-bit microcontroller core 616.

Preferably, the exemplary single-photon receiving device 601 comprises one or a plurality of read/write memories RAM 603. These can be SRAMs, and/or MRAMs, and/or FRAMS or similar. Also, the one or a plurality of read/write memories RAM 603 of the exemplary single-photon receiving device 601 can be, in whole or in part, dynamic read/write memories such as DRAMs, which the microcontroller core 616 or a refresh device of the exemplary single-photon receiving device 601 reads and rewrites at regular time intervals in a refresh cycle. In order for the microcontroller core 616 to access a memory of the exemplary single-photon receiving device 601, the exemplary single-photon receiving device 601 can have access logic that periodically performs this refresh and controls this access. However, a DRAM typically opens up opportunities for an attack and is typically a potential vulnerability. Preferably, this read/write memory RAM 603 of the exemplary single-photon receiving device 601 can be accessed by the microcontroller core 616 of the exemplary single-photon receiving device 601 by means of the internal databus 602 of the exemplary single-photon receiving device 601.

Preferably, the exemplary single-photon receiving device 601 comprises one or a plurality of writable and non-volatile memories 604. Preferably, these writable and non-volatile memories 604 of the exemplary single-photon receiving device 601 can be accessed by the microcontroller core 616 of the exemplary single-photon receiving device 601 by means of the internal databus 602 of the exemplary single-photon receiving device 601. These non-volatile memories 604 of the exemplary single-photon receiving device 601 can, e.g., comprise EEPROM memory 604, flash memory 604, or OTP memory 604. OTP is the abbreviation for “One Time Programmable”, which means programmable only once.

One attack option may be to erase the non-volatile memories 604 by means of radiation, for example X-rays and/or ionizing radiation and/or heating of storage cells. To this end, the exemplary single-photon receiving device 601 preferably comprises one or a plurality of security monitoring and security control circuits 614 of the exemplary single-photon receiving device 601 that monitor the data integrity of the memory cells of the erasable memories 604 of the exemplary single-photon receiving device 601. Preferably, the memory cells of the erasable memories 604 of the exemplary single-photon receiving device 601 have a redundancy such that at least two check bits are provided for a data word, which is preferably a data word of 8 bits in length, i.e. a byte, and that always at least one first check bit must have the content 1 and another far check bit assigned to this first check bit must have the content 0. For example, the first check bit can be a parity bit of the byte and the second check bit can be the inverse bit of the parity bit to the first check bit. If an attack with ionizing radiation or similar occurs, the attack resets both check bits to the same value. This is an illegal state which the exemplary single-photon receiving device 601 can detect. The one or a plurality of security monitoring and security control circuits 614 of the exemplary single-photon receiving device 601 detect such a deviation and optionally block the exemplary single-photon receiving device 601 for further accesses at least for a preferably predetermined period of time.

Preferably, each bit of the memories of the exemplary single-photon receiving device 601 is dual, so that preferably each logical data bit is realized as a pair of a first physical data bit having a first internal logical value and a second physical data bit having a second internal logical value. Typically, the second internal logical value is the logical inverse of the first internal logical value. That this is always the case is again preferably monitored by the one or a plurality of security monitoring and security control circuits 614 of the exemplary single-photon receiving device 601. The one or a plurality of security monitoring and security control circuits 614 of the exemplary single-photon receiving device 601 again detect deviations and (by way of example and optionally) preferably block further execution of programs or certain program components and/or access to data, e.g. for the microcontroller core 616 in the event of deviations. Preferably, the exemplary single-photon receiving device 601 comprises one or a plurality of reset circuits 622 of the exemplary single-photon receiving device 601. The reset circuits 622 of the exemplary single-photon receiving device 601 each set the exemplary single-photon receiving device 601 and/or subdevices of the exemplary single-photon receiving device 601 to predefined states when predetermined or determinable reset conditions and/or combinations and/or temporal sequences of such reset conditions are present. For example, such conditions may comprise signaling from the one or a plurality of security monitoring and security control circuits 614 of the exemplary single-photon transmission device 601 to one or a plurality of reset circuits 622 of the exemplary single-photon receiving device 601. Also, these conditions may be changes and/or values of electrical node potentials relative to the potential of a reference node or reference potential line, such as one or a plurality of operating voltages of the exemplary single-photon receiving device 601. A watchdog timer can be part of a reset circuit 622 of the exemplary single-photon receiving device 601. Furthermore, such conditions may relate to the integrity of the housing of the exemplary single-photon receiving device 601. Preferably, the housing of the exemplary single-photon receiving device 601 comprises a detector for opening or damaging the housing of the exemplary single-photon receiving device 601. For example, this can be a single conduit, such as a textile network, surrounding or covering the exemplary single-photon receiving device 601 or covering at least portions of the exemplary single-photon receiving device 601. It can also be a network of lines covering the exemplary single-photon receiving device 601 for the sole purpose of detecting an attack. For example, the exemplary single-photon receiving device 601 can inject an electrical current into one or a plurality of such lines by means of a first input/output line, respectively, and withdraw it again at one or a plurality of second input/output lines. If the stream flow is interrupted, this is an indication of an attack that one or a plurality of the one or a plurality of security monitoring and security control circuits 614 of the exemplary single-photon receiving device 601 can detect and which then signal this attack to, for example, the microcontroller core 616 of the exemplary single-photon receiving device 601. For example, in such a case of suspected violation of the integrity of the housing of the exemplary single-photon transmission device 601, one or a plurality of the one or a plurality of security monitoring and security control circuits 614 of the exemplary single-photon receiving device 601 can prevent read and/or write access to memory contents of the memory of the exemplary single-photon receiving device 601. of the memories of the exemplary single-photon receiving device 601 and/or erase such contents of the memories of the exemplary single-photon receiving device 601 in whole or in part or set such contents of the memories of the exemplary single-photon receiving device 601 to predefined values or overwrite them with nonsensical data or otherwise manipulate them. The memories of the exemplary single-photon receiving device 601 preferably comprise one or a plurality of non-volatile, read-only memories 605, such as a ROM. Preferably, the ROM of the exemplary single-photon transmission device 601 contains data and/or program instructions defined by the design. Preferably, the exemplary single-photon receiving device 601 comprises one or a plurality of non-volatile, writable, and/or non-writable manufacturer memories 606 in which the semiconductor manufacturer or another supplier can store its production and security data, such as serial numbers, etc. Preferably, the semiconductor manufacturer locks access to this writable and/or non-writable non-volatile manufacturer memory 606 of the exemplary single-photon receiving device 601 after execution of the last production test. Preferably, the writable and/or non-writable manufacturer memory 406 of the exemplary single-photon receiving device 601 can be accessed by means of one or a plurality of manufacturer passwords. In some cases, a double key method is advantageous. In this case, a customer following the semiconductor manufacturer stores a customer password in a customer lock register of the exemplary single-photon receiving device 601, which can also be locked for access by means of a password. Preferably, the semiconductor manufacturer can only access all memory areas of the exemplary single-photon receiving device 601 using the customer password and the semiconductor password. Preferably, the semiconductor manufacturer provides an analysis password by means of which it can cause one or a plurality of the one or a plurality of security monitoring and security control circuits 614 of the exemplary single-photon receiving device 601 to erase, typically with the aid of the reset circuit 622 of the exemplary single-photon receiving device 601, the customer contents in the memories of the exemplary single-photon receiving device 601 and then make all memory areas of the exemplary single-photon receiving device 601 accessible for analyzing errors. In the case of a non-writable manufacturer memory of the exemplary single-photon receiving device 601, the manufacturer memory 606 of the exemplary single-photon receiving device 601 can, e.g., be a manufacturer ROM whose contents are determined, for example, during manufacturing of the semiconductor circuit of the exemplary single-photon receiving device 601. The exemplary single-photon receiving device 601 is typically intended to receive data and/or program code portions and/or instructions in encrypted form and/or to send such data and/or program code portions and/or instructions by means of cryptographic procedures stored in the memories of the exemplary single-photon receiving device 601 and executed by one or a plurality of the microcontroller cores 616 of the exemplary single-photon receiving device 601. Preferably, the encryption is QKD encryption in each case. These methods sometimes require considerable computing power. It has therefore proven advantageous that not only the microcontroller core 616 of the exemplary single-photon receiving device 601 executes certain program components of these cryptography methods in the form of sub-steps of these cryptography methods, but that one or a plurality of special hardware accelerators of the exemplary single-photon receiving device 601 preferably in the form of one or a plurality of cryptography accelerators 607 of the exemplary single-photon receiving device 601 execute these program components. For this purpose, the exemplary single-photon receiving device 601 preferably comprises, for example, a DES accelerator 607 for the DES algorithm and/or an AES accelerator 607 for executing the AES algorithm. The microcontroller core 616 of the exemplary single-photon receiving device 601 typically addresses these hardware accelerators of the exemplary single-photon receiving device 601 via the internal databus 602 of the exemplary single-photon receiving device 601. Preferably, the microcontroller core 616 of the exemplary single-photon receiving device 601 comprises a redundant clock system of the exemplary single-photon receiving device 601 to detect accesses to the clock system of the exemplary single-photon receiving device 601. One or a plurality of the one or a plurality of security monitoring and security control circuits 614 of the exemplary single-photon receiving device 601 monitor the consistency of the logical contents of this preferred plurality of redundant clock systems of the exemplary single-photon receiving device 601, and thus can detect attacks and errors. Preferably, access by the microcontroller core 616 of the exemplary single-photon receiving device 601 and the test logic of the exemplary single-photon receiving device 601 to the manufacturer memories of the exemplary single-photon receiving device 601 is prevented by one or a plurality of manufacturer memory firewalls 608 of the exemplary single-photon receiving device 601. Preferably, these manufacturer firewalls 608 of the exemplary single-photon receiving device 601 can be unlocked by a manufacturer password, as described. Preferably, the number of incorrect entries is very limited to minimize the likelihood of a successful attack. Preferably, the exemplary single-photon receiving device 601 comprises one or a plurality of cyclic redundancy check (CRC) modules 611 of the exemplary single-photon receiving device 601 so that the exemplary single-photon receiving device 601 for a serial data communication can efficiently generate the CRC data used in most data protocols to detect erroneous data transmissions, on the one hand, in case of a transmission and, on the other hand, can quickly check the correct reception of the data message in case of a reception. Preferably, the exemplary single-photon receiving device 601 comprises one or a plurality of clock driver modules (CLK) 612 of the exemplary single-photon receiving device 601 to generate one or a plurality of clock signals of the exemplary single-photon receiving device 601 to operate the circuits of the exemplary single-photon receiving device 601. Preferably, the one or a plurality of clock driver modules (CLK) 612 of the exemplary single-photon receiving device 601 generate redundant clock signals that indicate an attack on the clock system of the exemplary single-photon receiving device 601. Typically, the exemplary single-photon receiving device 601 comprises one or a plurality of timer modules 613 of the exemplary single-photon receiving device 601 as required by the microcontroller core 616 for detecting time-outs, for example. Preferably, the exemplary single-photon receiving device 601 comprises one or a plurality of watchdog timers of the exemplary single-photon receiving device 601 that monitor the processing of the various program components by the one or a plurality of microcontroller cores 616 of the exemplary single-photon receiving device 601. These watchdog—of the exemplary single-photon receiving device 601 can be part of the one or a plurality of the one or a plurality of security monitoring and security control circuits 614 of the exemplary single-photon receiving device 601. Suggestively, the exemplary single-photon receiving device 601 comprises at least one preferably quantum random number generator (QRNG) 615. Quantum random number generators have the advantage that they are based on true random numbers. In the 1970s, the physicist Bell proved that the theory of “hidden parameters” was wrong. In other words, there are no hidden causes for the randomness of quantum mechanical events, e.g. the emission of photons. The microcontroller core 616 of the exemplary single-photon receiving device 601 already mentioned several times can, e.g., be an 8-bit microcontroller core or a 16-bit microcontroller core or a 32-bit microcontroller core or a 64-bit microcontroller core or a 128-bit microcontroller core or the like. The exemplary single-photon receiving device 601 can comprise one or a plurality of 8/16/32/15-bit microcontroller cores 616, which can preferably access the other of the exemplary single-photon receiving device 601 via one or a plurality of internal databuses 602 of the exemplary single-photon receiving device 601. Preferably, the exemplary single-photon receiving device 601 comprises one or a plurality of data interfaces 617 of the exemplary single-photon receiving device 601. Such data interfaces 617 can, e.g., be one or a plurality of Universal Asynchronous Receiver Transmitters (UART) for supporting high-speed serial data. Preferably, the exemplary single-photon receiving device 601 comprises one or a plurality of base clock drivers 621 (CLK) of the exemplary single-photon receiving device 601, each of which preferably provides a base clock to one or a plurality of clock driver modules (CLK) 612 of the exemplary single-photon receiving device 601. Preferably, the base clock drivers 621 (CLK) of the exemplary single-photon receiving device 601 are oscillators. Preferably, the exemplary single-photon receiving device 601 also comprises one or a plurality of power supply or Vcc circuits 623 of the exemplary single-photon receiving device 601 comprising voltage regulators which provide the operating voltages for the exemplary single-photon transmission device 401. Preferably, the exemplary single-photon transmission device 401 also comprises one or a plurality of ground circuits 424 of the exemplary single-photon receiving device 601 comprising, for example, polarity reversal protection and protection circuits against tampering with the electrical potential of the semiconductor substrate of the semiconductor crystal of the microintegrated parts of the exemplary single-photon receiving device 601. For example, it is advantageous for one or a plurality of the one or a plurality of ground circuits 624 of the exemplary single-photon receiving device 601 to comprise polarity reversal protection. For example, it is advantageous if one or a plurality of the one or a plurality of ground circuits 624 of the exemplary single-photon receiving device 601 and/or one or a plurality of the one or a plurality of power supply or Vcc circuits 623 of the exemplary single-photon receiving device 601 interact in such a manner, such that the modulation of the power consumption and/or the internal resistance and/or the voltage drop between the supply voltage terminals of the exemplary single-photon receiving device 601 is not indicative of the operations and/or states of the exemplary single-photon receiving device 601, at least temporarily.

For controlling other devices and/or for communicating with other devices and/or for monitoring other devices, it is generally advantageous if the exemplary single-photon receiving device 601 comprises one or a plurality of input/output circuits 625 of the exemplary single-photon receiving device 601, which are generally implemented as digital inputs and/or as digital outputs of the exemplary single-photon receiving device 601, which can preferably also assume a tri-state condition. The exemplary single-photon receiving device 601 can comprise an analog-to-digital converter of the exemplary single-photon receiving device 601 that enables the microcontroller core 616 of the exemplary single-photon receiving device 601 to monitor internal analog values, such as the operating voltage and external analog values. The analog-to-digital converter can be provided with an analog multiplexer to monitor a plurality of internal electrical nodes of the exemplary single-photon receiving device 601 for correctness of the values of the electrical potential with respect to a reference potential of the exemplary single-photon receiving device 601. Preferably, the microcontroller core 616 of the exemplary single-photon receiving device 601 controls this analog multiplexer. The exemplary single-photon receiving device 601 can optionally be provided with one or a plurality of driver stages 692 of the exemplary single-photon receiving device 601 in order to, e.g., drive actuators 694. Such actuators 694 can, e.g., be motors and/or other resistive and/or inductive and/or capacitive loads and the like. Such a driver stage 692 of the exemplary single-photon receiving device 601 can, e.g., be a half-bridge and/or an H-bridge or the like. It is also conceivable that they be power sources of the exemplary single-photon receiving device 601, for example for light sources such as LEDs.

Therefore, the present application proposes an exemplary single-photon receiving device 601, in particular for the safe control of devices in automobiles, comprising a semiconductor crystal. Preferably, the exemplary single-photon receiving device 601 is fabricated in whole or in part using a CMOS circuit technology or a bipolar circuit technology or a BiCMOS circuit technology. The exemplary single-photon receiving device 601 preferably comprises memory elements, one or a plurality of internal databuses 602 of the exemplary single-photon receiving device 601, one or a plurality of 8/16/32/15-bit microcontroller cores 616 of the exemplary single-photon receiving device 601, one or a plurality of data interfaces of the exemplary single-photon receiving device 601, and one or a plurality of preferably quantum process-based random generators 615 of the exemplary single-photon receiving device 601 for generating true or high quality random numbers (referred to as a quantum random number generator, or QRNG). The internal databus 602 of the exemplary single-photon receiving device 601 can comprise a plurality of databuses. The memory elements of the exemplary single-photon receiving device 601 are typically connected to the internal databus 602 of the exemplary single-photon receiving device 601. The data interfaces of the exemplary single-photon receiving device 601 are typically connected to the internal databus 602 of the exemplary single-photon receiving device 601. The one or a plurality of random number generators (QRNG) 615 of the exemplary single-photon receiving device 601 are also preferably connected to the internal databus 602 of the exemplary single-photon receiving device 601. The one or a plurality of microcontroller cores 616 of the exemplary single-photon receiving device 601 are also preferably connected to the internal databus 602 of the exemplary single-photon receiving device 601. Preferably and typically, the one or a plurality of random number generators (QRNG) 615 generate one or a plurality of random numbers in response to a request from the microcontroller core 616 of the exemplary single-photon receiving device 601. Preferably, one or a plurality of the one or a plurality of microcontroller cores 616 of the exemplary single-photon receiving device 601 generate one or a plurality of keys using a respective program from one or a plurality of its memory elements of the exemplary single-photon receiving device 601 and using one or a plurality of the generated random numbers. Typically, one or a plurality of microcontroller cores 616 of the exemplary single-photon receiving device 601 encrypt and/or decrypt using a respective program of the related microcontroller core 616 of the exemplary single-photon receiving device 601, each of which programs originates from one or a plurality of the memory elements of the exemplary single-photon receiving device 601 and, using a respective key for the generated keys, these microcontroller cores 616 of the exemplary single-photon receiving device 601 typically exchange data via one or a plurality of data interfaces of the exemplary single-photon receiving device 601 with devices outside the exemplary single-photon receiving device 601 via one or a plurality of data interfaces of the exemplary single-photon receiving device 601.

In a further embodiment of the exemplary single-photon receiving device 601, the memory elements of the exemplary single-photon receiving device 601 comprise one or a plurality of read/write memories RAM 603 and/or one or a plurality of writable non-volatile memories, in particular EEPROM memories 604 and/or flash memories 604 and/or OTP memories 604, and/or one or a plurality of read-only memories and/or one or a plurality of non-volatile manufacturer memories. The one semiconductor memory or multiple manufacturer memories of the exemplary single-photon receiving device 601 can, e.g., comprise one or a plurality of manufacturer ROMs 606, and/or one or a plurality of manufacturer EEPROMs, and/or one or a plurality of manufacturer flash memories.

In a second further embodiment, the manufacturer memory of the exemplary single-photon receiving device 601, and more particularly a manufacturer ROM 606 of the exemplary single-photon receiving device 601, comprises boot software for booting the microcontroller core 616 of the exemplary single-photon receiving device 601 to securely boot the exemplary single-photon receiving device 601.

In a third further embodiment, the exemplary single-photon receiving device 601 comprises a manufacturer memory firewall 608 of the exemplary single-photon receiving device 601 between the manufacturer memory 606 of the exemplary single-photon receiving device 601 and the internal databus 602 of the exemplary single-photon receiving device 601 that prevents access to the manufacturer memory firewall 706 of the exemplary single-photon receiving device 601 without authentication.

In a fourth further embodiment, the exemplary one of the exemplary single-photon receiving device 601 comprises one or a plurality of the following components: A base clock driver 621 (CLK), a clock driver circuit 612, a reset circuit 622, a power supply circuit or a Vcc circuit 623 comprising voltage regulators which provide the operating voltages for at least the exemplary single-photon receiving device 601, a ground circuit 624, an input/output circuit 625, one or a plurality of processing modules. In this regard, the processing modules of the exemplary single-photon receiving device 601 communicate with the internal databus 602 of the exemplary single-photon receiving device 601 and thus typically with a microcontroller core 616 of the exemplary single-photon receiving device 601. Preferably, the processing modules of the exemplary single-photon receiving device 601 comprise one or a plurality of the following modules: A cyclic redundancy check (CRC) module 611, a clock driver module 612, a crypto accelerator 607, in particular a DES accelerator and/or an AES accelerator 607, one or a plurality of timer modules 613, one or a plurality of security monitoring and security control circuits 614, and, one or a plurality of data interfaces, in particular a Universal Asynchronous Receiver Transmitter (UART) 617.

In a further embodiment of the exemplary single-photon receiving device 601, at least one data interface of the one or a plurality of data interfaces of the exemplary single-photon receiving device 601 is a wired automotive databus interface. In this case, the wired automotive databus interface can, e.g., be a CAN databus interface or a CAN FD databus interface or a Flexray databus interface or a PSI5 databus interface or a DSI3 databus interface or a LIN databus interface or an Ethernet databus interface or a LIN databus interface or a MELIBUS databus interface.

In a further embodiment of the exemplary single-photon receiving device 601, at least one data interface of the one or a plurality of data interfaces of the exemplary single-photon receiving device 601 is a wireless databus interface. The wireless databus interface can, e.g., be a Wi-Fi interface or a Bluetooth interface.

In a further embodiment of the exemplary single-photon receiving device 601, at least one data interface of the one or a plurality of data interfaces of the exemplary single-photon receiving device 601 is a wired databus interface. The wireless databus interface of the exemplary single-photon receiving device 601 can, e.g., be a KNX databus interface or an EIB databus interface or a DALI databus interface or a PROFIBUS databus interface.

The exemplary single-photon receiving device 601 preferably comprises one or a plurality of wireless and/or wired data interfaces 626. The data transmission channel 428 to a single-photon transmission device 401 can be wired or wireless. In the case of a car, the data transmission channel 428 is preferably wireless. The data transmission channel 428 is then typically an electromagnetic data signal that the single-photon receiving device 601 exchanges in a wireless manner with the single-photon transmission device 401. In the case of a car comprising a single-photon transmission device 401, the car exchanges data with the single-photon transmission device 401 preferably by means of a wireless data interface 626 and its antenna 627. In the case of a wired data transmission channel, the data transmission channel is then typically an electromagnetic data signal that the single-photon receiving device 601 exchanges with the single-photon transmission device 401 by wire. In this case of a wireless data interface, the exemplary single-photon receiving device 601 typically comprises one or a plurality of respective antennas 627 of the respective wireless interface 626.

The exemplary single-photon receiving device 601 preferably comprises an evaluation circuit 672 for the receive signals 673 to 676 of the single-photon detectors 677 to 680 for differently polarized single photons. The evaluation circuit 672 receives measured values in the form of signalizations of the single-photon detectors 677 to 680 for differently polarized single photons via said receive signals 673 to 676. The evaluation circuit 672 processes these measured values and makes the result of this processing available to the microcontroller core 616 via the internal databus 602.

The exemplary single-photon receiving device 601 preferably comprises a single-photon detector system 1603 for receiving a polarization-modulated single-photon signal. The single-photon detector system 1603 preferably comprises n receiving channels for single photons. The receiving channels each detect the single photons with a rotation of the polarization planes of (k−1)/(2*n)*360° with respect to a base direction. The receive channels can be numbered consecutively, starting with 1. In this case, k is the number of the receive channel, n is the number of receive channels, and k is a number where 1≤k≤n. The single-photon detector system provides the microcontroller core 616 with data on the received single photons, whereby this data preferably comprises the polarization direction and the time period or time of reception. The exemplary single-photon detector system 1603 preferably comprises a first single-photon detector 677 for horizontally polarized single photons and a second single-photon detector 678 for vertically polarized single photons and a third single-photon detector 679 for +45° polarized single photons and a fourth single-photon detector 680 for −45° polarized single photons. The proposed single-photon detector system 1603 is preferably a single-photon detector system 1603 for polarization-modulated single photons.

The exemplary single-photon receiving device 601 preferably comprises a first single-photon detector 677 for horizontally polarized single photons, for example a first SPAD diode. The present application assumes that, in the case of a SPAD diode, the first single-photon detector 677 comprises the drive circuit and evaluation circuit for operating the SPAD diode. Preferably, the semiconductor substrate of the microcontroller core 616 also comprises the first SPAD diode with the necessary operating circuits and the connector for a supply voltage, and thus the first single-photon detector 677. The first single-photon detector 677 for horizontally polarized single photons is integrated into the single-photon receiving device 601 such that the first single-photon detector 677 for horizontally polarized single photons detects substantially only horizontally polarized single photons of the QKD coupling beam 452 emitted from a single-photon transmission device 401. The structure of the first single-photon detector 677 can, e.g., already ensure that the first single-photon detector 677 for horizontally polarized single photons detects substantially only horizontally polarized single photons of the OKD coupling beam 452. Such a structure can, e.g., provide a first micro-optical grating as a polarization device that only transmits single photons of a horizontal polarization direction. However, such a structure can, e.g., also comprise a second polarizing beam splitter 684 as a microintegrated micro-optical functional element and a second single-photon detector 678. The first single-photon detector 677 converts the received single photons of the third horizontally polarized single-photon stream 685 into a first receive signal 673 of the first single-photon detector 677 for horizontally polarized single photons 673. The first single-photon detector 677 converts the received single photons of the third horizontally polarized single-photon stream into a first receive signal 673 of the first single-photon detector 677 for horizontally polarized single photons.

A first receive signal 673 from the first single-photon detector 677 for horizontally polarized single photons 677 signals the evaluation circuit 672 to receive single photons.

The exemplary single-photon receiving device 601 preferably comprises a second single-photon detector 678 for vertically polarized single photons, for example a second SPAD diode. The present application assumes that, in the case of a SPAD diode, the second single-photon detector 678 comprises the drive circuit and evaluation circuit for operating the SPAD diode. Preferably, the semiconductor substrate of the microcontroller core 616 also comprises the second SPAD diode with the necessary operating circuitry and connector for a supply voltage and thus the second single-photon detector 678. Preferably, the second single-photon detector for vertically polarized single photons 678 is integrated into the single-photon receiving device 601 such that the second single-photon detector 678 for vertically polarized single photons detects substantially only vertically polarized single photons of the QKD coupling beam 452. The structure of the second single-photon detector 678 can, e.g., already ensure that the second single-photon detector 678 for vertically polarized single photons detects substantially only vertically polarized single photons of the QKD coupling beam 452. Such a structure can, e.g., provide a second micro-optical grating as a polarization device that only transmits single photons of a vertical polarization direction. However, such a structure can, e.g., also comprise the second polarizing beam splitter 684 as a microintegrated micro-optical functional element and the first single-photon detector 677. The second single-photon detector 678 converts the received single photons of the fourth horizontally polarized single-photon stream 686 into a second receive signal 674 of the second single-photon detector 678 for vertically polarized single photons. The second single-photon detector 678 preferably thus converts substantially only the received vertically polarized single photons into the second receive signal 674 of the second single-photon detector 678 for vertically polarized single photons. A second receive signal 674 of the second single-photon detector 678 for vertically polarized single photons 678 signals the evaluation circuit 672 to receive single photons.

The exemplary single-photon receiving device 601 preferably comprises a third single-photon detector 679 for +45° polarized single photons, for example a third SPAD diode. The present application assumes that, in the case of a SPAD diode, the third single-photon detector 678 comprises the drive circuit and evaluation circuit for operating the SPAD diode. Preferably, the semiconductor substrate of the of the microcontroller core 616 also comprises the third SPAD diode and thus the third single-photon detector 679. The third single-photon detector for +45° polarized single photons 679 is preferably integrated into the single-photon receiving device 601 such that the third single-photon detector for +45° polarized single photons 679 detects substantially only +45° polarized single photons of the QKD coupling beam 452. The structure of the third single-photon detector 679 can, e.g., already ensure that the third single-photon detector 679 detects substantially only +45° polarized single photons of the QKD coupling beam 452. Such a structure can, e.g., provide a third +45° oriented micro-optical grating as a polarization device on the surface of a third SPAD diode, i.e. at its light entry port, which only transmits single photons of a +45° oriented polarization direction. However, such a structure can, e.g., also comprise the third polarizing beam splitter 690 as a microintegrated microoptical functional element and the fourth single-photon detector 680. The third single-photon detector 679 converts the received single photons of the fifth +45° polarized single-photon stream 1605 into a third receive signal 675 of the third single-photon detector 679 for +45° polarized single photons 675. The third single-photon detector 679 preferably thus converts substantially only the received +45° polarized single photons into the third receive signal 675 of the third single-photon detector 679 for +45° polarized single photons. A third receive signal 675 from the third single-photon detector 679 for +45° polarized single photons 679 signals the evaluation circuit 672 to receive single photons.

The exemplary single-photon receiving device 601 preferably comprises a fourth single-photon detector 680 for −45° polarized single photons, e.g. a fourth SPAD diode. The present application assumes that, in the case of a SPAD diode, the fourth single-photon detector 679 comprises the drive circuit and evaluation circuit for operating the SPAD diode. Preferably, the semiconductor substrate of the of the microcontroller core 616 also comprises the fourth SPAD diode and thus the fourth single-photon detector 680. Preferably, the fourth single-photon detector for −45° polarized single photons 680 is integrated into the single-photon receiving device 601 such that the fourth single-photon detector for −45° polarized single photons 680 detects substantially only −45° polarized single photons of the QKD coupling beam 452. The structure of the fourth single-photon detector 680 can, e.g., already ensure that the third single-photon detector 680 detects substantially only −45° polarized single photons of the QKD coupling beam 452. Such a structure can, e.g., provide a third −45° oriented micro-optical grating as a polarization device on the surface of a fourth SPAD diode, i.e. at its light entry port, which only transmits single photons of a −45° oriented polarization direction. However, such a structure can, e.g., also comprise the third polarizing beam splitter 690 as a microintegrated microoptical functional element and the third single-photon detector 679. The fourth single-photon detector 680 converts the received single photons of the sixth +45° polarized single-photon stream 691 into a fourth receive signal 680 of the fourth single-photon detector 680 for −45° polarized single photons 676. The fourth single-photon detector 680 preferably thus converts substantially only the received −45° polarized single photons into the fourth receive signal 676 of the fourth single-photon detector 680 for −45° polarized single photons. A fourth receive signal 676 of the fourth single-photon detector 680 for −45° polarized single photons 680 signals the evaluation circuit 672 to receive single photons.

The exemplary single-photon receiving device 601 preferably comprises a supply voltage line 643. The supply voltage line 643 connects the respective consumers within the exemplary single-photon receiving device 601 to one or a plurality of power supply or Vcc circuits 663 comprising voltage regulators which provide the operating voltages for the microcontroller system of the single-photon receiving device 601 and the QKD transmitter of the single-photon receiving device 601. The supply voltage line 643 can also comprise a plurality of lines each connecting, for example, a consumer of electrical power, i.e. a subdevice of the proposed single-photon receiving device 601, to a respective voltage regulator or power source of the one or a plurality of power supply or Vcc circuits 623.

The exemplary single-photon receiving device 601 preferably comprises an optional receiving optical means 681 for the QKD coupling beam 452. The optional receiving optical means 681 focuses the incoming single photons of the single-photon beam of the QKD coupling beam 452 onto the single-photon detectors 677, 678, 679, 680 of the exemplary single-photon receiving device 601. After passing through the beam path 682 for the single photons of the QKD coupling beam 452 between optional receiving optical means for the QKD coupling beam 452 and non-polarizing beam splitter 683, the non-polarizing beam splitter 683 splits the QKD coupling beam 452. The non-polarizing beam splitter 683 splits the single-photon stream of the QKD coupling beam 452 into a first single-photon stream 1604 and a second single-photon stream 687, regardless of the polarization of the single photons of the QKD coupling beam 452. The non-polarizing beam splitter 683 in this case feeds a single photon with a probability of substantially 50% into the first single-photon stream 1604 and with a probability of substantially 50% into the second single-photon stream 686. A second polarizing beam splitter 684 splits the one first single-photon stream 1604 into a third horizontally polarized single-photon stream 685 and a fourth vertically polarized single-photon stream 686. The third polarizing single-photon stream 685 comprises substantially only horizontally polarized single photons, using which the third horizontally polarized single-photon stream irradiates the first single-photon detector 677 for horizontally polarized single photons.

The fourth polarized single-photon stream 686 comprises substantially only vertically polarized single photons, using which the fourth vertically polarized single-photon stream 686 irradiates the second single-photon detector 678 for vertically polarized single photons.

A λ/4 plate and/or a polarization rotation device 688 is preferably present in the second single-photon stream 687. The λ/4 plate and/or the polarization rotation device 688 preferably rotates the polarization direction of the single photons in the second single-photon stream 687 by 45° to a rotated second single-photon stream 689. A third polarizing beam splitter 690 splits the twisted second single-photon stream 689 into a sixth −45° polarized single-photon stream 691 and a fifth +45° polarized photon stream 1605. The sixth polarized single-photon stream 691 comprises substantially only −45° polarized single photons, using which the sixth −45° polarized single-photon stream 691 irradiates the fourth single-photon detector 680 for −45° polarized single photons. The fifth +45° polarized single-photon stream 1605 comprises essentially only +45° polarized single photons, using which the fifth +45° polarized single-photon stream 1605 irradiates the third single-photon detector for +45° polarized single photons 679. If alignment of the single-photon transmission device 401 with respect to the single-photon receiving device 601 is necessary, the single-photon receiving device 601 comprises, for example, an alignment receiver 699. The receiver 1601 of the alignment receiver 699 detects the laser pointer beam 462 for alignment of the single-photon transmission device 401, 471, for example a car key. The interface 1606 of the alignment receiver 699 receives measurement data from the receiver 1601 of the alignment receiver 699 via the alignment receiver line 698. The interface 1606 of the alignment receiver 699 signals the microcontroller core 616 via the internal databus 602 whether the receiver 1601 of the alignment receiver 699 is receiving sufficient light from the laser pointer beam 462 via the optical system 1602 of the alignment receiver 699 to align the single-photon transmission device 471, e.g. a car key, with the single-photon receiving device 601. Only when this is the case, the microcontroller core 616 preferably starts the generation of a common quantum key for the single-photon transmission device 471, for example the car key 471, and the single-photon receiving device 601 of the car 802. For this purpose, the microcontroller core 616 of the single-photon receiving device 601 signals the microcontroller core 416 of the single-photon transmission device 471, for example the car key 471, for example via a wireless data link 626, 627,428, 427, 426, that the agreement of a quantum key can start. The microcontroller core 416 of the single-photon transmission device 471, for example of the car key 471, then causes the single-photon transmission device 1407 of the single-photon transmission device 471 to generate a polarization-modulated stream of single photons as a QKD coupling beam 452, whereby the microcontroller core 416 of the single-photon transmission device 471, for example of the car key 471, preferably generates as modulation signal of the polarization direction of the emitted single photons a random number of its at least one quantum random number generator (QRNG) 415. The single-photon receiving device 601 of the other unit, e.g. a car 802, receives this polarization-modulated single-photon data stream of the QKD coupling beam 452.

For example, the single-photon receiving device 601 can control or influence an exemplary locking device 694 of a car 802 as a car key 401 or 471. In the exemplary application of a door lock for opening a door 804 or other opening of a car 802, the microcontroller core 616 exchanges an encryption key with a car key 401 or 471 in a tap-proof manner using a QKD method. After the car key 401 or 471 has established a secure wireless connection 428 between the car key and the single-photon receiving device 601 by generating a shared secret quantum key, the microcontroller core 416 of the car key 401, 471 can exchange authentication data with the microcontroller core 616 or computer unit superordinate to the microcontroller core 616. Insofar as this computer unit 697, which is superordinate to the microcontroller core 616 or the microcontroller core 616, deems the authentication data to be trustworthy following a comparison with a database, the microcontroller core 616 causes, e.g. by means of suitable signaling via the internal databus 602, the control 692 for driving the exemplary locking device 694 and the control line 693 for driving the exemplary locking device 694 to open, unlock, lock, or close the door 804 any other opening of the car 802 via the exemplary locking device 694 of the car 802.

The single-photon receiving device 601 can also comprise a controller 692 for driving the exemplary locking device 694. By means of a control line 693 for driving the exemplary locking device 694, the controller 692 exchanges control data and/or status data with the drive of the exemplary locking device 694 and makes these available to the microcontroller core 616 via the internal databus 602 in order to operate the exemplary locking device 694. By means of the control line 693 for driving the exemplary locking device 694, the controller 692 exchanges control data and/or status data with the drive of the exemplary locking device 694 in order to operate the exemplary locking device 694.

The single-photon receiving device 601 preferably comprises one or a plurality of data connections 696 from one or a plurality of data interfaces 695 of the single-photon receiving device 601 to a superordinate computer unit 697 via a databus 696 of the other unit, e.g. the car 802. This can, e.g., be a CAN databus or a CAN FD databus or a PSI5 databus or a DSI3 databus or an IC bus or an Ethernet connection or an optical data connection, for example an optical fiber, or an encrypted radio connection, such as Wi-Fi or Bluetooth, or the like. The superordinate computer unit 697 can, e.g., be any desired computer unit in the motor vehicle. This superordinate computer unit generally controls the actions of the microcontroller core 616.

The respective subdevices for transmitting and receiving the QKD coupling beam 452 of the single-photon transmission device 471 in FIG. 5 and the single-photon receiving device 601 in FIG. 6 can be interchanged and combined as desired.

FIG. 7 shows an exemplary and schematic block diagram of an exemplary integrated circuit for use as an integrated QKD circuit 701 in automotive QKD systems. The proposed circuit is preferably a one-piece CMOS BICMOS or bipolar circuit in or on a semiconductor substrate. The material of the semiconductor substrate preferably comprises silicon or SiC or a mixed crystal of elements of the III, IV and V main groups of the periodic table. FIG. 7 shows a diagram of an example of an integrated QKD circuit 701. The integrated QKD circuit 701 comprises, e.g., memory elements connected to an internal databus 702. The memory elements can, e.g., comprise one or a plurality of read/write memory RAM 703, one or a plurality of writable non-volatile memory, e.g. EEPROM memory 704, flash memory 704, or OTP memory 704. Furthermore, the integrated QKD circuit 701 preferably comprises one or a plurality of non-volatile, read-only memories 705, such as a ROM. Furthermore, the integrated QKD circuit 701 preferably comprises one or a plurality of non-volatile, writable and/or non-writable manufacturer memories 706. In the case of a non-writable manufacturer memory, the manufacturer memory 706 can be a manufacturer ROM. Preferably, the manufacturer ROM 706 comprises boot software for the microcontroller core 716 of the integrated QKD circuit 701. For example, the integrated QKD circuit 701 comprises one or a plurality of cryptography accelerators 707, such as a DES accelerator and/or an AES accelerator 707, preferably connected to the microcontroller core 716 via the internal databus 702. For example, one or a plurality of manufacturer memory firewalls 708 can be provided between the manufacturer memory 706 and the internal databus 702. The integrated QKD circuit 701 preferably comprises, e.g., processing modules that communicate with the microcontroller core 716 of the integrated QKD circuit 701 via the internal databus 702. The processing modules of the integrated QKD circuit 701 preferably comprise at least one of the following modules: A cyclic redundancy check (CRC) module 711, a clock driver module 712, one or a plurality of timer modules 713, a security monitoring and security control circuits 714, one or a plurality of quantum random number generators (QRNG) 715, one or a plurality of 8/16/32/15-bit microcontroller cores 716, and one or a plurality of data interfaces 717, in particular one or a plurality of Universal Asynchronous Receiver Transmitters (UART) to support high-speed serial data. Other circuit components of the integrated QKD circuit 701 comprise, e.g., one or a plurality of base clock drivers 720 (CLK) and/or one or a plurality of clock driver modules 712, a reset circuit 722, a power supply or Vcc circuit 723 comprising voltage regulators which provide the operating voltage, a ground circuit 724, and an input/output circuit 725.

The integrated QKD circuit 701 is preferably configured to enable secure authentication. In addition to the authentication code, the integrated QKD circuit 701 preferably stores, e.g., other data, such as one or a plurality of lifetime and usage data and/or e.g., logistical data and/or e.g., commercial data and/or website and email addresses and/or image data, a set of instructions for control units of the car 802, using which the microcontroller core 716 communicates via a data interface. In addition, the integrated QKD circuit 701 can store other application data. Preferably, the integrated QKD circuit 701 comprises, for example, a microcontroller core 716 which is configured to facilitate secure authentication of a product. The internal databus 702 can comprise multiple databuses 702, e.g. microcontroller cores 716 of the integrated QKD circuit 701, so that these multiple microcontroller cores 716 can independently access different subdevices of the integrated QKD circuit 701 simultaneously. As a rule, however, the integrated QKD circuit 701 comprises only one internal databus 702 and only one microcontroller core 716. The microcontroller core 716 is preferably an ARM processor or the like. The latter is preferably an 8-bit, a 16-bit, a 32-bit, or a 64-bit microcontroller core 716.

Preferably, the integrated QKD circuit 701 comprises one or a plurality of read/write memories RAM 703. These can be SRAMs and/or MRAMs and/or FRAMS or similar. The one or a plurality of read/write memories RAM 703 can also be, in whole or in part, dynamic read/write memories such as DRAMs, which the microcontroller core 716 or a refresh device of the integrated QKD circuit 701 reads and rewrites at regular intervals in a refresh cycle. In order for the microcontroller core 716 to access a memory of the integrated QKD circuit 701, the integrated QKD circuit 701 can comprise access logic that periodically performs this refresh and controls this access. However, a DRAM typically opens up opportunities for an attack and is typically a potential vulnerability. Preferably, this read/write memory RAM 703 of the integrated QKD circuit 701 can be accessed by the microcontroller core 716 of the integrated QKD circuit 701 using the internal databus 702 of the integrated QKD circuit 701. Preferably, the integrated QKD circuit 701 comprises one or a plurality of writable and non-volatile memories 704. Preferably, these writable and non-volatile memories 704 of the integrated QKD circuit 701 can be accessed by the microcontroller core 716 of the integrated QKD circuit 701 by means of the internal databus 702 of the integrated QKD circuit 701. These non-volatile memories 404 of the integrated QKD circuit 701 can, e.g., comprise EEPROM memory 704, flash memory 704, or OTP memory 704. OTP is the abbreviation for “One Time Programmable”, which means programmable only once.

One attack option may be to erase the non-volatile memories 704 by means of radiation, for example X-rays and/or ionizing radiation and/or heating of memory cells. For this purpose, the integrated QKD circuit 701 preferably comprises one or a plurality of security monitoring and security control circuits 714 of the integrated QKD circuit 701 that monitor the data integrity of the memory cells of the erasable memories 704 of the integrated QKD circuit 701. Preferably, the memory cells of the erasable memories 704 of the integrated QKD circuit 701 have redundancy such that at least two check bits are provided for a data word, which is preferably a data word of 8 bits in length, i.e. a byte, and that always at least one first check bit must have the content 1 and another far check bit assigned to this first check bit must have the content 0. For example, the first check bit can be a parity bit of the byte and the second check bit can be the inverse bit of the parity bit to the first check bit. If an attack by ionizing radiation or similar occurs, the attack resets both check bits to the same value. This is an illegal state that the integrated QKD circuit 701 can detect. The one or a plurality of security monitoring and security control circuits 714 of the integrated QKD circuit 701 detect such a deviation and optionally disable the integrated QKD circuit 701 for further accesses at least for a preferably predetermined period of time.

Preferably, each bit of the memory of the integrated QKD circuit 701 is designed twice, so that preferably each logical data bit is realized as a pair of a first physical data bit with a first internal logical value and a second physical data bit with a second internal logical value. Typically, the second internal logical value is the logical inverse of the first internal logical value. That this is always the case is again preferably monitored by the one or a plurality of security monitoring and security control circuits 714 of the integrated QKD circuit 701. The one or a plurality of security monitoring and security control circuits 714 of the integrated QKD circuit 701 again detect deviations and (by way of example and optionally) preferably block further execution of programs or certain program components and/or access to data, e.g. for the microcontroller core 716 in the event of deviations. Preferably, the integrated QKD circuit 701 comprises one or a plurality of reset circuits 722 of the integrated QKD circuit 701. The reset circuits 722 of the integrated QKD circuit 701 each set the integrated QKD circuit 701 and/or subdevices of the integrated QKD circuit 701 to predefined states if predetermined or determinable reset conditions and/or combinations and/or temporal sequences of such reset conditions are present. For example, such conditions may comprise signaling from the one or a plurality of security monitoring and security control circuits 714 of the integrated QKD circuit 701 to one or a plurality of reset circuits 722 of the integrated QKD circuit 701. Also, these conditions may be changes and/or values of electrical node potentials with respect to the potential of a reference node or reference potential line, for example one or a plurality of operating voltages of the integrated QKD circuit 701. A watchdog timer can be part of a reset circuit 722 of the integrated QKD circuit 701. Furthermore, such conditions may relate to the integrity of the housing of the integrated QKD circuit 701. Preferably, the housing of the integrated QKD circuit 701 comprises a detector for opening or damaging the housing of the integrated QKD circuit 701. For example, this can be a single wire that surrounds or covers the integrated QKD circuit 701, for example as a textile network, or covers at least portions of the integrated QKD circuit 701. It can also be a network of wires covering the integrated QKD circuit 701 solely for the purpose of detecting an attack. For example, the integrated QKD circuit 701 can feed an electrical current into one or a plurality of such lines by means of a first input/output line and then remove it at one or a plurality of second input/output lines. If the stream flow is interrupted, this is an indication of an attack which one or a plurality of the one or a plurality of security monitoring and security control circuits 714 of the integrated QKD circuit 701 can detect and which then, for example, signal this attack to the microcontroller core 716 of the integrated QKD circuit 701. For example, in such a case of suspected violation of the integrity of the housing of the integrated QKD circuit 701, one or a plurality of the one or a plurality of security monitoring and security control circuits 714 of the integrated QKD circuit 701 can disable write and/or read access to storage contents of the memories of the integrated QKD circuit 701 and/or erase such contents of the memories of the integrated QKD circuit 701 in whole or in part or set these contents of the memories of the integrated QKD circuit 701 to predefined values or overwrite them with nonsensical data or otherwise manipulate them. The memories of the integrated QKD circuit 701 preferably comprise one or a plurality of non-volatile, read-only memories 705, such as a ROM. Preferably, the ROM of the integrated QKD circuit 701 contains data and/or program instructions defined by design. Preferably, the integrated QKD circuit 701 comprises one or a plurality of non-volatile, writable and/or non-writable manufacturer memories 706 in which the semiconductor manufacturer or another supplier can store its production and security data, such as serial numbers, etc. Preferably, the semiconductor manufacturer locks access to this writable and/or non-writable volatile manufacturer memory 706 of the integrated QKD circuit 701 after the last production test has been performed. Preferably, access to the writable and/or non-writable volatile manufacturer memory 706 of the integrated QKD circuit 701 is possible by means of one or a plurality of manufacturer passwords. In some cases, a double key method is advantageous. In that case, a customer following the semiconductor manufacturer stores a customer password in a customer lock register of the integrated QKD circuit 701 that can also be locked for access by means of a password. Preferably, the semiconductor manufacturer can only access all memory areas of the integrated QKD circuit 701 with the customer password and the semiconductor password. Preferably, the semiconductor manufacturer provides an analysis password by means of which it can cause one or a plurality of the one or a plurality of security monitoring and security control circuits 714 of the integrated QKD circuit 701 to erase the customer contents in the memories of the integrated QKD circuit 701, typically with the aid of the reset circuit 722 of the integrated QKD circuit 701, and then make all memory areas of the integrated QKD circuit 701 accessible for analyzing faults. In the case of a non-writable manufacturer memory of the integrated QKD circuit 701, the manufacturer memory 706 of the integrated QKD circuit 701 can, e.g., be a manufacturer ROM whose contents are determined, for example, during manufacturing of the semiconductor circuit of the integrated QKD circuit 701. The integrated QKD circuit 701 is typically designed to receive and/or send encrypted data and/or program code portions and/or instructions using cryptographic methods stored in the memories of the integrated QKD circuit 701 and executed by one or a plurality of the microcontroller cores 716 of the integrated QKD circuit 701. Preferably, the encryption is QKD encryption in each case. These methods sometimes require considerable computing power. It has therefore proven advantageous that not only the microcontroller core 716 of the integrated QKD circuit 701 executes certain program components of these cryptography methods in the form of substeps of these cryptography methods, but that one or a plurality of special hardware accelerators of the integrated QKD circuit 701, preferably in the form of one or a plurality of cryptography accelerators 707 of the integrated QKD circuit 701, execute these program components. For this purpose, the integrated QKD circuit 701 preferably comprises, for example, a DES accelerator 707 for the DES algorithm and/or an AES accelerator 707 for executing the AES algorithm. The microcontroller core 716 of the integrated QKD circuit 701 typically addresses these hardware accelerators of the integrated QKD circuit 701 via the internal databus 702 of the integrated QKD circuit 701. Preferably, the microcontroller core 716 of the integrated QKD circuit 701 comprises a redundant clock system of the integrated QKD circuit 701 to be able to detect accesses to the clock system of the integrated QKD circuit 701. One or a plurality of the one or a plurality of security monitoring and security control circuits 714 of the integrated QKD circuit 701 monitor the consistency of the logical contents of this preferred plurality of redundant clock systems of the integrated QKD circuit 701, and can detect attacks and errors. Preferably, one or a plurality of manufacturer memory firewalls 708 of the integrated QKD circuit 701 prevent the microcontroller core 716 of the integrated QKD circuit 701 and the test logic of the integrated QKD circuit 701 from accessing the manufacturer memories of the integrated QKD circuit 701. Preferably, these manufacturer firewalls 708 of the integrated QKD circuit 701 can be unlocked by a manufacturer password, as described. Preferably, the number of incorrect entries is very limited to minimize the likelihood of a successful attack. Preferably, the s integrated QKD circuit 701 comprises one or a plurality of cyclic redundancy check (CRC) modules 711 of the integrated QKD circuit 701 so that the integrated QKD circuit 701 for a serial data communication can efficiently generate the CRC data used in most data protocols to detect erroneous data transmissions, on the one hand, in the case of a transmission and, on the other hand, can quickly check the correct reception of the data message in the case of a reception. Preferably, the integrated QKD circuit 701 comprises one or a plurality of clock driver modules (CLK) 712 of the integrated QKD circuit 701 to generate one or a plurality of clock signals of the integrated QKD circuit 701 to drive the circuits of the integrated QKD circuit 701. Preferably, the one or a plurality of clock driver modules (CLK) 712 of the integrated QKD circuit 701 generate redundant clock signals that detect an attack on the clock system of the integrated QKD circuit 701. Typically, the integrated QKD circuit 701 comprises one or a plurality of timer modules 713 of the integrated QKD circuit 701 as required by the microcontroller core 716 for detecting time-outs, for example. Preferably, the integrated QKD circuit 701 comprises one or a plurality of watchdog timers of the integrated QKD circuit 701 that monitor the processing of the various program components by the one or a plurality of microcontroller cores 716 of the integrated QKD circuit 701. These watchdog timers of the integrated QKD circuit 701 can be part of the one or a plurality of the one or a plurality of security monitoring and security control circuits 714 of the integrated QKD circuit 701. According to a proposed embodiment, the integrated QKD circuit 701 comprises at least one quantum random number generator (QRNG) 715. Quantum random number generators have the advantage that they are based on true random numbers. In the 1970s, the physicist Bell proved that the theory of “hidden parameters” was wrong. In other words, there are no hidden causes for the randomness of quantum mechanical events, such as the emission of photons. The microcontroller core 716 of the integrated QKD circuit 701 mentioned multiple times hereinabove can, e.g., be an 8-bit microcontroller core, or a 16-bit microcontroller core, or a 32-bit microcontroller core, or a 64-bit microcontroller core, or a 128-bit microcontroller core, or the like. The integrated QKD circuit 701 can comprise one or a plurality of 8/16/32/15-bit microcontroller cores 716, which can preferably access the other subdevices of the integrated QKD circuit 701 via one or a plurality of internal databuses 702 of the integrated QKD circuit 701. Preferably, the integrated QKD circuit 701 comprises one or a plurality of data interfaces 717 of the integrated QKD circuit 701. Such data interfaces can, e.g., be one or a plurality of Universal Asynchronous Receiver Transmitters (UART) for supporting high-speed serial data. Preferably, the integrated QKD circuit 701 comprises one or a plurality of base clock drivers 721 (CLK) of the integrated QKD circuit 701, each of which preferably provides a base clock to one or a plurality of clock driver modules (CLK) 712 of the integrated QKD circuit 701. Preferably, the base clock drivers 721 (CLK) of the integrated QKD circuit 701 are oscillators. Preferably, the integrated QKD circuit 701 also comprises one or a plurality of power supply or Vcc circuits 723 of the integrated QKD circuit 701 comprising voltage regulators which provide the operating voltages for the integrated QKD circuit 701. Preferably, the integrated QKD circuit 701 also comprises one or a plurality of ground circuits 724 of the integrated QKD circuit 701 comprising, for example, polarity reversal protection and protection circuits against tampering with the electrical potential of the semiconductor substrate of the semiconductor crystal of the integrated QKD circuit 701. For example, it is advantageous for one or a plurality of the one or a plurality of ground circuits 724 of the integrated QKD circuit 701 to comprise polarity reversal protection. For example, it is advantageous if one or a plurality of the one or a plurality of ground circuits 724 of the integrated QKD circuit 701 and/or one or a plurality of the one or a plurality of power supply or Vcc circuits 723 of the integrated QKD circuit 701 interact such that the modulation of the power consumption and/or internal resistance and/or voltage drop between the supply voltage terminals of the integrated QKD circuit 701 at least temporarily does not allow conclusions to be drawn about the operating sequences and/or states of the integrated QKD circuit 701.

For controlling other devices and/or for communicating with other devices and/or for monitoring other devices, it is generally advantageous for the integrated QKD circuit 701 to have one or a plurality of input/output circuits 725 of the integrated QKD circuit 701, which are generally implemented as digital inputs and/or as digital outputs of the integrated QKD circuit 701, which can preferably also assume a tristate state. The integrated QKD circuit 701 can comprise an analog-to-digital converter of the integrated QKD circuit 701, which enables the microcontroller core 716 of the integrated QKD circuit 701 to monitor internal analog values, e.g. the operating voltage and external analog values. The analog-to-digital converter can be provided with an analog multiplexer to monitor a plurality of internal electrical nodes of the integrated QKD circuit 701 for correctness of values of the electrical potential with respect to a reference potential of the integrated QKD circuit 701. Preferably, the microcontroller core 716 of the integrated QKD circuit 701 controls this analog multiplexer. The integrated QKD circuit 701 can optionally be provided with one or a plurality of driver stages 792 of the integrated QKD circuit 701 in order to be able to, e.g., actuate actuators 694. Such actuators 694 can, e.g., be motors and/or other resistive and/or inductive and/or capacitive loads and the like. Such a driver stage 792 of the integrated QKD circuit 701 can, e.g., be a half-bridge of the integrated QKD circuit 701 and/or an H-bridge of the integrated QKD circuit 701 or the like. It is also conceivable that they be power sources of the integrated QKD circuit 701, for example for light sources such as LEDs.

Therefore, the present application proposes an integrated QKD circuit 701, in particular for safely controlling devices in automobiles and comprising a semiconductor crystal. Preferably, the integrated QKD circuit 701 is fabricated using a CMOS circuit technology or a bipolar circuit technology or a BiCMOS circuit technology. The integrated QKD circuit 701 preferably comprises memory elements, one or a plurality of internal databuses 702 of the integrated QKD circuit 701, one or a plurality of 8/16/32/15-bit microcontroller cores 716 of the integrated QKD circuit 701, one or a plurality of data interfaces of the integrated QKD circuit 701, and one or a plurality of preferably quantum process-based generators 715 of the integrated QKD circuit 701 for generating true or high quality random numbers (Quantum Random Number Generator, QRNG). The internal databus 702 of the integrated QKD circuit 701 can comprise a plurality of databuses. The memory elements of the integrated QKD circuit 701 are typically connected to the internal databus 702 of the integrated QKD circuit 701. The data interfaces of the integrated QKD circuit 701 are typically connected to the internal databus 702 of the integrated QKD circuit 701. The one or a plurality of random number generators (QRNG) 715 of the integrated QKD circuit 701 are also preferably connected to the internal databus 702 of the integrated QKD circuit 701. The one or a plurality of microcontroller cores 716 of the integrated QKD circuit 701 are also preferably connected to the internal databus 702 of the integrated QKD circuit 701. The one or a plurality of random number generators (QRNG) 715 preferably and typically generate one or a plurality of random numbers in response to a request from the microcontroller core 716 of the integrated QKD circuit 701. Preferably, one or a plurality of the one or a plurality of microcontroller cores 716 of the integrated QKD circuit 701 generate one or a plurality of keys using a respective program of one or a plurality of their memory elements of the integrated QKD circuit 701 and using one or a plurality of the generated random numbers. Typically, one or a plurality of microcontroller cores 716 of the integrated QKD circuit 701 encrypt and/or decrypt using a respective program of the related microcontroller core 716 of the integrated QKD circuit 701, each of which programs originates from one or a plurality of the memory elements of the QKD circuit 701 and, using a respective key for the generated keys, these microcontroller cores 716 of the integrated QKD circuit 701 typically exchange data via one or a plurality of data interfaces of the exemplary single-photon receiving device 701 with devices external to the integrated QKD circuit 701 via one or a plurality of data interfaces of the one or a plurality of data interfaces of the integrated QKD circuit 701. Typically, the semiconductor crystal comprises all subdevices of the integrated QKD circuit 701 integrally.

In a further embodiment of the integrated QKD circuit 701, the memory elements of the integrated QKD circuit 701 comprise one or a plurality of read/write memories RAM 703 and/or one or a plurality of writable non-volatile memories, in particular EEPROM memory 704 and/or flash memory 704 and/or OTP memory 704, and/or one or a plurality of read-only memories and/or one or a plurality of non-volatile manufacturer memories. The one semiconductor memory or the multiple manufacturer memories of the integrated QKD circuit 701 can, e.g., comprise one or a plurality of manufacturer ROMs 706, and/or one or a plurality of manufacturer EEPROMs, and/or one or a plurality of manufacturer flash memories.

In a second further embodiment, the manufacturer memory of the integrated QKD circuit 701, and more particularly a manufacturer ROM 706 of the integrated QKD circuit 701, comprises boot software for booting the microcontroller core 716 of the integrated QKD circuit 701 to safely start the integrated QKD circuit 701.

In a third further embodiment, the integrated QKD circuit 701 comprises a manufacturer memory firewall 708 of the integrated QKD circuit 701 between the manufacturer memory 706 of the integrated QKD circuit 701 and the internal databus 702 of the integrated QKD circuit 701 that prevents access to the manufacturer memory 706 of the integrated QKD circuit 701 without authentication.

In a fourth further embodiment, the integrated QKD circuit 701 comprises one or a plurality of the following components: A base clock driver 721 (CLK) of the integrated QKD circuit 701, a clock driver circuit 712 of the integrated QKD circuit 701, a reset circuit 722, a power supply circuit or a Vcc circuit 723 of the integrated QKD circuit 701 comprising voltage regulators which provide the operating voltages at least for the integrated QKD circuit 701, a ground circuit 724 of the integrated QKD circuit 701, an input/output circuit 725 of the integrated QKD circuit 701, one or a plurality of processing modules of the integrated QKD circuit 701. Here, the processing modules of the integrated QKD circuit 701 communicate with the internal databus 702 of the integrated QKD circuit 701 and thus typically with a microcontroller core 716 of the integrated QKD circuit 701. Preferably, the processing modules of the integrated QKD circuit 701 comprise one or a plurality of the following modules: A cyclic redundancy check (CRC) module 711, a clock driver module 712, a crypto accelerator 707, in particular a DES accelerator and/or an AES accelerator 707, one or a plurality of timer modules 713, one or a plurality of security monitoring and security control circuits 714, one or a plurality of data interfaces, in particular a Universal Asynchronous Receiver Transmitter (UART) 717.

In a further embodiment of the integrated QKD circuit 701, at least one data interface of the one or a plurality of data interfaces of the integrated QKD circuit 701 is a wired automotive databus interface. In that case, the wired automotive databus interface can, e.g., be a CAN databus interface or a CAN FD databus interface or a Flexray databus interface or a PSI5 databus interface or a DSI3 databus interface or a LIN databus interface or an Ethernet databus interface or a LIN databus interface or a MELIBUS databus interface.

In a further embodiment of the integrated QKD circuit 701, at least one data interface of the one or a plurality of data interfaces of the integrated QKD circuit 701 is a wireless databus interface. The wireless databus interface can, e.g., be a Wi-Fi interface or a Bluetooth interface.

In a further embodiment of the integrated QKD circuit 701, at least one data interface of the one or a plurality of data interfaces of the integrated QKD circuit 701 is a wired databus interface. The wireless databus interface of the integrated QKD circuit 701 can, e.g., be a KNX databus interface or an EIB databus interface or a DALI databus interface or a PROFIBUS databus interface.

Preferably, the integrated QKD circuit 701 comprises one or a plurality of wireless data interfaces 726 for communicating with other computer systems. For example, the exemplary integrated QKD circuit 701 can communicate via a respective antenna 727 of a respective wireless interface 726 of the exemplary integrated QKD circuit 701. Here, the antenna 427 emits an electromagnetic data signal 728 that the single-photon transmission device 401, which preferably comprises the exemplary integrated QKD circuit 701, exchanges with the single-photon receiving device 601 of another unit, e.g. a car, in a wired or wireless manner. In the case of a car key as a single-photon transmission device 401 comprising that of the exemplary integrated QKD circuit 701, the car key 401 exchanges data with the single-photon receiving device 601 of the exemplary car mentioned herein preferably by means of the wireless data interface 726 of the exemplary integrated QKD circuit 701 and the antenna 427 of the single-photon transmission device 401.

For generating a polarization-modulated single-photon beam 452, the integrated QKD circuit 701 preferably comprises an actuating device 729 for the (in this case) n=4 single-photon sources 736, 737, 738, 739. The microcontroller core 716 of the integrated QKD circuit 701 controls the actuating device 729 of the integrated QKD circuit 701 via the internal databus 702 of the integrated QKD circuit 701. For this purpose, the microcontroller core 716 can transmit configuration data of the actuating device 729 of the integrated QKD circuit 701 to the actuating device 729 of the integrated QKD circuit 701 by means of the internal databus 702 and read status information of the actuating device 729 via the internal databus 702 of the integrated QKD circuit 701. Such status information may be, for example, measurement data of the single-photon sources 736 to 739 or of device components related thereto. A control line 730 preferably connects the actuating device 729 of the integrated QKD circuit 701 to an adjustable voltage regulator 742 of the integrated QKD circuit 701. The actuating device 729 of the integrated QKD circuit 701 adjusts the voltage between a supply voltage line 741 of the single-photon sources 736, 737, 738, 739 and a reference potential by means of the control line 730. The reference potential is typically an internal ground potential of an internal ground line of the integrated QKD circuit 701. The adjustable voltage regulator 742 of the integrated QKD circuit 701 generates the potential for the supply voltage line 741 of the single-photon sources 736, 737, 738, 739 of the integrated QKD circuit 701 with respect to the internal reference potential of the integrated QKD circuit 701 based on the potential of the supply voltage line 743 of the integrated QKD circuit 701, which is adjusted by the actuating device 729.

The integrated QKD circuit 701 typically comprises one or a plurality of power supplies 742 for the single-photon sources 736 to 739 of the integrated QKD circuit 701, or a single-photon sources. The energy source, for example a key battery, supplies the power supply 742 of the single-photon sources 736 to 739 with electrical energy via an light source supply voltage line 743. The power supply 742 regulates the operating voltage of the single-photon sources 736 to 739 preferably by means of a linear regulator in order to avoid causing interference as far as possible. Optionally, the actuating device 729 for the single-photon sources 736, 737, 738, 739 does not track the regulation of the voltage between the supply voltage line 741 of the single-photon sources of the integrated QKD circuit 701 and a reference potential (typically ground) of the integrated QKD circuit 701 during the generation of a QKD key so as not to cause interference from the regulation. Preferably, the power supply 742 of the integrated QKD circuit 701 comprises a small power reserve, for example a capacitor, for stabilization.

The supply voltage line 741 of the integrated QKD circuit 701 connects the respective consumers within the integrated QKD circuit 701 to one or a plurality of power supply or Vcc circuits 723 comprising voltage regulators which provide the operating voltages for the microcontroller system of the integrated QKD circuit 701 and the polarization-modulated single-photon transmission devices of the integrated QKD circuit 701. The supply voltage line 741 can also comprise a plurality of lines each connecting, for example, a consumer of electrical power, i.e., a subdevice of the integrated QKD circuit 701, to a respective voltage regulator or power source of the one or a plurality of power supply or Vcc circuits 723. The adjustable voltage regulator 742 of the integrated QKD circuit 701 reduces the voltage between the potential of the supply voltage line 743 of the integrated QKD circuit 701 to such an extent that the potential of the supply voltage line 741 of the integrated QKD circuit 701 of the single-photon sources 736, 737, 738, 739 of the integrated QKD circuit 701 with respect to the internal reference potential of the integrated QKD circuit 701 is sufficient for the integrated QKD circuit 701 to just be able to operate all single-photon sources 736 to 739 of the integrated QKD circuit 701. The single-photon sources 736 to 739 of the integrated QKD circuit 701 each comprise light sources 764 and respective power sources 463 of the respective single-photon source of the single-photon sources 736 to 739 of the integrated QKD circuit 701. The respective power source 763 adjusts the single-photon rate of the respective associated light source 764 of its single-photon source of the single-photon sources 736 to 739 of the integrated QKD circuit 701 depending on signalizations of its associated control line of the control lines 731 to 735 for the associated power source 763 of the associated single-photon source of the single-photon sources 736 to 739 of the integrated QKD circuit 701. The respective power sources 763 of the respective single-photon sources 736 to 739 of the integrated QKD circuit 701 perform the actual adjustment of the photon density of the light emission of the single-photon sources 736 to 739 of the integrated QKD circuit 701. The respective power sources 763 of the respective single-photon sources 736 to 739 of the integrated QKD circuit 701 perform this adjustment depending on control data for the single-photon sources 736 to 739 transmitted by means of the respective control line of the control lines 731 to 734 of the integrated QKD circuit 701 through the actuating device 429 of the integrated QKD circuit 701.

The microcontroller core 716 of the integrated QKD circuit 701 preferably controls the actuating device 729 of the integrated QKD circuit 701 via the internal databus 702 of the integrated QKD circuit 701. The microcontroller core 716 of the integrated QKD circuit 701 preferably exchanges data with the actuating device 729 of the integrated QKD circuit 701 via the internal databus 702 of the integrated QKD circuit 701.

A first control line 731 connects the actuating device 729 to the first power source 763 of the first single-photon source 736 of the integrated QKD circuit 701. Via the first control line 731 for the first power source 763 of the first single-photon source 736 of the integrated QKD circuit 701, the actuating device 729 controls the electrical current through the first power source 763 of the first single-photon source 736 of the integrated QKD circuit 701. Thus, the actuating device 729 controls the electric current through the first light source 764 of the first single-photon source 736 of the integrated QKD circuit 701 by means of the first control line 731. In this way, the actuating device 729 of the integrated QKD circuit 701 controls the polarized first light source 764 of the first single-photon source 736 of the integrated QKD circuit 701. The first light source 764 of the first single-photon source 736 either emits polarized single photons directly or emits single photons of different polarizations, which polarization filters or polarizing optical functional means in the subsequent beam path then polarize. Preferably, the first control line 731 optionally also reports status data and/or measured values and/or other status parameters in digital or analog form of the first single-photon source 736 of the integrated QKD circuit 701 and its subdevices back to the microcontroller core 716 of the integrated QKD circuit 701 via the actuating device 729 for the single-photon sources 736, 737, 738, 739 of the integrated QKD circuit 701. The first control line 731 can comprise one or a plurality of digital or analog signal lines.

A second control line 732 connects the actuating device 729 of the integrated QKD circuit 701 to the second power source 763 of the second single-photon source 737 of the integrated QKD circuit 701. Via the second control line 732 for the second power source 763 of the second single-photon source 737, the actuating device 729 controls the electric current through the second power source 763 of the second single-photon source 737. The actuating device 729 thus controls the electric current through the second light source 764 of the second single-photon sources 737 by means of the second control line 732. In this way, the actuating device 729 of the integrated QKD circuit 701 controls the polarized second light source 764 of the second single-photon source 737 of the integrated QKD circuit 701. The second light source 764 of the second single-photon source 737 of the integrated QKD circuit 701 either emits directly polarized single photons or emits single photons of different polarizations, which then polarize polarization filters or polarizing optical functional means in the subsequent beam path. Preferably, the second control line 732 of the integrated QKD circuit 701 optionally also reports status data and/or measured values and/or other status parameters in digital or analog form of the second single-photon source 737 of the integrated QKD circuit 701 and its subdevices to the microcontroller core 716 of the integrated QKD circuit 701 via the actuating device 729 for the single-photon sources 736, 737, 738, 739 of the integrated QKD circuit 701. The second control line 732 of the integrated QKD circuit 701 can comprise one or a plurality of digital or analog signal lines.

A third control line 733 connects the actuating device 729 to the third power source 763 of the third single-photon source 738 of the integrated QKD circuit 701. Via the third control line 733 for the third power source 763 of the third single-photon source 738, the actuating device 729 of the integrated QKD circuit 701 controls the electrical current through the third power source 763 of the third single-photon source 738 of the integrated QKD circuit 701. Thus, the actuating device 729 of the integrated QKD circuit 701 controls the electric current through the third light source 764 of the third single-photon source 738 of the integrated QKD circuit 701 by means of the third control line 733. In this way, the actuating device 729 of the integrated QKD circuit 701 controls the polarized third light source 764 of the third single-photon source 738 of the integrated QKD circuit 701. The third light source 764 of the third single-photon source 738 either emits polarized single photons directly or emits single photons of different polarizations, which then polarize polarization filters or polarizing optical functional means in the subsequent beam path. Preferably, the third control line 733 optionally also reports status data and/or measured values and/or other status parameters in digital or analog form of the third single-photon source 738 and its subdevices via the actuating device 729 of the integrated QKD circuit 701 for the single-photon sources 736, 737, 738, 739 of the integrated QKD circuit 701 back to the microcontroller core 716 of the integrated QKD circuit 701. The third control line 733 of the integrated QKD circuit 701 can comprise one or a plurality of digital or analog signal lines.

A fourth control line 734 connects the actuating device 729 of the integrated QKD circuit 701 to the fourth power source 763 of the fourth single-photon source 739 of the integrated QKD circuit 701. Via the fourth control line 734 for the fourth power source 763 of the fourth single-photon source 739 of the integrated QKD circuit 701, the actuating device 729 of the integrated QKD circuit 701 controls the electrical current through the fourth power source 763 of the fourth single-photon source 739 of the integrated QKD circuit 701. The actuating device 729 of the integrated QKD circuit 701 thus controls the electric current through the fourth light source 764 of the fourth single-photon source 739 of the integrated QKD circuit 701 by means of the fourth control line 734. In this way, the actuating device 729 of the integrated QKD circuit 701 controls the polarized fourth light source 764 of the fourth single-photon source 739 of the integrated QKD circuit 701. The fourth light source 764 of the fourth single-photon source 739 either directly emits polarized single photons or emits single photons of different polarizations, which polarization filters or polarizing optical functional means in the subsequent beam path then polarize. Preferably, the fourth control line 734 optionally also reports status data and/or measured values and/or other status parameters in digital or analog form of the fourth single-photon source 739 of the integrated QKD circuit 701 and its subdevices via the actuating device 729 of the integrated QKD circuit 701 for the single-photon sources 736, 737, 738, 739 of the integrated QKD circuit 701 back to the microcontroller core 716 of the integrated QKD circuit 701. The fourth control line 735 can comprise one or a plurality of digital or analog signal lines.

In the example in FIG. 7, the integrated QKD circuit 701 comprises, by way of example, four single-photon sources 736 to 739. Preferably, the integrated QKD circuit 701 comprises n single-photon sources which, depending on the control by the actuating device 729 of the integrated QKD circuit 701, feed single photons into the QKD coupling beam 452 by means of suitable optical means. Typically, each of these n single-photon sources of the integrated QKD circuit 701 feeds the single photons emitted by it with a different polarization direction into the QKD coupling beam 452 by means of these optical means. The single-photon sources of the integrated QKD circuit 701 can typically be numbered from 1 to n, with a single-photon source number k. The polarization direction of the single-photons of a single-photon source of the integrated QKD circuit 701 with the single-photon source number k is preferably rotated by 360°*(k−1)/(2*n) with respect to the polarization direction of the single-photons of a single-photon source of the integrated QKD circuit 701 with the single-photon source number 1. Particularly preferably, the number n of the single-photon sources of the integrated QKD circuit 701 is a power of 2. It is preferably true that n=2^{(m-1)}, where m∈ [symbol] . The corresponding single-photon receiving device 601 should then comprise a corresponding number of single-photon detectors 677 to 680 (see, for example, FIG. 6 for exemplary n=4). In this respect, the example in FIG. 7 with n=4 is only exemplary.

The integrated QKD circuit 701 can comprise n single-photon sources, where n is a positive integer greater than 1. This general case is not shown in FIG. 7. However, a skilled person will be able to easily rework this case based on the examples presented here. In such a case, the integrated QKD circuit 701 therefore comprises an n-th control line. The n-th control line connects the actuating device 729 to the n-th power source 763 of the n-th single-photon sources. Via the n-th control line for the n-th power source 763 of the n-th single-photon source, the actuating device 729 controls the electrical current through the n-th power source 763 of the n-th single-photon source of the integrated QKD circuit 701. Thus, the actuating device 729 of the integrated QKD circuit 701 controls the electrical current through the n-th light source 764 of the n-th single-photon source of the integrated QKD circuit 701 by means of the n-th control line. In this way, the actuating device 729 of the integrated QKD circuit 701 controls the polarized n-th light source 464 of the n-th single-photon source of the integrated QKD circuit 701. The n-th light source 764 of the n-th single-photon source of the integrated QKD circuit 701 either emits polarized single photons directly or emits single photons of different polarizations, which polarization filters or polarizing optical functional means then polarize in the subsequent beam path. Preferably, the n-th control line 735 optionally also reports status data and/or measured values and/or other status parameters in digital or analog form of the n-th single-photon source of the integrated QKD circuit 701 and its subdevices via the actuating device 729 of the integrated QKD circuit 701 for the single-photon sources of the integrated QKD circuit 701 back to the microcontroller core 716 of the integrated QKD circuit 701. The n-th control line of the integrated QKD circuit 701 can comprise one or a plurality of digital or analog signal lines.

If the integrated QKD circuit 701 comprises n single-photon sources, an n-th control line of the integrated QKD circuit 701 connects the actuating device 729 of the integrated QKD circuit 701 to the n-th power source 763 of the n-th single-photon source of the integrated QKD circuit 701. Via the n-th control line for the n-th power source 763 of the n-th single-photon source of the integrated QKD circuit 701, the actuating device 729 controls the electrical current through the n-th power source 763 of the n-th single-photon source of the integrated QKD circuit 701. Thus, the actuating device 729 of the integrated QKD circuit 701 controls the electrical current through the n-th light source 764 of the n-th single-photon source of the integrated QKD circuit 701 by means of the n-th control line. In this way, the actuating device 729 controls the polarized n-th light source 764 of the n-th single-photon source of the integrated QKD circuit 701. The n-th light source 764 of the n-th single-photon source either emits polarized single photons directly or emits single photons of different polarizations, which polarization filters or polarizing optical functional means then polarize in the subsequent beam path. Preferably, the n-th control line of the integrated QKD circuit 701 optionally also reports status data and/or measured values and/or other status parameters in digital or analog form of the n-th single-photon source of the integrated QKD circuit 701 and its subdevices via the actuating device 729 for the single-photon sources with k=1 to n back to the microcontroller core 716 of the integrated QKD circuit 701. The n-th control line of the integrated QKD circuit 701 can comprise one or a plurality of digital or analog signal lines.

The first single-photon sources 736 of the integrated QKD circuit 701 typically comprises a polarized first light source 764 and a first power source 763. The first light source 746 is preferably a silicon PN light emitting diode or a SPAD diode used as the light source. The first power source 763 of the integrated QKD circuit 701 energizes the first light source 764 of the first single-photon source 736 of the integrated QKD circuit 701 so briefly and with such low energy that the first light source 764 of the first single-photon source 736 of the integrated QKD circuit 701 emits essentially only individual photons that are spatially and temporally separated from each other. Preferably, this energization of the first light source 764 of the first single-photon source 736 of the integrated QKD circuit 701 by the first power source 763 of the first single-photon source 736 is shorter than 1 ns, better shorter than 500 ps, better shorter than 200 ps, better shorter than 100 ps, better shorter than 50 ps, better shorter than 20 ps, better shorter than 10 ps, better shorter than 5 ps, better shorter than 2 ps, better shorter than 1 ps. Particularly preferably, this energization of the first light source 764 of the first single-photon source 736 of the integrated QKD circuit 701 by the first power source 763 of the first single-photon source 736 of the integrated QKD circuit 701 is shorter than 10 ps.

The second single-photon sources 737 of the integrated QKD circuit 701 typically comprises a polarized second light source 764 and a second power source 763. The second light source 746 of the integrated QKD circuit 701 is preferably a silicon PN-type light emitting diode or a SPAD diode used as the light source. The second power source 763 energizes the second light source 764 of the second single-photon source 737 of the integrated QKD circuit 701 so briefly and with such low energy that the second light source 764 of the second single-photon source 737 of the integrated QKD circuit 701 emits essentially only individual single photons that are spatially and temporally separated from one another. Preferably, this energization of the second light source 764 of the second single-photon source 737 of the integrated QKD circuit 701 by the second power source 763 of the second single-photon source 737 of the integrated QKD circuit 701 is shorter than 1 ns, better shorter than 500 ps, better shorter than 200 ps, better shorter than 100 ps, better shorter than 50 ps, better shorter than 20 ps, better shorter than 10 ps, better shorter than 5 ps, better shorter than 2 ps, better shorter than 1 ps. Particularly preferably, this energization of the second light source 764 of the second single-photon source 737 of the integrated QKD circuit 701 by the second power source 763 of the second single-photon source 737 of the integrated QKD circuit 701 is shorter than 10 ps.

The third single-photon source 738 typically comprises a polarized third light source 764 and a third power source 763. The third light source 746 of the integrated QKD circuit 701 is preferably a silicon PN-type light emitting diode or a SPAD diode used as the light source. The third power source 763 energizes the third light source 764 of the third single-photon source 738 of the integrated QKD circuit 701 so briefly and with such low energy that the third light source 764 of the third single-photon source 738 of the integrated QKD circuit 701 emits essentially only individual single photons that are spatially and temporally separated from one another. Preferably, this energization of the third light source 764 of the third single-photon source 738 of the integrated QKD circuit 701 by the third power source 763 of the third single-photon source 738 of the integrated QKD circuit 701 is shorter than 1 ns, better shorter than 500 ps, better shorter than 200 ps, better shorter than 100 ps, better shorter than 50 ps, better shorter than 20 ps, better shorter than 10 ps, better shorter than 5 ps, better shorter than 2 ps, better shorter than 1 ps. Particularly preferably, this energization of the third light source 764 of the third single-photon source 738 of the integrated QKD circuit 701 by the third power source 763 of the third single-photon source 738 of the integrated QKD circuit 701 is shorter than 10 ps.

The fourth single-photon sources 739 of the integrated QKD circuit 701 typically comprises a polarized fourth light source 764 and a fourth power source 763. The fourth light source 746 of the integrated QKD circuit 701 is preferably a silicon PN-type light emitting diode or a SPAD diode used as the light source. The fourth power source 763 energizes the fourth light source 764 of the fourth single-photon source 739 of the integrated QKD circuit 701 so briefly and with such low energy that the fourth light source 764 of the fourth single-photon source 739 of the integrated QKD circuit 701 emits essentially only individual single photons that are spatially and temporally separated from one another. Preferably, this energization of the fourth light source 764 of the fourth single-photon source 739 of the integrated QKD circuit 701 by the fourth power source 763 of the fourth single-photon source 739 is shorter than 1 ns, better shorter than 500 ps, better shorter than 200 ps, better shorter than 100 ps, better shorter than 50 ps, better shorter than 20 ps, better shorter than 10 ps, better shorter than 5 ps, better shorter than 2 ps, better shorter than 1 ps. Particularly preferably, this energization of the fourth light source 764 of the fourth single-photon source 739 of the integrated QKD circuit 701 by the fourth power source 763 of the fourth single-photon source 739 of the integrated QKD circuit 701 is shorter than 10 ps.

In the case of n single-photon sources as part of the integrated QKD circuit 701 (not shown in the drawings), the n-th single-photon source of the integrated QKD circuit 701 typically comprises a polarized n-th light source 764 and an n-th power source 763. The n-th power source 763 preferably energizes the n-th light source 764 of the n-th single-photon source of the integrated QKD circuit 701 so briefly and with such low energy that the n-th light source 764 of the n-th single-photon source of the integrated QKD circuit 701 emits essentially only individual single photons that are spatially and temporally separated from one another. Preferably, this energization of the n-th light source 764 of the n-th single-photon source of the integrated QKD circuit 701 by the n-th power source 763 of the n-th single-photon source of the integrated QKD circuit 701 is shorter than 1 ns, better shorter than 500 ps, better shorter than 200 ps, better shorter than 100 ps, better shorter than 50 ps, better shorter than 20 ps, better shorter than 10 ps, better shorter than 5 ps, better shorter than 2 ps, better shorter than 1 ps. Particularly preferably, this energization of the n-th light source 764 of the n-th single-photon source of the integrated QKD circuit 701 by the n-th power source 763 of the n-th single-photon source of the integrated QKD circuit 701 is shorter than 10 ps.

In the example in FIGS. 4 and 5, an optical subdevice of the single-photon transmission device 401 or 471 combines the respective single-photon streams of the single-photon sources 436 to 440 to form a QKD coupling beam 452 of polarization-modulated single photons. This optical means is not shown in the example in FIG. 7. However, a skilled person will easily be able to achieve this function using prior art means.

A much smaller problem is different single-photon densities of the single-photon sources 736 to 739 of the integrated QKD circuit 701, as they are fabricated integrally in the same semiconductor circuit manufacturing process. Nevertheless, the integrated QKD circuit 701 exhibits a photodetector 751 similar to the photodetector 451 in FIG. 4. A skilled person will provide the appropriate optical device components such that this photodetector 751 can perform an function similar to the photodetector 451 in FIG. 4. Preferably, the integrated QKD circuit 701 comprises an actuator controller for an actuator that the microcontroller core 716 of the integrated QKD circuit 701 can control by means of this actuator controller via the internal databus 702 to remove a beam splitter or mirror (e.g., 448 in FIG. 4) from the beam path of the transmitter when the calibration of the photon rates of the single-photon sources 736 to 739 of the integrated QKD circuit 701 is completed. The microcontroller core 716 of the integrated QKD circuit 701 preferably utilizes, e.g., the photodetector 751 to determine the photon density in the beam path (FIG. 4, reference character 449) of the single-photon transmission device 401 in FIG. 4. A potential problem is that the transmitted polarization of the single photons may not be linked to the temporal density of the single photons, i.e. the number of single photons per second. Therefore, the microcontroller core 716 of the integrated QKD circuit 701 inserts the mirror (FIG. 4 reference sign 448) into the beam path (FIG. 4, reference character 446) of the single-photon transmission device (FIG. 4, reference character 401), e.g. by means of an actuator external to the integrated QKD circuit 701, which it controls via the internal databus 702 of the integrated QKD circuit 701. The microcontroller core 716 then uses the photodetector 751 to detect the single photon density in the beam path of the single-photon transmission device (FIG. 4, reference characters 401). In each case, the microcontroller core 716 operates a single-photon source of the single-photon sources 736 to 736 of the integrated QKD circuit 701 and detects a single-photon density associated with this single-photon source. A receive signal 753 of the photodetector 751 connects the photodetector 751 of the integrated QKD circuit 701 to an evaluation circuit 754 of the photodetector 751. The evaluation circuit 754 of the integrated QKD circuit 701 is preferably coupled to the microcontroller core 716 of the integrated QKD circuit 701 via the internal databus 702 of the integrated QKD circuit 701. The evaluation circuit 754 of the photodetector 751 detects the values of the receive signal 753 of the photodetector 751, which depend on the single photons in the beam path of the single-photon receiving device (FIG. 4, reference character 401) from the first beam splitter or mirror (FIG. 4, reference character 448) to the photodetector 751 of the integrated QKD circuit 701, preferably converts them into digitized values, for example with the aid of an analog-to-digital converter ADC of the integrated QKD circuit 701 and transmits the measured value thus acquired relating to the single photons in the beam path of the single-photon receiving device (FIG. 4, reference character 401) from the first beam splitter or mirror (FIG. 4, reference character 448) to the photodetector 751 of the integrated QKD circuit 701 to the microcontroller core 716 of the integrated QKD circuit 701 via the internal databus 702 of the integrated QKD circuit 701. The microcontroller core 716 of the integrated QKD circuit 701 then controls the power sources 763 of the respective single-photon sources 736 to 739 of the integrated QKD circuit 701 such that the single-photon density of a single-photon source of the single-photon sources 736 to 739 of the integrated QKD circuit 701 detected by the photodetector 751 of the integrated QKD circuit 701 by means of the value of the receive signal 753 of the photodetector 751 of the integrated QKD circuit 701 is initially within a provided single-photon density range value interval and does not subsequently change by more than 10%, better 5%, better 2%, better 1%, better 0.5%, better 0.2%, better 0.1%, better 0.05%, better 0.02%, better 0.01% from the single-photon densities of all other single-photon sources of the single-photon sources 736 to 739 of the integrated QKD circuit 701. After the single-photon densities of the various single-photon sources of the integrated QKD circuit 701 have been calibrated, the microcontroller core 716 preferably removes the mirror (reference character 446 in FIG. 4) from the beam path (reference character 449 in FIG. 4) of the single-photon transmission device (reference character 401 in FIG. 4), which then radiates the single photons in the beam path (reference character 449 in FIG. 4) of the single-photon transmission device (reference character 401 in FIG. 4) as a QKD coupling beam 452 to a receiver, e.g. a single-photon receiving device 601. Preferably, the integrated QKD circuit 701 is part of a single-photon transmission device, as shown in FIGS. 4 and 5.

In the case of a key, the integrated QKD circuit 701 preferably comprises circuitry for supporting a human-machine interface 765 (HMI) to enable communication between the integrated QKD circuit 701 on the one hand and the single-photon receiving device 601 of the OKD-coupled unit being controlled (e.g., a car) by a person operating the system. By way of example, the present application assumes a car key as a single-photon transmission device 401 and an exemplary car as a unit being controlled using a single-photon receiving device 601. In this context, the single photon transmitting device 401 of the car key comprises an integrated QKD circuit 701. For the purposes of the present application, the support circuit of the integrated QKD circuit 701 for the human machine interface (HMI) 765 connects a support circuit 766 for an input terminal 466 for interacting with a person using the HMI to the microcontroller core 716 of the integrated QKD circuit 701 via the internal databus 702 of the integrated QKD circuit 701. For example, in the case of a car key, the support circuit 766 of the input terminal 466 of the integrated QKD circuit 701 can preferably comprise actuating and reading one or a plurality of buttons 467 or one or a plurality of switches 467 or other mechanical input devices for manual input by means of a support circuit 767 for reading and/or actuating such buttons and switches. Also, the support circuit 766 for the input terminal 466 of the integrated QKD circuit 701 can preferably comprise, for example, in the case of a car key, a support circuit 768 for operating one or a plurality of biometric sensors 468. The biometric sensors 468 supported by this support circuit 768 can, e.g., be one or a plurality of fingerprint sensors and/or one or a plurality of cameras and/or one or a plurality of microphones and/or one or a plurality of speech recognition devices and/or one or a plurality of speaker recognition devices and/or one or a plurality of face recognition devices and/or one or a plurality of retina scanners or the like. Also, in the case of a car key, for example, the support circuit 766 for the input terminal 466 of the integrated QKD circuit 701 can preferably act a support circuit 770 for one or a plurality of actuators 470 for feedback signals from the integrated QKD circuit 701 to the person using it. In the context of the present application, an actuator 470 that is controllable and/or readable by this support circuit 770 can, e.g., be a mechanical vibrator, a speaker, a beeper or other sound transducer, or a heater or the like. The actuator 470 typically serves to transmit a mechanical signal from the integrated QKD circuit 701 to the user. However, it can also serve their mechanical purposes. In addition to these mechanical/thermal feedbacks, the support circuit 766 of the integrated QKD circuit 701 for the input terminal 466 of the integrated QKD circuit 701 can preferably comprise support circuitry 769 for one or a plurality of optical signaling means 469, for example in the form of an optical output element for signaling from the integrated QKD circuit 701 to a user, for example in the case of a car key. The optical signaling means 469 supported by this support circuit 769 can comprise one or a plurality of screens and/or one or a plurality of light sources and/or one or a plurality of means that change their absorption characteristics, such as LCD displays or e-Ink displays. Preferably, the integrated QKD circuit 701 comprises a support circuit 1709 for one or a plurality of means 1409 for identifying a person using single-photon transmission device 401 comprising the integrated QKD circuit 701. For example, the support circuit 1709 for the means 1409 for identifying a person using the single-photon transmission device 401 can be a circuit for actuating a subscriber identification module (SIM) card. The single-photon transmission device 401 can optionally be a cell phone or a smartphone comprising the integrated QKD circuit 701. Therefore, one of the wireless data interfaces of the integrated QKD circuit 701 can, e.g., be a cellular data interface into a cellular network or a Wi-Fi network or the like. It may therefore also be advantageous, among other things, if the integrated QKD circuit 701 can establish an authentication data channel to the server of a service provider, e.g. an automobile manufacturer, via this interface.

Preferably, the integrated QKD circuit 701 comprises one or a plurality of wireless and/or wired data interfaces 726. The data transmission channel 428 to a single-photon transmission device 401 can be wired or wireless. In the case of a car, the data transmission channel 428 is preferably wireless. The data transmission channel 428 is then typically an electromagnetic data signal that the integrated QKD circuit 701 exchanges in a wireless manner with a single-photon transmission device 401. In the case of a car with the integrated QKD circuit 701, the car exchanges data with the single-photon transmission device 401 preferably by means of a wireless data interface 726 and its antenna 727. In the case of a wired data transmission channel, the data transmission channel is then typically an electromagnetic data signal that the integrated QKD circuit 701 exchanges with the single-photon transmission device 401 by wire. In this case of a wireless data interface, the integrated QKD circuit 701 typically comprises one or a plurality of respective antennas 727 of the respective wireless interface 726.

The integrated QKD circuit 701 preferably comprises an evaluation circuit 772 for the receive signals 773 to 776 of the single-photon detectors 777 to 780 for differently polarized single photons. The evaluation circuit 772 receives measured values in the form of signalizations of the single-photon detectors 777 to 780 for differently polarized single photons via said receive signals 773 to 776. The evaluation circuit 772 processes these measured values and makes the result of this processing available to the microcontroller core 716 via the internal databus 702.

The integrated QKD circuit 701 preferably comprises a single-photon detector system 1703 for receiving a polarization-modulated single-photon signal. The single-photon detector system 1703 preferably comprises n receiving channels for single photons. The receiving channels each detect the single photons at a rotation of the polarization planes of (k−1)/(2*n)*360° with respect to a base direction. The receive channels can be numbered consecutively starting with 1. In this case, k is the number of the receive channel, n is the number of receive channels, and k is a number where 1≤k≤n. The single-photon detector system provides the microcontroller core 716 with data on the received single photons, whereby this data preferably comprises the polarization direction and the time period or time of reception. The exemplary single-photon detector system 1703 preferably comprises a first single-photon detector 777 for horizontally polarized single photons and a second single-photon detector 778 for vertically polarized single photons and a third single-photon detector 779 for +45° polarized single photons and a fourth single-photon detector 780 for −45° polarized single photons. The proposed single-photon detector system 1703 is preferably a single-photon detector system 1703 for polarization-modulated single photons. The single-photon detector system 1703 preferably comprises n receiving channels for single photons. The receiving channels each detect the single photons with a rotation of the polarization planes of (k−1)/(2*n)*360° with respect to a base direction. The receive channels can be numbered consecutively starting with 1. In this case, k is the number of the receive channel, n is the number of receive channels, and k is a number where 1≤k≤n. The single-photon detector system provides the microcontroller core 716 with data on the received single photons, whereby these data preferably comprises the polarization direction and the time period or time of reception.

The integrated QKD circuit 701 preferably comprises a first single-photon detector 777 for horizontally polarized single photons, for example a first SPAD diode. The present application assumes that, in the case of a SPAD diode, the first single-photon detector 777 comprises the drive circuit and evaluation circuit for operating the SPAD diode. Preferably, the semiconductor substrate of the microcontroller core 716 also comprises the first SPAD diode with the necessary operating circuits and the connector for a supply voltage, and thus the first single-photon detector 777. The first single-photon detector for horizontally polarized single photons 777 is integrated into the integrated QKD circuit 701 such that the first single-photon detector for horizontally polarized single photons 777 detects substantially only horizontally polarized single photons of the QKD coupling beam 452 emitted from a single-photon transmission device 401, such as a car key. The structure of the first single-photon detector 777 can, for example, already ensure that the first single-photon detector 777 for horizontally polarized single photons detects substantially only horizontally polarized single photons of the QKD coupling beam 452. Such a structure can, for example, provide a first micro-optical grating as a polarization device that only transmits single photons of a horizontal polarization direction. However, such a structure can, e.g., also comprise the second polarizing beam splitter 684 as a microintegrated microoptical functional element and the second single-photon detector 778. The first single-photon detector 777 converts the received single photons of the third horizontally polarized single-photon stream into a first receive signal 773 of the first single-photon detector 777 for horizontally polarized single photons 773. Thus, the first single-photon detector 777 preferably converts substantially only the received horizontally polarized single photons into the first receive signal 773 of the first single-photon detector 777 for horizontally polarized single photons. A first receive signal 773 of the first single-photon detector 777 for horizontally polarized single photons 777 signals the evaluation circuit 772 to receive single photons.

The integrated QKD circuit 701 preferably comprises a second single-photon detector 778 for vertically polarized single photons, for example a second SPAD diode. The present application assumes that, in the case of a SPAD diode, the second single-photon detector 778 comprises the drive circuit and evaluation circuit for operating the SPAD diode. Preferably, the semiconductor substrate of the microcontroller core 716 also comprises the second SPAD diode with the necessary operating circuitry and the connector for a supply voltage, and thus the second single-photon detector 778. Preferably, the second single-photon detector for vertically polarized single photons 778 is integrated into the integrated QKD circuit 701 such that the second single-photon detector for vertically polarized single photons 778 detects substantially only vertically polarized single photons of the QKD coupling beam 452. The structure of the second single-photon detector 778 can, e.g., already ensure that the second single-photon detector for vertically polarized single photons 778 detects substantially only vertically polarized single photons of the QKD coupling beam 452. Such a structure can, e.g., provide a second micro-optical grating as a polarization device that only transmits single photons of a vertical polarization direction. However, such a structure can also comprise, for example, the second polarizing beam splitter 784 as a microintegrated microoptical functional element and the first single-photon detector 777. The second single-photon detector 778 converts the received single photons of the fourth horizontally polarized single-photon stream 786 into a second receive signal 774 of the second single-photon detector 778 for vertically polarized single photons. The second single-photon detector 778 preferably thus converts substantially only the received vertically polarized single photons into the second receive signal 774 of the second single-photon detector 778 for vertically polarized single photons. A second receive signal 774 from the second single-photon detector 778 for vertically polarized single photons 778 signals the evaluation circuit 772 to receive single photons.

The integrated QKD circuit 701 preferably comprises a third single-photon detector 779 for +45° polarized single photons, such as a third SPAD diode. The present application assumes that, in the case of a SPAD diode, the third single-photon detector 778 comprises the drive circuit and evaluation circuit for operating the SPAD diode. Preferably, the semiconductor substrate of the of the microcontroller core 716 also comprises the third SPAD diode and thus the third single-photon detector 779. The third single-photon detector for +45° polarized single photons 779 is preferably integrated into the single-photon receiving device 701 such that the third single-photon detector for +45° polarized single photons 779 substantially detects only +45° polarized single photons of the OKD coupling beam 452. The structure of the third single-photon detector 779 can already ensure that the third single-photon detector for horizontally polarized single photons 779 detects substantially only +45° polarized single photons of the OKD coupling beam 452. Such a structure can, e.g., provide a third +45° oriented micro-optical grating as a polarization device on the surface of a third SPAD diode, i.e. at its light entry port, which only transmits single photons of a +45° oriented polarization direction. However, such a structure can also comprise, for example, the third polarizing beam splitter 690 as a microintegrated microoptical functional element and the fourth single-photon detector 780. The third single-photon detector 779 converts the received single photons of the fifth +45° polarized single-photon stream 1605 into a third receive signal 775 of the third single-photon detector 779 for +45° polarized single photons 775. Thus, the third single-photon detector 779 preferably converts substantially only the received +45° polarized single photons into the third receive signal 775 of the third single-photon detector 779 for +45° polarized single photons. A third receive signal 775 of the third single-photon detector 779 for +45° polarized single photons 779 signals the evaluation circuit 772 to receive single photons.

The integrated QKD circuit 701 preferably comprises a fourth single-photon detector 780 for −45° polarized single photons, for example a fourth SPAD diode. The present application assumes that, in the case of a SPAD diode, the fourth single-photon detector 779 comprises the drive circuit and evaluation circuit for operating the SPAD diode. Preferably, the semiconductor substrate of the microcontroller core 716 also comprises the fourth SPAD diode and thus the fourth single-photon detector 780. The fourth single-photon detector for −45° polarized single photons 780 is preferably integrated into the integrated QKD circuit 701 such that the fourth single-photon detector for −45° polarized single photons 780 substantially detects only −45° polarized single photons of the OKD coupling beam 452. The structure of the fourth single-photon detector 780 can, e.g., already ensure that the third single-photon detector for horizontally polarized single photons 780 detects substantially only −45° polarized single photons of the QKD coupling beam 452. Such a structure can, e.g., provide a third −45° oriented micro-optical grating as a polarization device on the surface of a fourth SPAD diode, i.e. at its light entry port, which only transmits single photons of a −45° oriented polarization direction. However, such a structure can also comprise, for example, the third polarizing beam splitter 790 as a microintegrated microoptical functional element and the third single-photon detector 779. The fourth single-photon detector 780 converts the received single photons of the sixth +45° polarized single-photon stream 791 into a fourth receive signal 780 of the fourth single-photon detector 780 for −45° polarized single photons 776. Thus, the fourth single-photon detector 780 preferably converts substantially only the received −45° polarized single photons into the fourth receive signal 776 of the fourth single-photon detector 780 for −45° polarized single photons. A fourth receive signal 776 of the fourth single-photon detector 780 for −45° polarized single photons 780 signals the evaluation circuit 772 to receive single photons.

The integrated QKD circuit 701 preferably comprises a supply voltage line 743. The supply voltage line 743 connects the respective consumers within the integrated QKD circuit 701 to one or a plurality of power supply or Vcc circuits 763 comprising voltage regulators which provide the operating voltages for the microcontroller system of the integrated QKD circuit 701 and the QKD transmitter of the integrated QKD circuit 701. The supply voltage line 743 can also comprise a plurality of lines that each connect, for example, a consumer of electrical power, i.e., a subdevice of the integrated QKD circuit 701, to a respective voltage regulator or power source of the one or a plurality of power supply or Vcc circuits 723.

The integrated QKD circuit 701 is preferably coupled to an optional receiving optical means 681 for the QKD coupling beam 452. The optional receiving optical means 681 focuses the incoming single photons of the single-photon beam of the QKD coupling beam 452 onto the single-photon detectors 777, 778, 779, 780 of the integrated QKD circuit 701. Either the single-photon detectors 777, 778, 779, 780 are sensitive to different polarization directions or the optional receiving optical means 681 focuses the incoming single photons of the single-photon beam of the QKD coupling beam 452 onto different single-photon detectors 777, 778, 779, 780 depending on the polarization direction of the incoming single photons.

If alignment of the single-photon transmission device 401 with respect to the single-photon receiving device 601 is necessary, an integrated QKD circuit 701 of the single-photon receiving device 601 comprises, for example, an alignment receiver 799. The receiver 1701 of the alignment receiver 799 detects the laser pointer beam 462 for aligning the single-photon transmission device 401, 471, for example a car key, with respect to the QKD circuit 701. The interface 1706 of the alignment receiver 799 receives measurement data from the receiver 1701 of the alignment receiver 799 via the alignment receiver line 798. The interface 1706 of the alignment receiver 799 signals the microcontroller core 716 via the internal databus 702 whether the receiver 1701 of the alignment receiver 799 receives sufficient light from the laser pointer beam 462 via the optical system 1602 of the alignment receiver 799 to align the single-photon transmission device 471, for example a car key, with the integrated QKD circuit 701 of the single-photon receiving device 601. Only when this is the case, the microcontroller core 716 preferably starts the generation of a common quantum key for the single-photon transmission device 471, for example the car key 471, and the single-photon receiving device 601 of the car 802. For this purpose, the microcontroller core 716 of the integrated QKD circuit 701 of the single-photon receiving device 701 signals the microcontroller core 716 of the integrated QKD circuit 701 of the single-photon transmission device 471, for example the car key 471, for example via a wireless data connection 726, 727,428, 727, 726, that the agreement of a quantum key can start. The microcontroller core 716 of the integrated QKD circuit 701 of the single-photon transmission device 471, for example of the car key 471, then causes the single-photon transmission device 1707 of the integrated QKD circuit 701 of the single-photon transmission device 471 to generate a polarization-modulated stream of single photons as a QKD coupling beam 452, whereby the microcontroller core 716 of the integrated QKD circuit 701 of the single-photon transmission device 471, for example of the car key, preferably generates as modulation signal of the polarization direction of the emitted single photons a random number of its at least one quantum random number generator (QRNG) 715. The integrated QKD circuit 701 of the single-photon receiving device 601 of the other unit, e.g. a car, receives this polarization-modulated single-photon data stream of the QKD coupling beam 452.

For example, the integrated QKD circuit 701 of the single-photon receiving device 601 can control or influence an exemplary locking device 694 of a car as a car key 401 or 471. In the exemplary application of a door lock for opening a door 804 or other opening of a car, the microcontroller core 716 of the single-photon receiving device 601 exchanges an encryption code with an integrated QKD circuit 701 of the single-photon transmission device 401 or 471, for example a car key 401 or 471, in a tap-proof manner using a QKD method. After the integrated QKD circuit 701 of the single-photon transmission device 401 of the car key 401 or 471 has established a secure wireless connection 428 between the integrated QKD circuit 701 of the single-photon transmission device 401, i.e. the car key, and the single-photon receiving device 601, i.e. the car, by generating a shared secret quantum key, the microcontroller core 716 of the integrated QKD circuit 701 of the single-photon transmission device 401 or 471, i.e. the car key 401 or 471, can exchange authentication data with the microcontroller core 716 of the integrated QKD circuit 701 of the single-photon receiving device 601 or a computer unit superordinate to the microcontroller core 716. Insofar as this computer unit 697, which is superordinate to the microcontroller core 716 or the microcontroller core 716 of the integrated QKD circuit 701 of the single-photon receiving device 601 deems the authentication data to be trustworthy following a comparison with a database, the microcontroller core 716 of the integrated QKD circuit 701 of the single-photon receiving device 601 causes, e.g. by means of suitable signaling via the internal databus 702 of the integrated QKD circuit 701 of the single-photon receiving device 601, the control 792 of the integrated QKD circuit 701 of the single-photon receiving device 601 for driving the exemplary locking device 694 and the control line 693 for driving the exemplary locking device 694 to drive the exemplary locking device 694 of the car to open, unlock, lock, or close the door or other opening of the car.

The integrated QKD circuit 701 of the single-photon receiving device 601 can further comprise a controller 792 for driving the exemplary locking device 694. By means of a control line 793 for driving the exemplary locking device 694, the controller 792 of the integrated QKD circuit 701 for driving the exemplary locking device 694 exchanges control data and/or status data with the drive of the exemplary locking device 694 and makes them available to the microcontroller core 716 of the integrated QKD circuit 701 via the internal databus 702 of the integrated QKD circuit 701. By means of the control line 793 of the integrated QKD circuit 701 for driving the exemplary locking device 694, the controller 792 of the integrated QKD circuit 701 for driving the exemplary locking device 694 actuates control data and/or status data with the drive of the exemplary locking device 694.

The integrated QKD circuit 701 of the single-photon receiving device 601 preferably comprises one or a plurality of data connections 796 from one or a plurality of data interfaces 795 of the integrated QKD circuit 701 of the single-photon receiving device 601 to a superordinate computer unit 697 via a databus 796 of the integrated QKD circuit 701 of the other unit, e.g. the car. This can, e.g., be a CAN databus or a CAN FD databus or a PSI5 databus or a DSI3 databus or an I2C bus or an Ethernet connection or an optical data connection, for example an optical fiber, or an encrypted radio connection, such as Wi-Fi or Bluetooth, or the like. The superordinate computer unit 697 can, e.g., be any desired computer unit in the motor vehicle. This superordinate computer unit generally controls the actions of the microcontroller core 716 of the integrated QKD circuit 701 of the single-photon receiving device 601 of the other unit, e.g. the car.

The integrated QKD circuit 701 typically comprises a power supply 756 for a laser pointer laser diode 459. The laser pointer laser diode 459 typically emits a laser pointer beam 462 when powered. A user can preferably use the laser pointer beam 462 to align the single-photon transmission device 471, such as a car key, with a single-photon receiving device 601. Preferably, the laser pointer beam 462 has a wavelength that is different from the wavelength of the single photons in the QKD coupling beam 452. Preferably, the single-photon detectors 436 to 440 of the single-photon receiving device 601 are not sensitive to the wavelength of the radiation of the laser pointer beam 462. Preferably, the single-photon detectors 436 to 440 of the single-photon receiving device 601 are protected by shutters, housings and/or filters. Preferably, the integrated QKD circuit 701 comprises a control device 757 for the power source 760 of the laser pointer diode 459, which controls the value of the electric current through the laser pointer diode 459. For example, the microcontroller core 716 of the integrated QKD circuit 701 controls the control device 757 via the internal databus 702. The laser pointer diode 459 preferably emits visible light, which is typically detectable by a human user. As a result, the user is able to detect and correct misalignments. The power source 760 of the laser pointer diode 459 adjusts the operating current through the laser pointer diode 459 depending on the signaling from the control device 757 for the power source 760 of the laser pointer diode 459. A projection optical means 461 of the laser pointer device improves the beam quality of the laser pointer beam 462 for aligning the car key.

FIG. 8 shows the coupling of a single-photon transmission device 401 to a single-photon receiving device 601 using a QKD coupling beam 452.

In the example in FIG. 8, the exemplary car key comprises the single-photon transmission device 401 and the exemplary car 802 comprises the single-photon receiving device 601.

Preferably, the single-photon transmission device 401 comprises an integrated QKD circuit 701. Preferably, the single-photon receiving device 601 also comprises an integrated QKD circuit 701.

The single-photon transmission device 401 determines a first random number and a second random number by means of its preferably quantum random number generator (QRNG) 415. The single-photon transmission device 401 transmits the first random number and the second random number to the single-photon receiving device 601 of the other device (in this case the car 802), using the QKD coupling beam of polarization-modulated single photons. The microcontroller core 616 of the single-photon receiving device 601 of the other device (in this case the car 802), then encrypts the second random number with the first random number as a QKD key to form a QKD-encrypted second random number. The microcontroller core 616 of the single-photon receiving device 601 of the other device (in this case that of the car 802), then transmits the QKD-encrypted second random number to the single-photon transmission device 401 (i.e., the car key), by means of a conventional data transmission channel 428. The microcontroller core 416 of the single-photon transmission device 401 (i.e., the car key), decrypts the QKD-encrypted second random number received as a test message with the first random number as a QKD key to form a decrypted second random number. The microcontroller core 416 of the single-photon transmission device 401 (i.e., the car key), compares the second random number with the decrypted second random number. If they match, the microcontroller core 416 of the single-photon transmission device 401 (i.e., the car key), and the microcontroller core 616 of the single-photon receiving device 601, i.e., the car 802, have successfully agreed on a common key. From this point on, the microcontroller core 416 of the single-photon transmission device 401 (i.e., the car key), and the microcontroller core 616 of the single-photon receiving device 601 (i.e., the car 802), can exchange encrypted data via conventional data transmission channels 428. Preferably, the microcontroller core 416 of the single-photon transmission device 401 (i.e., the car key), and the microcontroller core 616 of the single-photon receiving device 601 (i.e., the car 802), agree again on a new QKD key after predeterminable time periods have elapsed to preclude breaking of the key. Preferably, the microcontroller core 416 of the single-photon transmission device 401 (i.e., the car key), and the microcontroller core 616 of the single-photon receiving device 601 (i.e., the car 802), exchange further authentication data, which can include GPS data, biometric data, key numbers, car manufacturer data, and/or service provider data, etc. For example, the configuration of the car, such as the maximum speed and/or the maximum acceleration or the allowed radius of action around a reference point or the allowed area, etc., can depend on the biometric features captured by the car key. If the authentication data for driving the locking device 694 are correct and the car key transmits a QKD-encrypted command to unlock or lock or open or close an opening of the car 802 (e.g., a door 804), the single-photon receiving device 601 or a superordinate device executes this command from the car key. Finally, it should be mentioned at this point that the body of the car 802 preferably comprises an optical window 803 transparent to the QKD coupling beam 452 so that the QKD coupling beam can reach the single-photon receiving device 601 with a low photon loss rate.

It is apparent that the single-photon receiving device 601 can be used in the car key instead of the car 802, if the single-photon transmission device 401 is used in the car 802 instead. This reversal is hereby made a complete part of the disclosure herein and relates to the entire text of the present application as presented.

FIG. 9 corresponds largely to FIG. 8 with the difference that the user now uses a laser pointer beam 462 to align the single-photon transmission device 401, i.e. the car key, with the single-photon receiving device 601, i.e. the door lock. Only when the laser pointer beam 462 of the laser pointer device 455 of the single-photon transmission device 401, i.e. the car key, hits the alignment receiver 699 of the single-photon transmission device 601, i.e. the car 802, does the microcontroller core 616 of the single-photon receiving device 601 signal via the conventional data transmission channel 428 single-photon transmission device 401 that the agreement of a QKD key, as described in the description to FIG. 8, can start. Thereupon, the single-photon transmission device 401 starts the agreement of a common secret QKD key.

FIG. 10 shows the agreement of a QKD key between a car 802 and an infrastructure device, in this case a charging station 1011. The charging station 1011 in FIG. 10 comprises, by way of example, a single-photon receiving device 601. The wireless data transmission link 428 shown by way of example in FIGS. 4, 5, and 6 is, by way of example, replaced by another, now wired, data transmission path 428. A charging cable 1012 connects the charging station 1011 to the car 802 via a charging connector 1013.

The charging cable 1012 preferably comprises a waveguide, for example a fiber optic cable, for transmitting the QKD coupling beam 452 from the single-photon transmission device 401 of the car 802 to the single-photon receiving device 601 of the charging station 1011. Furthermore, the charging cable 1012 preferably comprises an electrical line for exchanging data by means of a now wire-based data transmission path 428 between the microcontroller core 616 of the single-photon receiving device 601 of the charging station 1011 on the one hand and the microcontroller core 416 of the single-photon transmission device 401 of the car 802 on the other hand, which in this case then enables the role of the key for enabling access to the charging station 1011. If the data transmission path 428 is radio-based, then this line is not necessary. Thus, unlike in the scenario with a car key and a car, the data transmission path 428 can now also be explicitly wire-based. In this case, the charging cable preferably comprises a corresponding data line. A laser pointer beam 462 is not necessary here. Finally, the charging cable typically also comprises the power lines for transporting electrical power from the charging station to the car and optionally back. First, the charging connector 1013 preferably comprises a plurality of electrical power connections for the transmission of electrical power from the charging station 1011 to the car 802. Furthermore, the charging connector preferably comprises a plug-in connection for the data connection of the data line of the charging cable 1012 to a data line of the car to the single-photon transmission device 401 in order to be able to establish the data connection 428 between the single-photon transmission device 401 of the car 802 and the single-photon receiving device 601 of the position column. Once the data link is established, the car exchanges a QKD key with the charging station as described hereinabove. The charging station and the car can then exchange encrypted authentication data and other data.

FIG. 11 shows an exemplary interaction between a software update unit 1114 and the car 802. The software update unit 1114 operates as what is referred to as a trusted server. The computer 1117 of the software update unit 1114 is connected to the server of an SW provider 1118 by means of a data transmission path 428, which can be wired or wireless. This server of the SW provider 1118 can, e.g., be a server of an automobile manufacturer. The data transmission path 428 to the server of the SW provider 1118 can run entirely or partially on the Internet. The computer 1117 of the software update unit 1114 exchanges a tap-proof QKD-generated key with the server of the SW provider 1118 by means of a QKD interface (e.g., a single-photon receiving device 601 and a single-photon transmission device 401).

The communication between the computer 1117 of the software update unit 1114 and the server of a SW provider 1118 is preferably encrypted via a data transmission path 428. Preferably, the computer 1117 of the software update unit 1114 and the server of a SW provider 1118 use the key generated by means of a QKD method for the encryption of this communication. The computer 1117 of the software update unit 1114 generates, by means of its single-photon transmission device 401 of the software update unit 1114 and the single-photon receiving device 601 of the car 802 using the QKD coupling beam 428 and a quantum key generation method, a key for encrypting the data transmitted between the microcontroller core 616 of the single-photon receiving device 601 of the car on the one hand and the computer 1117 of the software update device 1114. An optical fiber, which is preferably part of the data transmission cable 1115, preferably carries the single photons of the QKD coupling beam 452 from the single-photon transmission device 401 of the SW update unit 1114 to the single-photon receiving device 601 of the car 802. A data line, which is preferably part of the data transmission cable 1115, enables conventional data communication between the computer 1117 of the software update unit 1114 and the microcontroller core 616 of the single-photon receiving device 601 of the car 802. Typically, the computer 1117 of the SW update unit requests identification data via the QKD-encrypted data channel between the single-photon receiving device 601 of the car and the single-photon transmission device. The computer 1117 of the software update unit 1114 requests corresponding authentication data from the SW provider's server 1118 via the QKD-encrypted data channel based on the received identification data of the car 802. The server of the SW provider 1118 checks the identification data received. First, if the identification data is correct, the SW provider server 1118 provides suitable authentication data for accessing the relevant data memories of the car 802. Second, the SW provider server 1118 provides data that the SW update unit 114 intends to transmit to the car 802, and transmits it to memories of the software update unit 1114 computer 1117 using the QKD encrypted data transmission path 428. The computer 1117 of the software update unit 1114 authenticates itself via the data line 428 (which is also QKD-encrypted) between the computer 1117 of the software update unit 1114 and the single-photon transmission device 401 on the one hand and the microcontroller core 616 of the single-photon receiving device 601 of the car 802 on the other hand at the microcontroller core 616 of the single-photon receiving device 601 of the car 802 using the authentication data of the single-photon transmission device 601 received from the server of the SW provider 1118. The microcontroller 616 of the single-photon receiving device 601 verifies the authentication data thus obtained. If the verification result is positive, which means that the data corresponds to an expected value, the microcontroller core 616 of the single-photon receiving device 601 of the car 802 signals to the computer 1117 of the software update device 1114 that the data can be downloaded. Thereupon, the computer 1117 of the software update device 1114 transfers the data from its memory and/or from the software provider's server 1118 to a memory of the car 802. Some of the steps described herein can optionally also be performed by other computers of the car 802 and/or the software update device 1114. At the end of the download, one or a plurality of computers of the car can optionally perform further security checks. Once all security checks have been performed with positive results, computers of the car use all or part of the downloaded data. By unplugging the software update plug-in connector 1116 from the car 802, the data connection is interrupted and the download is terminated.

FIG. 12 shows a car 802 in which subdevices of the car generate a QKD key via a QKD system and use it for encrypted communication in a vehicle.

The proposed vehicle thereby comprises a single-photon waveguide for the QKD coupling beam 452. The single-photon waveguide is preferably a fiber optic cable. A first subdevice of the car, e.g. a first control unit of the car 802, comprises, e.g., a single-photon transmission device 401. A second subdevice of the car, for example a second control unit of the car 802, comprises, e.g., a single-photon receiving device 601. The single-photon waveguide ensures that the QKD coupling beam of the single photons of the single-photon transmission device 401 reaches the single-photon receiving device 601. A conventional databus enables conventional communication between single-photon transmission device 401 and single-photon receiving device 601. If the establishment of a common QKD key fails or the authentication of the single-photon transmission device 401 at the single-photon receiving device 601 fails or the authentication of the single-photon receiving device 601 at the single-photon transmission device 401 fails, then the single-photon transmission device 401 and/or the single-photon receiving device 601 preferably refuse to work and/or cooperate at least in part or completely. The systems optionally transition into an emergency mode.

FIG. 13 largely corresponds to the situation in FIG. 9 with the difference that instead of the car key, one car is now accessing another car. The first car (left) follows the car in front (right). The optical system of the single-photon transmission device 471 of the following car now preferably comprises an actuator for directing the laser pointer beam 462 to a predetermined point on the other car in front. Preferably, the single-photon detectors of the single-photon receiving device 601 of the preceding car are located at this point. Preferably, a camera detects the position of the predetermined point on the other car in front. An image recognition system recognizes this point and preferably supplies the control data for the alignment devices of the laser pointer beam. The single-photon receiving device 601 preferably also comprises an alignment device for aligning the QKD coupling beam of the single photons. The single-photon transmission device 471 of the following car preferably causes the laser pointer beam alignment means and the single-photon QKD coupling beam alignment means to direct the laser pointer beam and the QKD coupling beam to the predetermined point on the other preceding car using this control data. When the single-photon receiving device 601 of the preceding car signals to the single-photon transmission device 471 of the following car that the single-photon receiving device 601 of the preceding car is aligned with respect to the single-photon transmission device 471 of the following car, the single-photon transmission device 471 of the following car starts to agree on the QKD key. The other steps then proceed as described hereinabove. The single-photon receiving device 601 of the preceding car and the single-photon transmission device 471 of the following car are in this case not aligned with each other, but the beam path of the QKD single-photon beam is suitably deflected. Only when the laser pointer beam 462 of the laser pointer device 455 of the single-photon transmission device 401 hits the alignment receiver 699 of the single-photon receiving device 601, the microcontroller core 616 of the single-photon receiving device 601 signals via the conventional data transmission channel 428 of the single-photon transmission device 401 that the agreement of a QKD key can start as described in the description relating to FIG. 8. Thereupon, the single-photon transmission device 401 starts the agreement of a common secret QKD key. The two cars can then exchange encrypted data.

FIG. 14 schematically shows (in simplified form and not to scale), an exemplary SPAD diode 1820 for use as a sensor element of a single-photon detector in the context of the present application. The exemplary SPAD diode 1820 comprises exemplary one or a plurality of shallow trench isolation means (STI) 1821, one or a plurality of anode contacts 1822, one or a plurality of cathode contacts 1823, one or a plurality of cover oxides 1824 or one or a plurality of optically transparent insulating layers 1824, one or a plurality of highly doped first connector areas 1825 of a first line type, one or a plurality of first doped trays 1826 of a second line type, one or a plurality of second doped trays 1827 of a second line type, an epitaxial layer 1828 of a second line type, a base material 1829 of the semiconducting monocrystalline wafer, second doped tray 1830 of a second line type below the anode contact, one or a plurality of highly doped second connector areas 1831 of a second line type, one or a plurality of isolation means 1832, one or a plurality of metal optical filters 1833, one or a plurality of optically transparent slits 1834 in the metal optical filter 1833.

The cathode contact 1823 of the exemplary SPAD diode 1820 is preferably made of indium tin oxide (ITO) or another transparent and electrically conductive material. Using CMOS technology with a p-doped wafer material, the highly doped first connector area 1825 of a first line type can, e.g., be an n+-doped region in the semiconducting substrate material of the SPAD diode 1820. For example, with CMOS technology using a p-doped wafer material, the first doped tray 1826 of a second line type can be a p⁻-doped region in the semiconducting substrate material of the SPAD diode 1820. Using CMOS technology with a p-doped wafer material, the second doped tray 1827 of a second line type can, e.g., be a p−-doped region in the semiconducting substrate material of the SPAD diode 1820. For example, using CMOS technology with a p-doped wafer material, the epitaxial layer 1828 of a second line type can be a p-doped epitaxial layer in the semiconducting substrate material of the SPAD diode 1820. The base material 1829 of the semiconducting monocrystalline wafer typically has a second line type. Using CMOS technology with a p-doped wafer material, the base material 1829 of the semiconducting monocrystalline wafer is, e.g., a p-doped monocrystalline semiconductor wafer. Using CMOS technology with a p-doped wafer material, the second doped tray 1830 of a second line type below the anode contact can, e.g., be a p−-doped region in the semiconducting substrate material of the SPAD diode 1820. Using CMOS technology with a p-doped wafer material, the highly doped second connector area 1831 of a second line type can, e.g., be a p+ doped region in the semiconducting substrate material of the SPAD diode 1820. The isolation means 1832 can, e.g., be an oxide or the like. The metal-optical filter 1833 preferably covers the SPAD diode 1820 to such an extent that no more light from the sides can hit the SPAD diode 1820. Preferably, the light reaches the SPAD diode 1820 from above. The incident light 1835 must then pass through the slits 1834 in the metal layer 1833 of the metal-optical filter 1833. If the slits are narrow enough, this is only possible if the polarization direction of the E-field of the electromagnetic wave 1835 is oriented parallel to the slits 1834 in the x-direction. Only those parts of the electromagnetic wave 1835 that have this polarization direction therefore reach the PN connector of the SPAD diode. Preferably, a filter filters the electromagnetic wave 1835 before it strikes the metal-optical filter 1834 so that only light with a wavelength greater than a maximum wavelength reaches the metal-optical filter 1833. Preferably, the optical means is designed such that the electromagnetic wave 1835 strikes the metal-optical filter 1833 from a preferably always same direction, since the filtering properties of the metal-optical filter 1833 depend on the angle of incidence between the pointing vector of the electromagnetic wave 1835 and the normal vector of the plane of the metal-optical filter 1833. Preferably, this angle of incidence is 0°. The width of the optically transparent slits 1834 in the metal-optical filter 1833 determines the cut-off wavelength of the metal-optical filter. For electromagnetic radiation with wavelengths longer than the cut-off wavelength and an E-field vector perpendicular to the direction of the slits 1834, the metal-optical filter 1833 is non-transparent. In order to enable effective polarization, the electromagnetic wave 1835 should therefore be filtered by a filter such that it no longer has any radiation components with wavelengths shorter than the cut-off wavelength.

FIG. 14 shows a schematic illustration of an incident electromagnetic wave 1835. The electromagnetic wave 1835 can be the wave of a single photon.

FIG. 15A shows a metal-optical filter 1950 schematically simplified and not to scale with four metal-optical subfilters 1951, 1952, 1953, 1954 for a 2×2 SPAD diode array of four SPAD diodes with polarization filter effect of the metal-optical subfilters 1951, 1952, 1953, 1954 rotated in 45° steps in the top view. The SPAD diodes underneath are not shown. Reference character 1951 denotes, by way of example, a first metal-optical subfilter 1951 (schematically sketched to scale), with vertical polarization direction of the E-field for a first SPAD diode, which is typically arranged below the first metal-optical subfilter 1951. The vertical polarization direction of the E-field for a first SPAD diode corresponds in this case to a 0° polarization direction of the E-field for a first SPAD diode.

Reference character 1952 designates an exemplary second metal-optical subfilter 1952 (not schematically sketched to scale), with 45° polarization direction of the E-field for a second SPAD diode, which is typically arranged below the second metal-optical subfilter 1952 in the semiconductor substrate.

Reference character 1953 denotes an exemplary third metal-optical subfilter 1953 (schematically sketched to scale), with horizontal polarization direction of the E-field for a third SPAD diode, which is typically arranged below the third metal-optical subfilter 1953 in the semiconductor substrate. The horizontal polarization direction of the E-field for a third SPAD diode corresponds in this case to a 90° polarization direction of the E-field for a third SPAD diode.

Reference character 1954 denotes an exemplary fourth metal-optical subfilter 1954 (schematically sketched to scale), with vertical polarization direction of the E-field for a fourth SPAD diode, which is typically arranged below the fourth metal-optical subfilter 1954 in the semiconductor substrate.

FIG. 15B shows another exemplary metal-optical filter 1955 schematically simplified and not to scale with sixteen metal-optical subfilters for a 4×4 SPAD diode array of sixteen SPAD diodes with the polarization filter effect of the metal-optical subfilters rotated in 45° steps in the top view. The metal-optical filters are scrambled in the case of the further exemplary metal-optical filter 1955.

FIG. 16 corresponds to FIG. 5 with the difference that 1411 is replaced by 1603. FIG. 16 thus represents a single-photon receiving device 2417.

FIG. 17 corresponds to FIG. 6 with the difference that the 1603 is replaced by the 1411. FIG. 16 thus represents a single-photon transmission device 2601.

FIG. 18 corresponds to FIG. 5 with the difference that the 1411 is replaced by the 1603. In addition, the laser pointer transmitter (456, 457, 455) is replaced by the laser pointer receiver (1606, 699). FIG. 18 thus represents a single-photon receiving device 3417.

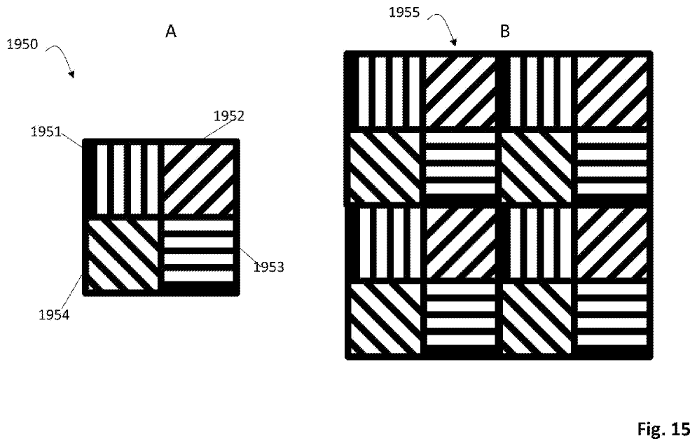

FIG. 19 corresponds to FIG. 6 with the difference that the 1603 is replaced by the 1411. In addition, the laser pointer receiver (1606, 699) is replaced by the laser pointer transmitter (456, 457, 455). FIG. 19 thus represents a single-photon transmission device 3601.

FIG. 20 corresponds to FIG. 9, whereby the single-photon transmission device 2601 or 3601 is now located in the vehicle 802 and the single-photon receiving device 2471 or 3471 is now located in the car key.

The description hereinabove is not exhaustive and does not limit this disclosure to the examples disclosed. Other variations of the disclosed examples can be understood from the drawings, the disclosure, and the claims and implemented by those having customary technical knowledge in the art. The indefinite article “a” or “an” and its inflections do not exclude a plurality, whereas the mention of a definite number of elements does not exclude the possibility that more or fewer elements are present. A single unit can perform the functions of several elements specified in the disclosure, and conversely, several elements can perform the function of one unit. Numerous alternatives, equivalents, variations, and combinations are possible without departing from the scope of the present disclosure.

Unless otherwise stated, all features of the present invention can be freely combined with one another. This relates to the entire application presented herein. The features described in the description of the drawings can also be freely combined as features of the invention with the remaining features, unless otherwise specified. A restriction of individual features of the exemplary embodiments to the combination with other features of the exemplary embodiments is expressly not provided. In addition, the device features presented herein can also be reworded and be used as method features, and the method features can also be reworded and be used as the device features presented herein. Such rewording is therefore automatically also disclosed. In the above detailed description, reference is made to the accompanying drawings. The examples in the specification and drawings should be considered as illustrative and should not be considered as limiting to the specific example or element described. Multiple examples can be derived from the description hereinabove, and/or the drawings, and/or the claims by altering, combining, or varying specific elements. Moreover, examples or elements not described verbatim can be derived from the description and/or drawings by a skilled person.

### LIST OF REFERENCE CHARACTERS

100 Single-photon receiving device for a polarization-modulated single-photon beam
102 Polarization direction modulated stream of the single photons
149 Second signal path
150 First signal path
152 Receive path
163 Non-polarizing first beam splitter
176 Second single-photon detector
177 First single-photon detector
178 Fourth single-photon detector
179 Third single-photon detector
184 Second polarizing beam splitter
187 Second signal path
188 λ/4 plate
189 Rotated second signal path
190 Third polarizing beam splitter
201 Single-photon transmission device
236 First single-photon source
237 Second single-photon source
238 Third single-photon source
239 Fourth single-photon source
283 First beam splitter
284 Second beam splitter
288 λ/4 plate
290 Third beam splitter
336 First single-photon source
337 Second single-photon source
338 Third single-photon source
339 Fourth single-photon source
344 First pinhole
345 Second pinhole
401 Single-photon transmission device
402 Internal databus
403 Read/write memory RAM
404 Writable non-volatile memory
405 Non-volatile, read-only memory, such as a ROM
406 Non-volatile, writable and/or non-writable manufacturer memory
407 Cryptography accelerator
408 Manufacturer memory firewall
411 CRC module (Cyclic Redundancy Check)
412 Clock driver module (CLK)
413 Timer module
414 Security monitoring and security control circuit
415 Quantum process-based generator for real random numbers (quantum random number generator, QRNG)
416 Microcontroller core
417 Data interface, in particular one or multiple Universal Asynchronous Receiver Transmitters (UART) for supporting high-speed serial data
421 Base clock driver (CLK)
422 Reset circuit
423 Power supply or Vcc circuit comprising a voltage regulator
424 Ground circuit
425 Input/output circuit
426 Wireless and/or wired data interface
427 Respective connector for the wired or wireless data transmission path, e.g. connector for the respective antenna of a respective wireless interface 426
428 Data transmission channel
429 Actuating device for the single-photon sources 436, 437, 438, 439, 440
430 Control line, using which the actuating device 429 for the single-photon sources 436, 437, 438, 439, 440 controls an adjustable voltage regulator 442
431 First control line for the first power source 463 of the first single-photon source 436
432 Second control line for the second power source 463 of the second single-photon source 437
433 Third control line for the third power source 463 of the third single-photon source 438
434 Fourth control line for the fourth power source 462 of the fourth single-photon source 439
435 Fifth control line for the fifth power source 463 of the fifth single-photon source 440, which controls the polarized fifth light source 464 of the fifth single-photon source 440
436 First single-photon source
437 Second single-photon source (The second single-photon source comprises a polarized second light source 464 and a second power source 463)
438 Third single-photon source (The third single-photon source typically comprises a polarized third light source 464 and a third power source 463)
439 Fourth single-photon source (The fourth single-photon source comprises a polarized fourth light source 464 and a fourth power source 463)
440 Fifth single-photon source. (The fifth single-photon source comprises a polarized fifth light source 464 and a fifth power source 463)
441 Supply voltage line of the single-photon sources 436 to 440
442 Power supply for the single-photon sources 436 to 440
443 Supply voltage line
444 First pinhole
445 Second pinhole
446 First lens
447 Second lens
448 First beam splitter of the transmission path
449 Beam path of the transmitter to the first beam splitter or mirror 448
450 Transmitter beam path from the first beam splitter or mirror 448 to the photodetector 451
451 Photodetector 451
452 QKD coupling beam
453 Receive signal of the photodetector 451
454 Evaluation circuit of the photodetector 451
455 Laser pointer device
456 Power supply for the laser pointer laser diode 459
457 Control device for the power source 460 of the laser pointer diode 459
459 Laser pointer diode
460 Power source of the laser pointer diode 459
461 Projection optical means of the laser pointer device
462 Laser pointer beam for alignment of the single-photon transmission device 401, 471, e.g. a car key
463 Power source of the single-photon source of the single-photon sources 436 to 440
464 Light source of the single-photon source of the single-photon sources 436 to 440
465 HMI interface (HMI=Human Machine Interface)
466 Input terminal
467 Buttons, switches, or other mechanical input units
468 Biometric sensor
469 Optical output element, e.g. one or a plurality of light sources or a screen for signaling to a user
470 Actuator, e.g. an electromechanical vibrator
471 Single-photon transmission device
601 Single-photon receiving device, in particular for a car
602 Internal databus
603 Read/write memory RAM
604 Writable non-volatile memory
605 Non-volatile read-only memory
606 Non-volatile, writable and/or non-writable manufacturer memory
607 Cryptography accelerator
608 Manufacturer memory firewall
611 CRC module (Cyclic Redundancy Check)
612 Clock driver module (CLK)
613 Timer module
614 Security monitoring and security control circuit
615 Quantum process-based generator for real random numbers (quantum random number generator, QRNG)
616 Microcontroller core
617 Data interface, in particular one or multiple Universal Asynchronous Receiver Transmitters (UART) for supporting high-speed serial data
621 Base clock driver (CLK)
622 Reset circuit
623 Power supply or Vcc circuit comprising a voltage regulator
624 Ground circuit
625 Input/output circuit
626 Wireless and/or wired data interface
627 Respective antenna of the respective wireless interface 626
643 Supply voltage line
672 Evaluation circuit for the receive signals 673 to 676 of the single-photon detectors 677 to 680 for differently polarized single photons
673 First receive signal of the first single-photon detector 677 for horizontally polarized single photons
674 Second receive signal of the second single-photon detector 678 for vertically polarized single photons
675 Third receive signal of the third single-photon detector 679 for +45° polarized single photons
676 Fourth receive signal of the fourth single-photon detector 680 for −45° polarized single photons
677 First single-photon detector for horizontally polarized single photons, e.g. a first SPAD diode
678 Second single-photon detector for vertically polarized single photons 678, e.g. a second SPAD diode
679 Third single-photon detector for +45° polarized single photons, e.g. a third SPAD diode
680 Fourth single-photon detector for −45° polarized single photons, e.g. a fourth SPAD diode
681 Receiving optical means for the QKD coupling beam 452
682 Beam path for the single photons of the QKD coupling beam 452 between the receiving optical means for the QKD coupling beam 452 and the non-polarizing beam splitter 683
683 Non-polarizing beam splitter 683
684 Second polarizing beam splitter
685 Third horizontally polarized single-photon stream
686 Fourth vertically polarized single-photon stream
687 Second single-photon stream
688 λ/4 plate and/or polarization rotation device
689 Rotated second single-photon stream
690 Third polarizing beam splitter
691 Sixth −45° polarized single-photon stream
692 Controller for driving the exemplary locking device 694
693 Control line for driving the exemplary locking device 694
694 Exemplary locking device 694 of the motor vehicle 802
695 Data interface to a superordinate computer unit 697 via a databus 696 of the car 802
696 Data connection from the data interface 695 of the single-photon receiving device to a superordinate computer unit 697 via a databus 696 of the car 802
697 Superordinate computer unit
698 Alignment receiver line
699 Alignment receiver
701 Exemplary integrated circuit for use in automotive QKD systems
702 Internal databus of the integrated QKD circuit 701
703 Read/write memory RAM 703 of the integrated QKD circuit 701
704 Writable non-volatile memory of the integrated QKD circuit 701
705 Non-volatile, read-only memory of the integrated QKD circuit 701, such as a ROM
706 Non-volatile, writable, and/or non-writable manufacturer memory of the integrated QKD circuit 701
707 Cryptography accelerator of the integrated QKD circuit 701, e.g. a DES accelerator and/or an AES accelerator 707
708 Manufacturer memory firewall of the integrated QKD circuit 701
711 CRC module (Cyclic Redundancy Check) of the integrated QKD circuit 701
712 Clock driver module (CLK) of the integrated QKD circuit 701
713 Timer module of the integrated QKD circuit 701
714 Security monitoring and security control circuit of the integrated QKD circuit 701
715 Quantum random number generator (QRNG) of the integrated QKD circuit 701
716 Microcontroller core of the integrated QKD circuit 701
717 Data interface, in particular one or multiple Universal Asynchronous Receiver Transmitters (UART) for supporting high-speed serial data
721 Base clock driver (CLK) of the integrated QKD circuit 701
722 Reset circuit of the integrated QKD circuit 701
723 Power supply or Vcc circuit of the integrated QKD circuit 701 comprising voltage regulators
724 Ground circuit of the integrated QKD circuit 701
725 Input/output circuit of the integrated QKD circuit 701
726 Data transmission channel of the integrated QKD circuit 701
727 Respective connector for the wired or wireless data transmission path, e.g. connector for the respective antenna of a respective wireless interface 726
729 Actuating device for the single-photon sources 736, 737, 738, 739 of the integrated QKD circuit 701
730 Control line of the integrated QKD circuit 701, using which the actuating device 729 for the single-photon sources 736, 737, 478, 479 controls an adjustable voltage regulator 742
731 First integrated QKD circuit control line for the first power source 763 of the first single-photon source 736 of the integrated QKD circuit, which controls the polarized first light source 764 of the first single-photon source 736 of the integrated QKD circuit, whereby the first control line 731 optionally also reports status data of the first single-photon source 736 of the integrated QKD circuit back to the microcontroller core 716 of the integrated QKD circuit via the actuating device 729 of the integrated QKD circuit for the single-photon sources 736, 737, 738, 739 of the integrated QKD circuit
732 Second control line of the integrated QKD circuit for the second power source 763 of the second single-photon source 737 of the integrated QKD circuit, which controls the polarized second light source 764 of the second single-photon source 737 of the integrated QKD circuit, whereby the second control line 732 optionally also reports status data of the second single-photon source 737 of the integrated QKD circuit back to the microcontroller core 716 of the integrated QKD circuit via the actuating device 729 of the integrated QKD circuit for the single-photon sources 736, 737, 738, 739 of the integrated QKD circuit
733 Third control line of the integrated QKD circuit for the third power source 764 of the third single-photon source 738 of the integrated QKD circuit, which controls the polarized third light source 764 of the third single-photon source 738 of the integrated QKD circuit, whereby the third control line 733 optionally also reports status data of the third single-photon source 738 of the integrated QKD circuit back to the microcontroller core 716 of the integrated QKD circuit via the actuating device 729 of the integrated QKD circuit for the single-photon sources 736, 737, 738, 739 of the integrated QKD circuit
734 Fourth control line of the integrated QKD circuit for the fourth power source 763 of the fourth single-photon source 739 of the integrated QKD circuit, which controls the polarized fourth light source 764 of the fourth single-photon source 739 of the integrated QKD circuit, whereby the fourth control line 734 optionally also reports status data of the fourth single-photon source 739 of the integrated QKD circuit back to the microcontroller core 716 of the integrated QKD circuit via the actuating device 729 of the integrated QKD circuit for the single-photon sources 736, 737, 738, 739 of the integrated QKD circuit
736 First single-photon source of the integrated QKD circuit 701
737 Second single-photon source of the integrated QKD circuit 701
738 Third single-photon source 738 of the integrated QKD circuit 701
739 Fourth single-photon source of the integrated QKD circuit 701
741 Supply voltage line of the single-photon sources 736 to 739
742 Power supply for the exemplary four single-photon sources 736 to 739 of the integrated QKD circuit 701
743 Supply voltage line
751 Photodetector of the integrated QKD circuit 701
753 Receive signal of the photodetector 751 of the integrated QKD circuit 701
754 Evaluation circuit of the photodetector 751 of the integrated QKD circuit 701
756 Power supply for the laser pointer laser diode 459
757 Control device for the power source 760 of the laser pointer diode 459
760 Power source of the laser pointer diode 459
763 Respective light source for the respective single-photon source of the exemplary four single-photon sources 736 to 739
764 Respective power source of the respective single-photon source of the exemplary four single-photon sources 736 to 739 of the integrated QKD circuit 701
772 Evaluation circuit for the receive signals 773 to 776 of the single-photon detectors 777 to 780 for differently polarized single photons. The evaluation circuit receives measured values in the form of signalizations of the single-photon detectors 777 to 780 for differently polarized single photons via said receive signals 773 to 776. The evaluation circuit processes these measured values and makes the result of this processing available to the microcontroller core 716 via the internal databus 702.
773 First receive signal of the first single-photon detector 777 for horizontally polarized single photons
774 Second receive signal of the second single-photon detector 778 for vertically polarized single photons
775 Third receive signal of the third single-photon detector 779 for +45° polarized single photons
776 Fourth receive signal of the fourth single-photon detector 780 for −45° polarized single photons
777 First single-photon detector for horizontally polarized single photons, e.g. a first SPAD diode
778 Second single-photon detector for vertically polarized single photons, e.g. a second SPAD diode
779 Third single-photon detector for +45° polarized single photons, e.g. a third SPAD diode
780 Fourth single-photon detector for −45° polarized single photons, e.g. a fourth SPAD diode
792 Controller for driving the exemplary locking device 694
793 Control line for driving the exemplary locking device 694
795 Data interface to a superordinate computer unit 697 via a databus 696 of the car 802 or another device in which the integrated QKD circuit 701 is used
798 Alignment receiver line
801 Situation when agreeing a QKD key between a car key and a car 802
802 Car
803 Optical window for the QKD coupling beam 452 in the body of the car 802
804 Car door 802
1011 Charging station
1012 Charging cable
1013 Charging connector
1114 Software update unit
1115 Data transmission cable
1116 Software update plug-in connection
1117 Computer of the software update unit 1114
1118 Server of the SW provider
1301 Conical mirror
1302 Spatial filter
1407 Single-photon transmission device of the car key 401, 471
1408 Conical mirror or functionally equivalent device for combining the single-photon streams of the single-photon sources 436 to 440 into a single single-photon stream
1409 Identification means for identifying the user
1410 Single-photon beams of the single-photon sources 436 to 440
1411 Receiver module for polarization-modulated single photons;
1601 Receiver of the alignment receiver 699
1603 Single-photon detector system for receiving a polarization-modulated single-photon signal
1604 First single-photon stream
1605 Fifth +45° polarized single-photon stream
1606 Interface of the alignment receiver 699
1701 Receiver of the alignment receiver 699
1703 Single-photon detector system for receiving a polarization-modulated single-photon signal
1706 Interface of the alignment receiver 699
1707 Single-photon transmission device of the QKD circuit 701, e.g. of the car key 401, 471
1820 Exemplary SPAD diode for use as a sensor element of a single-photon detector
1821 Shallow trench isolation means (STI) of the exemplary SPAD diode 1820
1822 Anode contact of the exemplary SPAD diode 1820
1823 Cathode contact of the exemplary SPAD diode 1820
1824 Cover oxide or optically transparent insulating layer of the exemplary SPAD diode 1820
1825 Highly doped first connector area of a first line type
1826 First doped tray of a second line type
1827 Second doped tray of a second line type
1828 Epitaxial layer of a second line type
1829 Base material of semiconducting monocrystalline wafer comprising a second line type
1830 Second doped tray of a second line type below the anode contact
1831 Highly doped second connector area of a second line type
1832 Isolation means, e.g. an oxide or the like
1833 Metal-optical filter
1834 Optically transparent slits in the metal-optical filter 1833
1835 Incident electromagnetic wave
1950 Metal-optical filter with four metal-optical subfilters 1951, 1952, 1953, 1954 for a 2×2 SPAD diode array of four SPAD diodes with polarization filter effect of the metal-optical subfilters 1951, 1952, 1953, 1954 rotated in 45° steps
1951 First metal-optical subfilter with vertical polarization direction of the E-field for a first SPAD diode, which is typically arranged below the first metal-optical subfilter 1951
1952 Second metal-optical subfilter with 45° polarization direction of the E-field for a second SPAD diode, which is typically arranged under the second metal-optical subfilter 1952 in the semiconductor substrate
1953 Third metal-optical subfilter with horizontal polarization direction of the E-field for a third SPAD diode, which is typically arranged under the third metal-optical subfilter 1953 in the semiconductor substrate
1954 Fourth metal-optical subfilter with vertical polarization direction of the E-field for a fourth SPAD diode, which is typically arranged under the fourth metal-optical subfilter 1954 in the semiconductor substrate
1955 Further exemplary metal-optical filter

1. A single-photon transmission device (401, 471) for enabling secure authentication, comprising:
a plurality of single-photon sources (436-440),
a control device which is configured to separately actuate one of the single-photon sources (436-440) at a time, and
an optical subdevice which is configured to combine single-photon streams of photons emitted by the at least one single-photon source (436-440) to form a QKD coupling beam (452) consisting of a common stream of single photons,
characterized in that the single-photon transmission device (401, 471) further comprises:
an actuating device (429) for the single-photon sources (436-440), which single-photon sources (436-440) each comprise an light source (464) and a power source (463), wherein the light source (464) emits polarized single photons or single photons of different polarization, which are polarized by means of polarization filters or polarizing optical functional means in a subsequent beam path,
at least one databus (402),
at least one microcontroller core (416) which is configured to control the actuating device (429) via the internal databus (402),
at least one control line (430), which connects the actuating device (429) to an adjustable voltage regulator (442),
at least one energy supply (442) for the single-photon sources (436-440), wherein the energy supply (442) is configured to regulate an operating voltage of the single-photon sources (436-440), in particular by means of a linear regulator,
wherein the actuating device (429) is configured to adjust a voltage between a supply voltage line (441) of the single-photon sources (436-440) and a reference potential by means of the control line (430), and
wherein the power source (463) of each single-photon source (436-440) is configured to adjust a single-photon rate of the respective associated light source (464) depending on signaling of a control line (431-435) associated with the respective power source (463), in particular depending on control data for the single-photon sources (436-440) transmitted by the actuating device (429), and
thus a photon density of a light emission of the single-photon sources (436-440), and
wherein the actuating device (429) is configured to control an electric current through the respective power source (463) of the respective single-photon sources (436-440), and
wherein the single-photon sources (436-440) are configured to feed the respective single-photon streams into the QKD coupling beam (452) depending on the control by the actuating device (429).

2. The single-photon transmission device (401, 471) according to claim 1, characterized in that the single-photon transmission device (401, 471) comprises a plurality of databuses (402) and a plurality of microcontroller cores (416), wherein the plurality of microcontroller cores (416) can independently simultaneously access various subdevices of the single-photon transmission device (401, 471).

3. The single-photon transmission device (401, 471) according to one of claims 1 to 2, characterized in that the single-photon transmission device (401, 471) comprises a beam splitter or mirror (448) and a photodetector (451) for measurement and calibration of a photon rate, wherein the beam splitter or mirror (448) is configured to direct at least a part of the QKD coupling beam (452) onto the photodetector (451).

4. The single-photon transmission device (401, 471) according to claim 3, characterized in that the microcontroller core (416) is configured to determine a single-photon density in the QKD coupling beam (452) by means of the photodetector (451).

5. The single-photon transmission device (401, 471) according to one of claims 3 to 4, characterized in that the microcontroller core (416) is configured to insert the beam splitter or mirror (448) into the QKD coupling beam (452), in particular by means of an actuator, wherein the microcontroller core (416) controls the actuator via the internal databus (402).

6. The single-photon transmission device (401, 471) according to one of claims 3 to 5, characterized in that
the microcontroller core (416) is configured to separately receive one of the single-photon sources
(436-440) and to detect a single-photon density associated with this single-photon source (436-440).

7. The single-photon transmission device (401, 471) according to one of claims 3 to 5, characterized in that
the microcontroller core (416) is configured to calibrate the single-photon densities of the various single-photon sources (436-440) by the microcontroller core (416) recontrolling the power sources (463) of the respective single-photon sources (436-440) such that
the single-photon density of the respective single-photon sources (436-440) detected by the photodetector (451) is within a provided single-photon density range value interval, and/or
the single-photon density of the respective single-photon source (436-440) detected by the photodetector (451) differs from the single-photon density of another of the single-photon sources (436-440) by not more than 10%, better 5%, better 2%, better 1%, better 0.5%, better 0.2%, better 0.1%, better 0.05%, better 0.02%, better 0.01%.

8. The single-photon transmission device (401, 471) according to one of claims 3 to 7, characterized in that
the microcontroller core (416) is configured to remove the beam splitter or mirror (448) from the QKD coupling beam (452), in particular by means of an actuator, wherein the microcontroller core (416) controls the actuator via the internal databus (402) after the calibration of the single-photon densities of the various single-photon sources (436-440) has been completed.

9. The single-photon transmission device (401, 471) according to one of the preceding claims, characterized in that
the subdevice comprises:
a conical mirror (1408) and
a spatial filter (1302), in particular comprising a first pinhole (344) and a second pinhole (345), wherein
the conical mirror (1408) is configured to direct single photons emitted by the single-photon sources (436-440) in a common beam direction and to thus combine them into a common stream of single photons, the QKD coupling beam (452).

10. The single-photon transmission device (401, 471) according to one of the preceding claims, characterized in that
the subdevice comprises:
at least one λ/4 plate (288) which is configured to rotate photons emitted from the plurality of single-photon sources (238) by 45°,
at least one beam splitter (290), and
a control device, wherein
the at least one beam splitter (290) is configured to combine photons emitted by the at least one single-photon sources (436-440) into a common stream of single photons, the QKD coupling beam (452).

11. The single-photon transmission device (401, 471) according to one of the preceding claims, comprising:
at least one read/write memory (403),
at least one non-writable volatile memory (404), and
at least one read-only memory (405), wherein
the microcontroller core (416) is configured to process program code and/or program data contained on the at least one read/write memory (403) and/or on the at least one read-only memory (405), the single-photon transmission device (401, 471) in particular comprising an access logic for this purpose, the microcontroller core (416) in particular being configured to access the at least one read/write memory (403) by means of the internal databus (402), the microcontroller core (416) in particular being configured to access the at least one non-writable volatile memory (404) by means of the internal databus (402).

12. The single-photon transmission device (401, 471) according to one of the preceding claims, comprising at least one non-volatile manufacturer memory (406) which is designed to be writable and/or non-writable, the non-volatile manufacturer memory (406) in particular comprising boot software for the microcontroller core (416).

13. The single-photon transmission device (401, 471) according to one of the preceding claims, comprising at least one cryptography accelerator (407), the at least one cryptography accelerator (407) in particular being connected to the microcontroller core (416) via the internal databus (402).

14. The single-photon transmission device (401, 471) according to one of the preceding claims, comprising at least one manufacturer memory firewall (408) which is configured to prevent unauthorized access to the manufacturer memory (406) and to allow such access only after a corresponding authentication, the at least one manufacturer memory firewall (408) in particular being provided between the manufacturer memory (406) and the internal databus (402).

15. The single-photon transmission device (401, 471) according to one of the preceding claims, comprising at least one cyclic redundancy check (CRC) module (411) which is configured to calculate a CRC check data word for a specified amount of data.

16. The single-photon transmission device (401, 471) according to one of the preceding claims, comprising at least one clock driver module (412) which is configured to provide system clocks for operating individual device components of the single-photon transmission device (401).

17. The single-photon transmission device (401, 471) according to one of the preceding claims, comprising at least one timer module (413) which is configured to control temporal sequences within the single-photon transmission device (401).

18. The single-photon transmission device (401, 471) according to one of the preceding claims, comprising at least one security monitoring and security control circuit (414) which is configured to monitor integrity of the single-photon transmission device (401) and to optionally initiate countermeasures in the event of an attack, the at least one security monitoring and security control circuit (414) in particular being configured to detect an attack and to optionally block the single-photon transmission device (401) from access to storage contents of the memories (403, 404, 405) for a preferably predetermined period of time and/or to delete contents of the memories (403, 404, 405) in whole or in part, and/or to set contents of the memories (403, 404, 405) to predefined values, and/or to overwrite them with nonsensical data, and/or to otherwise manipulate them.

19. The single-photon transmission device (401, 471) according to one of the preceding claims, comprising at least one quantum process-based generator (415) which is configured to generate true random numbers.

20. The single-photon transmission device (401, 471) according to one of the preceding claims, comprising at least one data interface (417).

21. The single-photon transmission device (401, 471) according to one of the preceding claims, comprising at least one base clock driver (421) which is configured to provide a base clock to the at least one clock driver module.

22. The single-photon transmission device (401, 471) according to one of the preceding claims, comprising at least one reset circuit (422) which is configured to set the single-photon transmission device (401) and/or subdevices of the single-photon transmission device (401) to a predefined state when predetermined or determinable reset conditions, and/or combinations, and/or time sequences of such reset conditions are present.

23. The single-photon transmission device (401, 471) according to one of the preceding claims, comprising at least one power supply or VCC circuit (423) comprising voltage regulators, which power supply or VCC circuit (423) being configured to provide an operating voltage.

24. The single-photon transmission device (401, 471) according to one of the preceding claims, comprising at least one ground circuit (424) which is configured to protect the single-photon transmission device (401) against polarity reversal and attacks via a ground line.

25. The single-photon transmission device (401, 471) according to one of the preceding claims, comprising at least one input/output circuit (425) which is configured to enable the single-photon transmission device (401, 471) to actuate, read out, or otherwise communicate with further devices.

26. The single-photon transmission device (401, 471) according to one of the preceding claims, comprising at least one processing module which is configured to communicate with the microcontroller core (416) via the internal databus (402), the at least one processing module in particular comprising the at least one CRC module (411), and/or the at least one cryptography accelerator (407), and/or the at least one clock driver module (412), and/or the at least one timer module (413), and/or the
at least one security monitoring and security control circuit (414), and/or the at least one quantum process-based generator (415), and/or the at least one microcontroller core (416), and/or the at least one data interface (417).

27. The single-photon transmission device (401, 471) according to one of the preceding claims, comprising at least one watchdog timer which is configured to monitor processing of various program components by the at least one microcontroller core (416), the at least one watchdog timer in particular being integrated into the at least one security monitoring and security control circuit (414).

28. The single-photon transmission device (401, 471) according to one of the preceding claims, characterized in that
the single-photon transmission device (401, 471) is configured to receive further data in addition to an authentication code, for example one or a plurality of lifetime and usage data, and/or logistical data, and/or commercial data, and/or website and email addresses, and/or image data, and/or a set of instructions for control units of a car (802), using which the microcontroller core (416) of the single-photon transmission device (401, 471) communicates via the at least one data interface (417) of the single-photon transmission device (401, 471), and/or further application data.

29. The single-photon transmission device (401, 471) according to one of claims 23 to 28, characterized in that
one or a plurality of the at least one ground circuit (424) and/or one or a plurality of the at least one power supply or VCC circuit (423) are configured to cooperate such that a modulation of a power consumption, and/or a internal resistance, and/or a voltage drop between supply voltage terminals of the single-photon transmission device (401, 471) at least temporarily does not allow conclusions to be drawn about an operating sequence and/or a state of the single-photon transmission device (401, 471).

30. The single-photon transmission device (401, 471) according to one of the preceding claims, characterized in that
the single-photon transmission device (401, 471) comprises an analog-to-digital converter,
which is configured to enable the microcontroller core (416) to monitor internal analog values, such as an operating voltage and external analog values.

31. The single-photon transmission device (401, 471) according to one of claims 19 to 30, characterized in that
the at least one quantum process-based generator (415) is configured to generate one or a plurality of random numbers, in particular on request by the at least one microcontroller core (416).

32. The single-photon transmission device (401, 471) according to one of the preceding claims, characterized in that
the at least one microcontroller core (416) is configured to generate one or a plurality of keys by means of a respective program from one or a plurality of its memory elements and by means of one or plurality of the generated random numbers.

33. The single-photon transmission device (401, 471) according to claim 32, characterized in that the at least one microcontroller core (416) is configured to encrypt and/or decrypt data with the aid of a respective program of the related microcontroller core (416) and with the aid of a respective key of the generated keys, which data is typically exchanged by the at least one microcontroller core (416) via the at least one data interface (417) of the single-photon transmission device (401, 471) with devices outside the single-photon transmission device (401, 471).

34. The single-photon transmission device (401, 471) according to one of the preceding claims, characterized in that the single-photon transmission device (401, 471) comprises at least one wireless data interface (426) for communication with another computer system, in particular via a respective antenna (427) of the at least one wireless data interface (426), wherein the respective antenna (427) is configured to emit an electromagnetic signal (428) which the single-photon transmission device (401, 471) exchanges with a single-photon receiving device (601) in a wired or wireless manner.

35. The single-photon transmission device (401, 471) according to one of the preceding claims, characterized in that
the single-photon transmission device (401, 471) is a mobile unit, in particular a cell phone, a smartphone, a laptop, a tablet PC, a key, a vehicle key, a security key for a weapon or other military device, a key for activating and/or controlling an aircraft, watercraft, or projectile, an access key to a secured area, a vault, or a safe, an activation key for a secured mechanism, an activation key for a protected procedure to, for example, execute a secured device, or an activation key for a protected device to, for example, execute a secured procedure.

36. The single-photon transmission device (401, 471) according to one of the preceding claims, characterized in that
the single-photon transmission device (401, 471) comprises at least one biometric sensor (468).

37. The single-photon transmission device (401, 471) according to one of the preceding claims, characterized in that
the single-photon transmission device (401, 471) comprises at least one means (1409) for identifying a person using the single-photon transmission device (401, 471).

38. The single-photon transmission device (401, 471) according to one of the preceding claims, characterized in that
the single-photon transmission device (401, 471) comprises alignment means (456, 457, 460, 455, 459, 461), in particular a laser pointer diode (459), for aligning the single-photon transmission device (401, 471) with respect to a single-photon receiving device (601).

39. The single-photon receiving device (601) for receiving a QKD coupling beam (452) transmitted from a single-photon transmission device (401, 471) according to one of the preceding claims, wherein
the single-photon receiver (601) comprises:
a single-photon detector system (1603) which is configured to receive a polarization-modulated single photon signal, wherein
the single-photon detector system (1603) comprises at least one single-photon detector (677-680), wherein
the at least one single-photon detector (677-680) is configured to detect the QKD coupling beam (452) of the single-photon transmission device (401, 471), and
at least one microcontroller core (616) and
at least one internal databus (602).

40. The single-photon receiving device (601) according to claim 39, characterized in that the microcontroller core (616) is configured to handle internal data communication via the internal databus (602).

41. The single-photon receiving device (601) according to one of claims 39 to 40, characterized in that
the single-photon receiving device (601) comprises at least one read/write memory RAM (603) for storing and for providing and using data and program instructions by the microcontroller core (616).

42. The single-photon receiving device (601) according to one of claims 39 to 41, characterized in that
the single-photon receiving device (601) comprises at least one writable non-volatile memory (604).

43. The single-photon receiving device (601) according to one of claims 39 to 42, characterized in that
the single-photon receiving device (601) comprises at least one non-volatile read-only memory (605).

44. The single-photon receiving device (601) according to one of claims 42 to 43, characterized in that
the microcontroller core (616) is configured to process program code and program data stored on the writable non-volatile memory (604) and/or on the non-volatile read-only memory (605).

45. The single-photon receiving device (601) according to one of claims 39 to 44, characterized in that
the single-photon receiving device (601) comprises at least one non-volatile, writable and/or non-writable manufacturer memory (606).

46. The single-photon receiving device (601) according to one of claims, 39 to 45, characterized in that
the single-photon receiving device (601) comprises at least one cryptography accelerator (607).

47. The single-photon receiving device (601) according to one of claims 39 to 46, characterized in that
the single-photon receiving device (601) comprises at least one manufacturer memory firewall (608) which is configured to prevent unauthorized access to a manufacturer memory (606) and to allow such access only after appropriate authentication, for example by means of a password.

48. The single-photon receiving device (601) according to one of claims 39 to 47, characterized in that
the single-photon receiving device (601) comprises at least one cyclic redundancy check (CRC) module (611).

49. The single-photon receiving device (601) according to one of claims 39 to 48, characterized in that
the single-photon receiving device (601) comprises at least one clock driver module (612).

50. The single-photon receiving device (601) according to one of claims 39 to 49, characterized in that
the single-photon receiving device (601) comprises at least one timer module (613) which is configured to control temporal sequences within the single-photon receiving device (601).

51. The single-photon receiving device (601) according to one of claims 39 to 50, characterized in that
the single-photon receiving device (601) comprises at least one security monitoring and security control circuit (614) which is configured to monitor an integrity of the single-photon receiving device (601) and optionally initiate countermeasures in the event of an attack.

52. The single-photon receiving device (601) according to one of claims 39 to 51, characterized in that
the single-photon receiving device (601) comprises at least one quantum process-based generator for real random numbers (615).

53. The single-photon receiving device (601) according to one of claims 39 to 52, characterized in that
the single-photon receiving device (601) comprises at least one data interface (617) which is configured to perform data communication with other computer systems.

54. The single-photon receiving device (601) according to one of claims 39 to 53, characterized in that
the single-photon receiving device (601) comprises at least one base clock driver (621).

55. The single-photon receiving device (601) according to one of claims 39 to 54, characterized in that
the single-photon receiving device (601) comprises at least one reset circuit (622).

56. The single-photon receiving device (601) according to one of claims 39 to 55, characterized in that
the single-photon receiving device (601) comprises at least one power supply or Vcc circuit (623) comprising a voltage regulator, wherein the power supply or Vcc circuit (623) is configured to provide an operating voltage for a microcontroller system of the single-photon receiving device (601) and other subdevices of the single-photon receiving device (601).

57. The single-photon receiving device (601) according to claim 56, characterized in that the power supply or Vcc circuit (623) comprises a charging circuit and a first charging coil for inductive coupling to a second charging coil.

58. The single-photon receiving device (601) according to one of claims 39 to 57, characterized in that
the single-photon receiving device (601) comprises at least one ground circuit (624) which is configured to protect the device against polarity reversal and attacks via the ground line.

59. The single-photon receiving device (601) according to one of claims 39 to 58, characterized in that
the single-photon receiving device (601) comprises at least one input/output circuit (625) which is configured to enable the single-photon receiving device (601) to actuate, read out, or otherwise communicate with further devices.

60. The single-photon receiving device (601) according to claim 55, characterized in that the reset circuit (622) comprises a watchdog timer.

61. The single-photon receiving device (601) according to one of claims 56 to 60, characterized in that
one or a plurality of the at least one ground circuit (624) and/or one or a plurality of the at least one power supply or Vcc circuit (623) are configured to cooperate such that
modulation of the power consumption and/or the internal resistance and/or the voltage drop between supply voltage terminals of the single-photon receiving device (601) at least temporarily does not allow conclusions to be drawn about operating sequences and/or states of the single-photon receiving device (601).

62. The single-photon receiving device (601) according to one of claims 39 to 61, characterized in that
one or a plurality of the at least one microcontroller core (616) are configured to generate one or a plurality of keys by means of a respective program from one or a plurality of their memory elements and with the aid of one or a plurality of generated random numbers, the at least one microcontroller core (616) in particular being configured to encrypt and/or decrypt data exchanged via one or a plurality of data interfaces of the single-photon receiving device (601) with devices outside the single-photon receiving device (601) with the aid of a respective program of the related microcontroller core (616) and with the aid of a respective key of the generated keys.

63. The single-photon receiving device (601) according to one of claims 39 to 62, characterized in that
the single-photon receiving device (601) comprises at least one wireless and/or at least one wired data interface (626), wherein
the wired data interface (626) is configured to exchange data between the single-photon receiving device (601) and the single-photon transmission device (401, 471) via a wired data channel by means of an electromagnetic data signal, and wherein
each wireless data interface (626) comprises at least one antenna (627).

64. The single-photon receiving device (601) according to one of claims 39 to 63, characterized in that
the single-photon receiving device (601) comprises an evaluation circuit (672).

65. The single-photon receiving device (601) according to one of claims 39 to 64, characterized in that
the single-photon detector system (1603) comprises:
at least one receiving channel for single photons,
optionally, at least one receiving optical means (681) which is configured to focus incoming single photons of the QKD coupling beam (452) onto the single-photon detectors (677-680),
at least one polarizing beam splitter (683, 684, 690), and
at least one λ/4 plate and/or polarization rotation device (688).

66. The single-photon receiving device (601) according to one of claims 39 to 65, characterized in that
the single-photon receiving device (601) comprises an alignment receiver (699) for aligning the single-photon transmission device (401, 471) with respect to the the single-photon receiving device (601), the alignment receiver (699) in particular being configured to detect a laser pointer beam (462) of the single-photon transmission device (401, 471).

67. The single-photon receiving device (601) according to claim 66, characterized in that the alignment receiver (699) comprises:
a receiver (1601), the receiver (1601) in particular being configured to detect the laser pointer beam (462),
an optical system (1602),
an interface (1606) which is configured to receive measurement data from the receiver (1601), the interface (1601) in particular being configured to signal to the microcontroller core (616) via the internal databus (602) whether the receiver (1601) is receiving sufficient light from the laser pointer beam (462) via the optical system (1602) to align the single-photon transmission device (401, 471).

68. The single-photon receiving device (601) according to claim 67, characterized in that the microcontroller core (616) is configured to start a generation of a common quantum key for the single-photon transmission device (401, 471) and the single-photon receiving device (601) according to signaling by the interface (1601).

69. A method for generating a common quantum key for a single-photon transmission device (401, 471) according to one of claims 1 to 38 and a single-photon receiving device (601) according to one of claims 39 to 68, characterized in that,
corresponding to signaling by an interface (1601) of the single-photon receiving device (601), a microcontroller core (616) of the single-photon receiving device (601) starts the generation of the common quantum key for the single-photon transmission device (401, 471) and the single-photon receiving device (601) by the microcontroller core (616) of the single-photon receiving device (601) signaling to a microcontroller core (416) of the single-photon transmission device (401, 471) that an agreement of a quantum key can start,
the microcontroller core (416) of the single-photon transmission device (401, 471) causing the single-photon transmission device (401, 471) to generate a polarization-modulated stream of single photons as a QKD coupling beam (452), in particular using a random number of its quantum process-based generator (415) of the single-photon transmission device (401, 471), and
the single-photon receiving device (601) receiving the polarization-modulated single-photon data stream of the QKD coupling beam (452) generated
by the single-photon transmission device (401, 471).

70. An integrated QKD circuit (701) comprising a single-photon transmission device (401, 471) according to one of claims 1 to 38 and/or a single-photon receiving device (601) according to one of claims 39 to 68.

71. A car key comprising a single-photon transmission device (401, 471) according to one of claims 1 to 38 and/or a single-photon receiving device (601) according to one of claims 39 to 68.

72. The car key according to claim 71, comprising:
a single-photon source (436-439),
a quantum process-based generator (415), and
an actuating device (429),
wherein the quantum process-based generator (415) is configured to provide one or a plurality of random numbers, and
wherein the actuating device (429) is configured to generate a polarization control signal depending on one or a plurality of the provided random numbers, and
wherein the single-photon sources (436-440) are configured to generate single photons, hereinafter referred to as single photons, with a polarization, wherein the polarization of the single photons depends on the polarization control signal, and
wherein the single-photon sources (436-440) are configured to emit the single photons in a temporally sequential and temporally separated manner, and
wherein the car key comprises means for transmitting these single photons to a single-photon receiving device (601) of a car (802), and
wherein the car key comprises a wireless data interface (426), in particular a radio interface, wherein the wireless data interface (426) is configured to exchange synchronization signals between the car key and the single-photon receiving device (601).

73. The car key according to claim 72, characterized in that
the actuating device (429) is configured to transmit a predefined receive code by means of amplitude modulation without polarization modulation once or multiple times for a predefined time as synchronization information by means of the single-photon sources (436-440) before the start of a transmission of a key to a single-photon receiving device (601) of a car (802).

74. The car key according to claim 73, characterized in that
the actuating device (429) is configured to generate a polarization control signal by means of a time base of the actuating device (429) at predetermined time periods and depending on one or a plurality of the provided random numbers in order to cause the single-photon sources (436-440) to emit individual single photons.

75. The car key according to claim 74, characterized in that
a respective start of the predetermined time periods depends on a random number, in particular on a random number of the quantum process-based generator (415).

76. The car key according to one of claims 72 to 75, characterized in that the car key comprises:
a first single-photon source (436),
a second single-photon source (437),
a third single-photon source (438), and a
a fourth single-photon source (439),
wherein each of the single-photon sources (436-439) radiates into an optical transmission path (152), and
wherein each of the single-photon sources (436-439) emits polarized light in a polarization direction, and
wherein the polarization direction of the first single-photon source (436) is rotated by 45° with respect to the polarization direction of the third single-photon source (438), and
wherein the polarization direction of the first single-photon source (436) is rotated by 90° with respect to the polarization direction of the second single-photon source (437), and
wherein the polarization direction of the first single-photon source (436) is rotated by 135° with respect to the polarization direction of the fourth single-photon source (439), and
wherein the actuating device (429) is configured to control the first single-photon source (436), the second single-photon source (437), the third single-photon source (438), and the fourth single-photon source (439) by means of the polarization control signal.

77. The car key according to one of claims 71 to 76, characterized in that
the car key comprises a birefringent crystal for mixing vertically and horizontally polarized photons.

78. The car key according to one of claims 71 to 77, characterized in that the car key comprises a conical mirror (1301/1408) for mixing vertically and horizontally polarized photons.

79. The car key according to one of claims 71 to 78, characterized in that the car key comprises a spatial filter (1302).

80. The car key according to one of claims 76 to 79, characterized in that the car key comprises:
a λ/4 plate (288),
a non-polarizing first beam splitter (283),
a polarizing second beam splitter (284), and
a polarizing third beam splitter (290),
wherein the third beam splitter (290) is configured to feed those photons of the fourth single-photon sources (439) into a second rotated signal path (SP2′) if they have a vertical polarization, and not to feed them into the second rotated signal path (SP2′) if they have a horizontal polarization, and
wherein the third beam splitter (290) is configured to feed those photons of the third single-photon sources (438) into the second rotated signal path (SP2′) if they have a horizontal polarization, and not to feed them into the second rotated signal path (SP2′) if they have a vertical polarization, and
wherein the λ/4 plate (288) is configured to rotate the photons in the second rotated signal path (SP2′) by 45° and to feed them into a second signal path (SP2), and
wherein the second beam splitter (284) is configured to feed the photons of the second single-photon sources (437) into a first signal path (SP1) if they have a vertical polarization, and not to feed them into the first signal path (SP1) if they have a horizontal polarization, and
wherein the second beam splitter (284) is configured to feed the photons of the first single-photon sources (436) into the first signal path (SP1) if they have a horizontal polarization, and not to feed them into the first signal path (SP1) if they have a vertical polarization, and
wherein the first beam splitter (283) is configured to direct the photons of the first signal path (SP1) and the photons of the second signal path (SP2) into a common transmit signal path (152).

81. A car (802) comprising a single-photon transmission device (401, 471) according to one of claims 1 to 38 and/or a single-photon receiving device (601) according to one of claims 39 to 68.

82. The car (802) according to claim 81, characterized in that the car (802) comprises:
a first single-photon detector (677),
a second single-photon detector (678),
a third single-photon detector (679),
a fourth single-photon detector (680),
an evaluation circuit (672),
a radio interface, and
a non-polarizing first beam splitter (183),
wherein the car (802) is configured to receive a light signal of a car key according to one or more of the preceding claims, and
wherein the first beam splitter (183) is configured to redirect photons of the light signal to a first signal path (1604) or a second signal path (187) with a probability of substantially 50%, and
wherein the first single-photon detector (677) is configured to detect horizontally polarized photons in the first signal path (1604), and
wherein the second single-photon detector (678) is configured to detect vertically polarized photons in the first signal path (1604), and
wherein the third single-photon detector (679) is configured to detect +45° polarized photons in the second signal path (187), and
wherein the fourth single-photon detector (680) is configured to detect −45° polarized photons in the second signal path (187), and
wherein the evaluation circuit (672) is configured to exchange synchronization signals with the
car key according to one of claims 71 to 80 via the radio interface, and wherein the evaluation circuit (672) is configured to evaluate
receive signals of the first single-photon detector (677), the second single-photon detector (678), the third single-photon detector (679), and the fourth single-photon detector (680) depending on the synchronization signals and to extract a bit sequence, and wherein the evaluation circuit (672) is configured to generate a key on the basis of the bit sequence, and
wherein the evaluation circuit (672) is configured to decrypt data of the car key which the
evaluation circuit (672) has received via the radio interface, and/or wherein the evaluation circuit (672) is configured to encrypt data
and send it to the car key via the radio interface.

83. The car (802) according to claim 82, characterized in that the car (802) comprises:
a λ/4 plate (188),
a polarizing second beam splitter (184), and
a polarizing third beam splitter (190), wherein the λ/4 plate (188) is configured to rotate the photons in the second signal path (187) by 45° and feed them into a rotated second signal path (189), and
wherein the third beam splitter (190) is configured to direct the photons of the light in the rotated second signal path (189) having a vertical polarization to the fourth single-photon detector (680), and
wherein the third beam splitter (190) is configured to direct the photons of the light in the rotated second signal path (189), which have a horizontal polarization, to the third single-photon detector (679), and
wherein the second beam splitter (184) is configured to direct the photons of the light in the first
signal path (1604) having a vertical polarization to the second
single-photon detector (678), and
wherein the second beam splitter (184) is configured to direct the photons of the light in the first
signal path (1604) having a horizontal polarization to the first single-photon detector (677).

84. The car (802) according to one of claim 82 or 83, comprising
a single-photon receiving device (601) according to one of claims 39 to 68,
wherein actuating electronics of the single-photon receiving device (601) are configured to receive a predefined receive code by means of amplitude modulation without polarization modulation once or multiple times for a predefined time as a synchronization signal from the car key, and
wherein the single-photon receiving device (601) is configured for the purpose of, in particular by means of a synchronization demodulator of the single-photon receiving device (601) or by means of an optimum filter of the single-photon receiving device (601), synchronizing a time base of the single-photon receiving device (601) with a time base of the actuating device (429) of the car key according to one of claims 71 to 80, and
wherein the evaluation circuit (672) is configured to evaluate the receive signals of the first single-photon detector (677), the second single-photon detector (678), the third single-photon detector (679), and the fourth single-photon detector (680) depending on the time base thus synchronized and to extract a bit sequence.

85. The car (802) according to claim 84, characterized in that the actuating electronics of the single-photon receiving device (601) are configured to evaluate the receive signals of the single-photon sources (436-439) by means of its time base at predetermined time periods and depending on one or a plurality of the random numbers provided and/or received by the car key.

86. The car (802) according to claim 85, characterized in that
that a respective start of the predetermined time periods depends on a random number, in particular on a random number from the quantum process-based generator (415) of the car key.

87. The car (802) according to one of claims 82 to 86, comprising:
a single-photon receiving device (601) according to one of claims 39 to 68,
a first single-photon detector (677) of the single-photon receiving device (601),
a second single-photon detector (678) of the single-photon receiving device (601),
a third single-photon detector (679) of the single-photon receiving device (601), and
a fourth single-photon detector (680) of the single-photon receiving device (601), wherein each of the single-photon detectors (677-680) is configured to receive photons from an optical receive path (152), and
wherein each of the single-photon detectors (677-680) is configured to receive polarized light in one polarization direction only, and
wherein the polarization direction of the first single-photon detector (677) is rotated by 45° with respect to the polarization direction of the third single-photon detector (679), and wherein the polarization direction of the first single-photon detector (677) is rotated by 90° with respect to the polarization direction of the second single-photon detector (678), and
wherein the polarization direction of the first single-photon detector (677) is rotated by 135° with respect to the polarization direction of the fourth single-photon detector (680).

88. The car (802) according to one of claims 82 to 87, characterized in that the car (802) comprises a birefringent crystal for segregating vertically and horizontally polarized photons.

89. The car (802) according to claim 81, characterized in that the car (802) comprises:
a single-photon source (436-439),
a quantum process-based generator (415), and
an actuating device (429),
wherein the quantum process-based generator (415) is configured to provide one or a plurality of random numbers, and
wherein the actuating device (429) is configured to generate a polarization control signal depending on one or a plurality of the provided random numbers, and
wherein the single-photon sources (436-439) are configured to generate single photons,
which are hereinafter referred to as single photons, with a polarization,
wherein the polarization of the single photons depends on the polarization control signal, and
wherein the single-photon sources (436-439) are configured to emit the single photons in a temporally sequential and temporally separated manner, and
wherein the car (802) comprises means configured to transmit these single photons to a single-photon receiving device (601) of a car key, and wherein the car (802) comprises a wireless data interface (426), in particular a
radio interface, wherein the wireless data interface (426) is configured to exchange synchronization signals between the car (802) and the single-photon receiving device (601).

90. The car (802) according to claim 89, characterized in that
the actuating device (429) is configured to transmit a predefined receive code by means of amplitude modulation without polarization modulation once or multiple times for a predefined time as synchronization information by means of the single-photon source (436-439) before the start of transmission of a key to the single-photon receiving device (601) of the car key.

91. The car (802) according to claim 90, characterized in that the actuating device (429) is configured to generate the polarization control signal by means of a time base of the actuating device (429) at predetermined time periods and depending on one or a plurality of the provided random numbers in order to cause the single-photon sources (436-439) to emit individual single photons.

92. The car (802) according to claim 91, characterized in that a respective start of the predetermined time periods depends on a random number, in particular on a random number from the quantum process-based generator (415).

93. The car (802) according to one of claims 89 to 92, characterized in that the car (802) comprises:
a first single-photon source (436),
a second single-photon source (437),
a third single-photon source (438),
a fourth single-photon source (439),
wherein each of the single-photon sources (436-439) is configured to radiate into an optical transmission path (152),
and wherein each of the single-photon sources (436-439) is configured to emit polarized light in a polarization direction, and
wherein the polarization direction of the first single-photon source (436) is rotated by 45° with respect to the polarization direction of the third single-photon source (438), and
wherein the polarization direction of the first single-photon source (436) is rotated by 90° with respect to the polarization direction of the second single-photon source (437), and
wherein the polarization direction of the first single-photon source (436) is rotated by 135° with respect to the polarization direction of the fourth single-photon source (439), and
wherein the actuating device (429) is configured to control the first single-photon source (436), the second single-photon source (437), the third single-photon source (438), and the fourth single-photon source (439) by means of the polarization control signal.

94. The car (802) according to one of claims 89 to 93, characterized in that
the car (802) comprises a birefringent crystal for mixing vertically and horizontally polarized photons.

95. The car (802) according to one of claims 89 to 94, characterized in that
the car (802) comprises a conical mirror (1408) for mixing vertically and horizontally polarized photons.

96. The car (802) according to one of claims 89 to 95, characterized in that the car (802) comprises a spatial filter (1302/444, 445).

97. The car (802) according to one of claims 93 to 96, characterized in that the car (802) comprises:
a λ/4 plate (288),
a non-polarizing first beam splitter (283),
a polarizing second beam splitter (284), and
a polarizing third beam splitter (290),
wherein the third beam splitter (290) is configured to feed the photons of the fourth single-photon sources (439) into a second rotated signal path (SP2′) if they have a vertical polarization, and not to feed them into the second rotated signal path (SP2′) if they have a horizontal polarization, and
wherein the third beam splitter (290) is configured to feed the photons of the third single-photon sources (438) into a second rotated signal path (SP2′) if they have a horizontal polarization, and not to feed them into the second rotated signal path (SP2′) if they have a vertical polarization, and
wherein the λ/4 plate (288) is configured to rotate the photons in the second rotated signal path (SP2′) by 45° and to feed them into a second signal path (SP2), and
wherein the second beam splitter (284) is configured to feed the photons of the second single-photon sources (437) into a first signal path (SP1) if they have a vertical polarization, and not to feed them into the first signal path (SP1) if they have a horizontal polarization, and
wherein the second beam splitter (284) is configured to feed the photons of the first single-photon sources (436) into the first signal path (SP1) if they have a horizontal polarization, and not to feed them into the first signal path (SP1) if they have a vertical polarization, and
wherein the first beam splitter (283) is configured to direct the photons of the first signal path (SP1) and the second signal path (SP2) into a common transmit signal path (152).

98. The car key according to claim 71, characterized in that the car key comprises:
a first single-photon detector (677),
a second single-photon detector (678),
a third single-photon detector (679),
a fourth single-photon detector (680),
an evaluation circuit (672),
a radio interface, and
a non-polarizing first beam splitter (183),
wherein the car key is configured to receive a light signal of a car (802) according to one or more of the preceding claims, and
wherein the first beam splitter (183) redirects photons of the light signal to a first signal path (1604) or a second signal path (187) with a probability of substantially 50%, and
wherein the first single-photon detector (677) is configured to detect horizontally polarized photons in the first signal path (1604), and
wherein the second single-photon detector (678) is configured to detect vertically polarized
photons in the first signal path (1604), and
wherein the third single-photon detector (679) is configured to detect +45° polarized photons in the second signal path (187), and
wherein the fourth single-photon detector (680) is configured to detect −45° polarized photons in the second signal path (187), and
wherein the evaluation circuit (672) is configured to exchange synchronization signals with the car (802) according to one or more of the preceding claims via the radio interface, and
wherein the evaluation circuit (672) is configured to evaluate receive signals of the first single-photon detector (677), the second single-photon detector (678), the third single-photon detector (679), and the fourth single-photon detector (680) depending on the synchronization signals and to extract a bit sequence, and
wherein the evaluation circuit (672) is configured to generate a key on the basis of the bit sequence, and
wherein the evaluation circuit (672) is configured to decrypt data of the car (802) according to one or more of the preceding claims which the evaluation circuit (672) has received via the radio interface and/or
wherein the evaluation circuit (672) is configured to encrypt data and send it via the radio interface to the car (802) according to one of claims 89 to 97.

99. The car key according to claim 98, characterized in that the car key comprises:
a λ/4 plate (188),
a polarizing second beam splitter (184), and
a polarizing third beam splitter (190),
wherein the λ/4 plate (188) is configured to rotate the photons in the second signal path (187) by 45° and to feed them into a rotated second signal path (189), and
wherein the third beam splitter (190) is configured to direct the photons of the light in the rotated second signal path (189) having a vertical polarization to the fourth single-photon detector (680), and
wherein the third beam splitter (190) is configured to direct the photons of the light in the rotated second signal path (189) having a horizontal polarization, to the third single-photon detector (679), and
wherein the second beam splitter (184) is configured to direct the photons of the light in the first signal path (1604) having a vertical polarization to the second single-photon detector (678), and
wherein the second beam splitter (184) is configured to direct the photons of the light in the first signal path (1604) having a horizontal polarization, to the first single-photon detector (677).

100. The car key according to one of claim 98 or 99, comprising a single-photon receiving device (601),
wherein the actuating device of the single-photon receiving device (601) is configured to receive a predefined receive code by means of amplitude modulation without polarization modulation once or multiple times for a predefined time as a synchronization signal from the car (802), and
wherein the single-photon receiving device (601) is configured for the purpose of, in particular by means of a synchronization demodulator of the single-photon receiving device (601) or by means of an optimum filter of the single-photon receiving device (601), synchronizing a time base of the single-photon receiving device (601) with a time base of the actuating device (429) of the car (802) according to one of claims 89 to 97, and
wherein the evaluation circuit (672) is configured to evaluate the receive signals of the first single-photon detector (677), the second single-photon detector (678), the third single-photon detector (679), and the fourth single-photon detector (680) depending on the time base thus synchronized and to extract a bit sequence.

101. The car key according to claim 100, characterized in that the actuating device of the single-photon receiving device (601) is configured to evaluate the receive signals of the single-photon sources (436-439) by means of its time base at predetermined time periods and depending on one or a plurality of the random numbers provided and/or received by the car (802).

102. The car key according to claim 101, characterized in that a respective start of the predetermined time periods depends on a random number, in particular on a random number of the quantum process-based generator (415) of the car (802).

103. The car key according to one of claims 98 to 102, characterized in that each of the single-photon detectors (677-680) is configured to receive photons from an optical receive path (152), and
wherein each of the single-photon detectors (677-680) is configured to receive polarized light in one polarization direction only, and
wherein the polarization direction of the first single-photon detector (677) is rotated by 45° with respect to the polarization direction of the third single-photon detector (679), and
wherein the polarization direction of the first single-photon detector (677) is rotated by 90° with respect to the polarization direction of the second single-photon detector (678), and
wherein the polarization direction of the first single-photon detector (677) is rotated by 135° with respect to the polarization direction of the fourth single-photon detector (680).

104. The car key according to one of claims 98 to 103, characterized in that the car key comprises a birefringent crystal for segregating vertically and horizontally polarized photons.

105. Use of a single-photon transmission device (401, 471) according to one of claims 1 to 38 and/or a single-photon receiving device (601) according to one of claims 39 to 68 for data exchange
between a car key according to claim 71 and a car (802) according to claim 81, and/or
between a first car (802) according to claim 81 and a second car (802) according to claim 81, and/or
between a car (802) according to claim 81 and an infrastructure device, such as a charging station (1011), and/or
within a car (802) according to claim 81 for encrypted communication within the car (802).

106. A SPAD diode (1820) for a sensor element of a single-photon detector (677-680) for a single-photon transmission device (401, 471) according to one of claims 1 to 38 and/or for a single-photon receiving device (601) according to one of claims 39 to 68, said diode comprising:
at least one shallow trench isolation means (1821),
at least one anode contact (1822),
at least one cathode contact (1823),
at least one cover oxide (1824),
at least one optically transparent insulating layer,
at least one highly doped first connector area (1825) of a first line type,
at least one first doped tray (1826) of a second line type,
at least one second doped tray (1827) of a second line type,
an epitaxial layer (1828) of a second line type,
a base material (1829) of a semiconducting monocrystalline wafer,
a second doped tray (1830) of a second line type below the anode contact (1822),
at least one highly doped second connector area (1831) of the second connector type,
at least one isolation means (1832), characterized in that the SPAD diode (1820) further comprises:
at least one metal-optical filter (1833), and
at least one optically transparent slit (1834) in the metal-optical filter (1833),
wherein, given a SPAD diode array comprising a plurality of the SPAD diodes (1820), the plurality of SPAD diodes (1820) are arranged such that the respective metal-optical filters (1833) of the respective adjacent SPAD diodes (1820) are arranged at a 45° angle to each other.

107. A vehicle system comprising:
a vehicle (802) and
device components (401, 601),
wherein at least one first device component (401, 601) is part of the vehicle (802), and
wherein the vehicle system comprises a QKD system (401, 601, 452, 428) and
wherein at least the first device component (401, 601) exchanges a key with a further second
device component (401, 601) of the vehicle system in order to encrypt data by means of the QKD system (401, 601, 452, 428), and
wherein the first device component (401, 601) exchanges encrypted data with the second device component (401, 601) at least temporarily by means of this key.

108. The vehicle system according to claim 107, characterized in that the second device component is a car key.

109. The vehicle system according to claim 107, characterized in that the second device component is also a component of the vehicle (802).

110. The vehicle system according to claim 107, characterized in that the second device component is an infrastructure arrangement.

111. The vehicle system according to claim 107, characterized in that the second device component is another vehicle (802).

112. The vehicle system according to one of claims 107 to 111, characterized in that the vehicle is a passenger car, a truck, a special machine, a ship, a watercraft, a floating body, or any other mobile apparatus.

113. The vehicle system according to one of claims 107 to 112, characterized in that the vehicle system at least temporarily comprises a polarization-modulated single-photon stream, in particular a QKD coupling stream (452) between the second device component (401, 601) and the first device component (401, 601), via which the second device component (401, 601) exchanges with the first device component (401, 601).

114. The vehicle system according to claim 113, characterized in that the first device component comprises a single-photon receiving device (601) for the polarization-modulated single-photon stream, and
the second device component comprises a single-photon transmission device (401) for the polarization-modulated single-photon stream.

115. The vehicle system according to one of claims 113 to 114, characterized in that the first device component comprises a single-photon transmission device (401) for the polarization-modulated single-photon stream, and
the second device component comprises a single-photon receiving device (601) for the polarization-modulated single-photon stream.

116. The vehicle system according to one of claims 113 to 115, characterized in that the single-photon stream is a QKD coupling stream (452).

117. The vehicle system according to one of claims 107 to 116, characterized in that the first device component (401, 601) and the second device component (401, 601) each comprise means (1411, 1603) for exchanging a single-photon stream, in particular a QKD coupling beam (452).

118. The vehicle system according to one of claims 107 to 117, characterized in that the first device component and the second device component comprise means (455, 699) for directing a single-photon stream, in particular a QKD coupling beam (452).
